(19) United States
(12) Patent Application Publication
(10) Pub. No.: US 2026/0172527 A1
(43) Pub. Date: Jun. 18, 2026

(54) System, computer program product and method for transferring a video stream

(71) Applicant: LIVEARENA TECHNOLOGIES INC., Bellevue, WA (US)

(72) Inventors: Strider AGOSTINELLI, Everett, WA (US); Anders NILSSON, FALKÖPING (SE)

(21) Appl. No.: 18/983,478

(22) Filed: Dec. 17, 2024

(51) Int. Cl. H04N 7/14; G06F 21/16; G06F 21/31; H04N 7/15

(52) U.S. Cl. CPC H04N 7/147; G06F 21/16; G06F 21/31; H04N 7/15

(57) ABSTRACT

A method for transferring a first video stream, comprising
determining a first verification code (VC1);
producing a first produced video stream (PVS1) based on a first source video stream (SVS1) as well as a first piece of information (POI1) coding for the first verification code (VC1);
transferring the first produced video stream (PVS1) from a sender (510) to a receiver (530), wherein the method further comprises the steps
down-sampling the first source video stream (SVS1) to achieve a first shadow source video stream (SSVS1);
producing a first shadow produced video stream (SPVS1) based on the first shadow source video stream (SSVS1) as well as the first piece of information (POI1), the producing of the first shadow produced video stream (SPVS1) being performed using one or more automatic shadow production steps corresponding to one or more automatic primary production steps; and
storing or distributing the first produced shadow produced video stream (SPVS1).

The present invention relates to a system, computer program product and method for transferring a digital video stream, such as a digital video stream having been produced based on one or several digital input video streams.

In some embodiments, the digital video stream is produced in the context of a digital video conference or meeting system, particularly involving a plurality of different concurrent users. The transferred digital video stream may be produced and/or published externally or within a digital video conference or digital video conference system. The digital video conference system can be interactive in the sense that it allows participant users to interact in real-time or near real-time, for instance by a second user viewing a video showing a first user as a part of a first produced video stream, and the first user simultaneously viewing the second user as a part of a second produced video stream that can be the same or different from the first produced video stream.

In other embodiments, the present invention is applied in contexts that are not digital video conferences, but in which source/primary digital video streams, or produced digital video streams, are transferred between entities for other reasons. For instance, such contexts may be educational, instructional or entertainment-related.

There are many known digital video conference systems, such as Microsoft® Teams®, Zoom® and Google® Meet®, offering two or more participants to meet virtually using digital video and audio captured locally and broadcast to all participants to emulate a physical meeting.

When transferring a video stream, it is sometimes important for a receiver of the video stream to be able to verify that the transferred video stream is actually valid, in the sense that it is actually sent by an alleged sending entity and that the informational contents of the video stream are not altered during the transfer.

This is desirable even in cases where the video stream is reformatted during the transfer, such as due to varying internet connection quality or system bitrate bottlenecks.

It is also desirable that the provision of such verification does not deteriorate the transfer, such as altering the video stream quality or latency.

The verification should preferably be reliable even in case the video stream is transferred via one or several intermediate entities.

In case the video stream is used as an input video stream to a produced video stream in turn being transferred, it should still be possible for the receiving entity to performed said verification. This would, for instance, be the case in a video conference service, where one participating user would like to verify the authenticity of a video stream concurrently showing several other users with respect to one or several of the other users.

Swedish application SE 2151267-8 discloses various methods for producing and transferring digital video streams. Swedish application 2151461-7 discloses various solutions specific to the handling of latency in multi-participant digital video environments, such as when different groups of participants are associated with different general latency. Swedish application 2250113-4 discloses various solutions specific to the use of one or several cameras to track one or several persons. Swedish application SE 2250945-9 discloses various ways of load-balancing production work between a local and a remote computer. Swedish application SE 2350439-2 discloses handling of static and dynamic content in a video-based system. Swedish application 2450104-1 discloses the use of a down-sampled version of a digital video stream.

In the various types of solutions described and referred to above, there is generally a problem for various users of the system, as well as external parties, to know who is participating as a user in the meeting or interaction.

Swedish application SE 13509476 discloses a solution using one-way functions and publicly available information to cryptographically secure information to a timeline.

The present invention solves one or several of the above-described problems.

Hence, the invention relates to a method for transferring a first source video stream, the method comprising determining a first verification code; translating the first verification code into two or more distinct and different graphical objects, the graphical objects being useful to unambiguously determine the first verification code based on visual identification of each of the graphical objects; producing a first produced video stream, the first produced video stream comprising one or several frames of the first source video stream as well as the graphical objects, the graphical objects not overlapping with frames of the first source video stream; and transferring the first produced video stream from a sender to a receiver.

In some embodiments, each of the graphical objects is configured with one or several respective distinct graphical features, the one or several distinct graphical features being defined in a more coarse-grained manner, on pixel information level, than the first source video stream.

In some embodiments, the first verification code is unique to the first source video stream.

In some embodiments, the one or several distinct graphical features are selected to incorporate sufficient graphical coarseness so that each of the graphical objects can be visually and uniquely identified also after a down-sampling, such as a predetermined down-sampling, of the first produced video stream.

In some embodiments, the transfer of the first produced video stream comprises a down-sampling of the first produced video stream.

In some embodiments, the down-sampling comprises a change of encoding to an encoding producing a smaller video stream byte size.

In some embodiments, the down-sampling comprises a reduction of pixmap resolution.

In some embodiments, the down-sampling comprises a reduction of color depth.

In some embodiments, the down-sampling comprises a reduction of frame rate.

In some embodiments, each of the distinct graphical features are defined in terms of a defined absolute or relative color range, or a defined absolute or relative color, applied across a connected set of at least 8×8 pixels.

In some embodiments, each of the distinct graphical features are defined in terms of a high-contrast basic shape element having a smallest geometrical size measurement of at least 8 pixels.

In some embodiments, respective colors or color ranges used in different ones of the graphical objects are uniquely describable using a color depth of 8 bits or less.

In some embodiments, the first source video stream is included in the first produced video stream in its entirety and without any cropping of the frames of the first source video stream.

In some embodiments, each frame of the first produced video stream contains a larger number of pixels than a corresponding frame of the first source video stream.

In some embodiments, two or more of the graphical objects together coding for the first verification code, or part of the first verification code, are incorporated in one single frame of the first produced video stream.

In some embodiments, two or more of the graphical objects together coding for the first verification code, or part of the first verification code, are incorporated into different frames of the first produced video stream.

In some embodiments, the method comprises determining the first verification code based on a source stream authentication code, the source stream authentication code being unique for the first source video stream.

In some embodiments, the method comprises determining the first verification code based on a primary stream authentication code, the primary stream authentication code being unique for a primary video stream based on which the first source video stream is produced.

In some embodiments, the method comprises determining the first verification code based on a user authentication code, the user authentication code being unique for a user being associated with or depicted in the first source video stream and/or the user authentication code being unique for a user receiving the transfer of the first produced video stream.

In some embodiments, the method comprises determining the first verification code based on a session code, the session code being unique for a communication session within the context of which the transfer of the first produced video stream takes place.

In some embodiments, the method comprises determining the first verification code based on a random code.

In some embodiments, the method comprises determining the first verification code based on a timestamp.

In some embodiments, the method comprises determining the first verification code based on metadata, the metadata comprising information about one or several of the sender; the receiver; the first source video stream; said session; and said context.

In some embodiments, the random code is calculated based on a piece of hardware-generated randomness.

In some embodiments, the method comprises calculating a sequence of graphical objects to be incorporated into one or several frames of the first produced video stream based on a sequence of verification codes, the sequence of verification codes being an ordered sequence of verification codes, each verification code in the sequence of verification codes being calculated based on at least one of a previous verification code in the ordered sequence of verification codes and the first verification code.

In some embodiments, the method comprises, for each of one or several verification codes in the sequence of verification codes, calculating the verification code based on publicly published information.

In some embodiments, the method comprises, for each of one or several verification codes in the sequence of verification codes, calculating a value of a piece of information based on the verification code, the value subsequently being publicly published.

In some embodiments, the method comprises, for each of one or several verification codes in the sequence of verification codes, calculating the verification code as a pseudo-random number.

In some embodiments, the method comprises transferring to the sender a secret value being known to the receiver; and calculating the first verification code based on only the secret value and any additional information known to the receiver.

In some embodiments, the method comprises transferring to a sender a secret value being known to a receiver; the receiver receiving a first produced video stream containing as a part of a respective pixmap of one or several frames of the first produced video stream a respective contained video frame of the first source video stream; identifying two or more graphical objects in the first produced video stream, the graphical objects being useful to unambiguously determine a received verification code; determining the received verification code based on the identified graphical objects; verifying the received verification code based on the secret value; and determining a contained video stream based on the one or several contained video frames.

In some embodiments, the method comprises displaying the contained video stream, and not the graphical objects, on a screen display.

In some embodiments, the determining of the contained video stream is performed using a cropping operation of the first produced video stream.

In some embodiments, the method comprises determining that the verification of the received verification code is a failure; and incorporating an information element indicating a warning into the contained video stream.

In some embodiments, the method comprises determining that the verification of the received verification code is a success; and incorporating an information element indicating an acknowledgement into the contained video stream.

The present application also relates to a method for transferring a first video stream, the method comprising a sender receiving, from a receiver, a secret value; the sender determining a first verification code, the first verification code being or being determined based on the secret value; the sender producing a first produced video stream based on one or several frames of a first source video stream as well as a first piece of information coding for the first verification code in a way so that the first verification code can be unambiguously determined based on the first produced video stream; transferring the first produced video stream to an intermediate party; the intermediate party determining, based on the first produced video stream, a first piece of intermediate information correlating to the first verification code; the intermediate party producing a third produced video stream based on frames of the first produced video stream as well as a third piece of information coding for the first piece of intermediate information in a way so that the first piece of intermediate information can be unambiguously determined based on the third produced video stream;
transferring the third produced video stream to the receiver; the receiver determining, based on the third produced video stream, the first piece of intermediate information; and
the receiver verifying the first piece of intermediate information using the secret value.

In some embodiments, the secret value is unknown to the intermediate party.

In some embodiments, the intermediate party refrains from verifying the first piece of intermediate information.

In some embodiments, the method comprises the intermediate party producing the third produced video stream based on the first produced video stream so that, for at least one, some or all of individual frames of the first source video stream, at least part of the frame is visible in the third produced video stream.

In some embodiments, the method comprises the intermediate party producing the third produced video stream based on the first produced video stream as well as additional content, the additional content being visible in the third produced video stream.

In some embodiments, the additional content comprises a video stream, such as a second produced video stream.

In some embodiments, the method comprises producing the second produced video stream based on frames of a second source video stream as well as second piece of information coding for a second verification code in a way so that the second verification code can be unambiguously determined based on the second produced video stream.

In some embodiments, the first piece of information comprises pixel information and/or audio information.

In some embodiments, the first piece of information and/or the third piece of information comprises or constitutes one or several graphical objects being useful to unambiguously determine the first verification code or the first piece of intermediate information based on visual identification of each of the one or several graphical objects.

In some embodiments, the first piece of information and/or the third piece of information comprises or constitutes a visual coding pattern having a predetermined structure, such as a QR code or a barcode, the visual coding pattern being useful to unambiguously determine the first verification code or the first piece of intermediate information based on visual identification of the visual coding pattern.

In some embodiments, the first piece of information and/or the third piece of information comprises or constitutes one or several alphanumeric characters, the one or several alphanumeric characters being useful to unambiguously determine the first verification code or the first piece of intermediate information based on visual identification of each of the one or several alphanumeric characters.

In some embodiments, the first piece of information and/or the third piece of information comprises or constitutes one or several graphical objects located in the first produced video stream without overlay of the first source video stream, or located in the third produced video stream without overlay of a third source video stream based on which the second produced video stream is produced.

In some embodiments, the first piece of information and/or the third piece of information comprises or constitutes a watermark structure, being configured to be indiscernible to the human eye in the first produced video stream or in the third produced video stream, but to be discernible after an image transformation, such as an inversion or a change of brightness or contrast, performed on the first produced video stream or the third produced video stream.

In some embodiments, the first piece of information is present in one or more of frames of the first produced video stream.

In some embodiments, different parts of the first piece of information coding for the first verification code are present in two or more different frames of the first produced video stream.

In some embodiments, the third piece of information coding for the first piece of intermediate information is present in one or more of frames of the third produced video stream.

In some embodiments, different parts of the third piece of information coding for the first piece of intermediate information are present in two or more different frames of the third produced video stream.

In some embodiments, the method comprises calculating a sequence of pieces of information to be incorporated into one or several frames of the first produced video stream based on a sequence of verification codes, the sequence of verification codes being an ordered sequence of verification codes, each verification code in the sequence of verification codes being calculated based on at least one of a previous verification code in the ordered sequence of verification codes and the first verification code.

In some embodiments, for each of one or several verification codes in the sequence of verification codes, calculating the verification code based on publicly published information.

In some embodiments, for each of one or several verification codes in the sequence of verification codes, calculating a value of a piece of information based on the verification code, the value subsequently being publicly published.

In some embodiments, for each of one or several verification codes in the sequence of verification codes, calculating the verification code as a pseudo-random number.

In some embodiments, the third produced video stream contains as a part of a respective pixmap of one or several frames of the third produced video stream a respective contained video frame of the first source video stream.

In some embodiments, the method comprises determining a contained video stream based on the one or several contained video frames.

In some embodiments, the method comprises displaying the contained video stream on a screen display.

The present application also relates to a method for transferring a first video stream, the method comprising determining a first verification code; producing a first produced video stream based on one or several frames of a first source video stream as well as a first piece of information coding for the first verification code in a way so that the first verification code can be unambiguously determined based on the first produced video stream, the producing of the first produced video stream being performed using one or more automatic primary production steps; and transferring the first produced video stream from a sender to a receiver.

In some embodiments, the method further comprises the steps down-sampling the first source video stream to achieve a first shadow source video stream; producing a first shadow produced video stream based on frames of the first shadow source video stream as well as the first piece of information in a way so that the verification code can be unambiguously determined based on the first shadow produced video stream, the producing of the first shadow produced video stream being performed using one or more automatic shadow production steps corresponding to the one or more automatic primary production steps; and storing or distributing the first produced shadow produced video stream.

In some embodiments, the one or more automatic primary production steps are based on one or more defined parameters.

In some embodiments, the one or more automatic primary production steps are based on automatic image processing of the first source video stream.

In some embodiments, the one or more automatic primary production steps are based on automatic audio processing of the first source video stream.

In some embodiments, the method comprises calculating an output of a first one-way function using as direct or derivative input frame data of the first shadow produced video stream, and publicly publishing the output of the first one-way function.

In some embodiments, the method comprises calculating the output of the first one-way function using as direct or derivative input the first piece of information.

In some embodiments, the method comprises sampling a publicly available information source and calculating an output of a second one-way function using the sampling as input; and incorporating into one or several frames of the first shadow produced video stream the output of the second one-way function.

In some embodiments, the method comprises calculating the output of the first one-way function based on the output of the second one-way function and/or calculating a subsequently calculated output of the first one-way function based on the output of the second one-way function, the subsequently calculated output of the first one-way function being calculated based on a subsequent frame of the first shadow produced video stream.

In some embodiments, the method comprises calculating the output of the second one-way function based on the output of the first one-way function and/or calculating a subsequently calculated output of the second one-way function based on the output of the first one-way function, the subsequently calculated output of the second one-way function being calculated based on a subsequent sampling of said publicly available information source.

In some embodiments, the method comprises the sender receiving a secret value known to the receiver; the sender determining the first verification code being or being determined based on the secret value; the receiver determining, based on the first produced video stream, the first verification code; and the receiver verifying the first verification code using the secret value.

In some embodiments, the method comprises the receiver determining that the verification is a failure; and the method then comprising determining, based on the first shadow produced video stream, the first verification code; and verifying the first verification code using the secret value.

In some embodiments, the method comprises verifying a respective output of the first and/or second one-way function.

In some embodiments, the verifying of the first verification code and/or the output of the first and/or second one-way function is performed by the receiver.

In some embodiments, the first piece of information comprises pixel information and/or audio information.

In some embodiments, the method comprises, for each of one or several verification codes in the sequence of verification codes, calculating the verification code based on publicly published information.

In some embodiments, the method comprises, for each of one or several verification codes in the sequence of verification codes, calculating a value of a piece of information based on the verification code, the value subsequently being publicly published.

In some embodiments, the method comprises, for each of one or several verification codes in the sequence of verification codes, calculating the verification code as a pseudo-random number.

The present application also relates to a system for transferring a first source video stream, the system comprising a sender and a receiver, the sender being configured to determine a first verification code; translate the first verification code into two or more distinct and different graphical objects, the graphical objects being useful to unambiguously determine the first verification code based on visual identification of each of the graphical objects;

produce a first produced video stream, the first produced video stream comprising one or several frames of the first source video stream as well as the graphical objects, the graphical objects not overlapping with frames of the first source video stream; and transfer the first produced video stream from the sender to the receiver.

In some embodiments, each of the graphical objects is configured with one or several respective distinct graphical features, the one or several distinct graphical features being defined in a more coarse-grained manner, on pixel information level, than the first source video stream.

The present application also relates to a system for transferring a first video stream, the system comprising a sender, an intermediate party and a receiver, the sender being configured to determine a first verification code, the first verification code being or being determined based on a secret value; producing a first produced video stream based on one or several frames of a first source video stream as well as a first piece of information coding for the first verification code in a way so that the first verification code can be unambiguously determined based on the first produced video stream; and transfer the first produced video stream to the intermediate party

In some embodiments, the intermediate party is configured to receive, from the receiver, the secret value; determine, based on the first produced video stream, a first piece of intermediate information correlating to the first verification code; produce a third produced video stream based on frames of the first produced video stream as well as a third piece of information coding for the first piece of intermediate information in a way so that the first piece of intermediate information can be unambiguously determined based on the third produced video stream; and transfer the third produced video stream to the receiver.

In some embodiments, the receiver is configured to determine, based on the third produced video stream, the first piece of intermediate information; and verify the first piece of intermediate information using the secret value.

The present application also relates to a system for transferring a first video stream, the system comprising a sender, the sender being configured to determine a first verification code; produce a first produced video stream based on one or several frames of a first source video stream as well as a first piece of information coding for the first verification code in a way so that the first verification code can be unambiguously determined based on the first produced video stream, the producing of the first produced video stream being performed using one or more automatic primary production steps; and transfer the first produced video stream to a receiver.

In some embodiments, the sender is further configured to down-sample the first source video stream to achieve a first shadow source video stream; produce a first shadow produced video stream based on frames of the first shadow source video stream as well as the first piece of information in a way so that the verification code can be unambiguously determined based on the first shadow produced video stream, the producing of the first shadow produced video stream being performed using one or more automatic shadow production steps corresponding to the one or more automatic primary production steps; and
store or distribute the first produced shadow produced video stream.

The present application also relates to a computer program product for transferring a first source video stream, the computer program product being configured to, when executing on one or several computer processors of a sender, determine a first verification code; translate the first verification code into two or more distinct and different graphical objects, the graphical objects being useful to unambiguously determine the first verification code based on visual identification of each of the graphical objects; produce a first produced video stream, the first produced video stream comprising one or several frames of the first source video stream as well as the graphical objects, the graphical objects not overlapping with frames of the first source video stream; and transfer the first produced video stream from the sender to a receiver.

In some embodiments, each of the graphical objects is configured with one or several respective dis-tinct graphical features, the one or several distinct graphical features being defined in a more coarse-grained manner, on pixel information level, than the first source video stream.

The present application also relates to a computer program product for transferring a first source video stream, the computer program product being configured to, when executing on one or several computer processors of a sender, cause the sender to determine a first verification code, the first verification code being or being determined based on a secret value; produce a first produced video stream based on one or several frames of a first source video stream as well as a first piece of information coding for the first verification code in a way so that the first verification code can be unambiguously determined based on the first produced video stream; and transfer the first produced video stream to the intermediate party.

In some embodiments, the computer program product is configured to, when executing on one or several computer processors of an intermediate party, cause the intermediate party to receive, from the receiver, the secret value; determine, based on the first produced video stream, a first piece of intermediate information correlating to the first verification code; produce a third produced video stream based on frames of the first produced video stream as well as a third piece of information coding for the first piece of intermediate information in a way so that the first piece of intermediate information can be unambiguously determined based on the third produced video stream; and transfer the third produced video stream to the receiver.

In some embodiments, the computer program product is configured to, when executing on one or several computer processors of a receiver, cause the receiver to determine, based on the third produced video stream, the first piece of intermediate information; and verify the first piece of intermediate information using the secret value.

The present application also relates to a computer program product for transferring a first source video stream, the computer program product being configured to, when executing on one or several computer processors of a sender, cause the sender to determine a first verification code; produce a first produced video stream based on one or several frames of a first source video stream as well as a first piece of information coding for the first verification code in a way so that the first verification code can be unambiguously determined based on the first produced video stream, the producing of the first produced video stream being performed using one or more automatic primary production steps; and transfer the first produced video stream to a receiver.

In some embodiments, the computer program product is configured to, when executing on one or several computer processors of the sender, further cause the sender to down-sample the first source video stream to achieve a first shadow source video stream; produce a first shadow produced video stream based on frames of the first shadow source video stream as well as the first piece of information in a way so that the verification code can be unambiguously determined based on the first shadow produced video stream, the producing of the first shadow produced video stream being performed using one or more automatic shadow production steps corresponding to the one or more automatic primary production steps; and store or distribute the first produced shadow produced video stream.

The computer program product can be implemented by a non-transitory computer-readable medium encoding instructions that cause one or more hardware processors located in at least one of computer hardware devices in the system to perform a method of said type.

In the following, the invention will be described in detail, with reference to exemplifying embodiments of the invention and to the enclosed drawings, wherein:

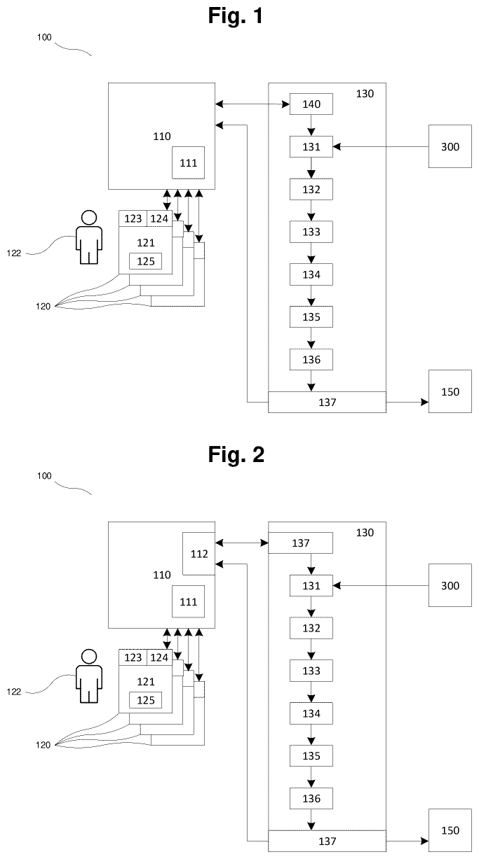

FIG. 1 illustrates a first exemplifying system;

FIG. 2 illustrates a second exemplifying system;

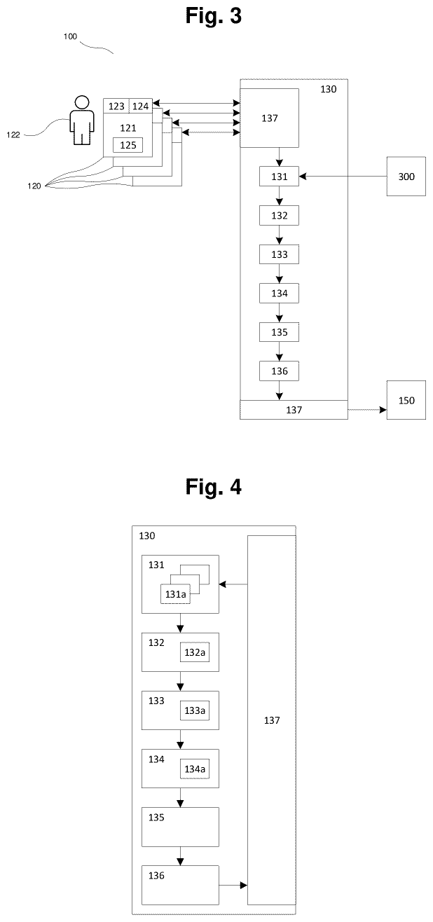

FIG. 3 illustrates a third exemplifying system;

FIG. 4 illustrates a central server;

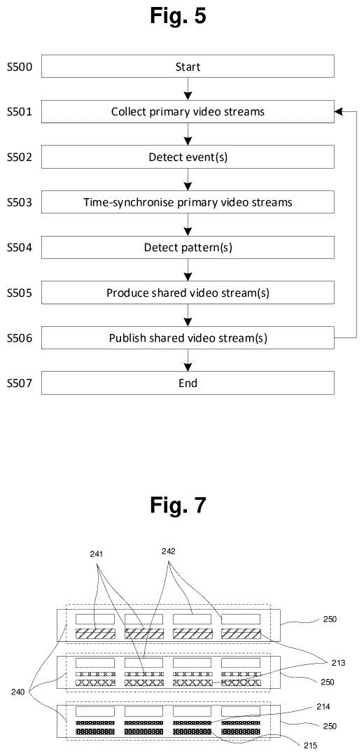

FIG. 5 illustrates a first method;

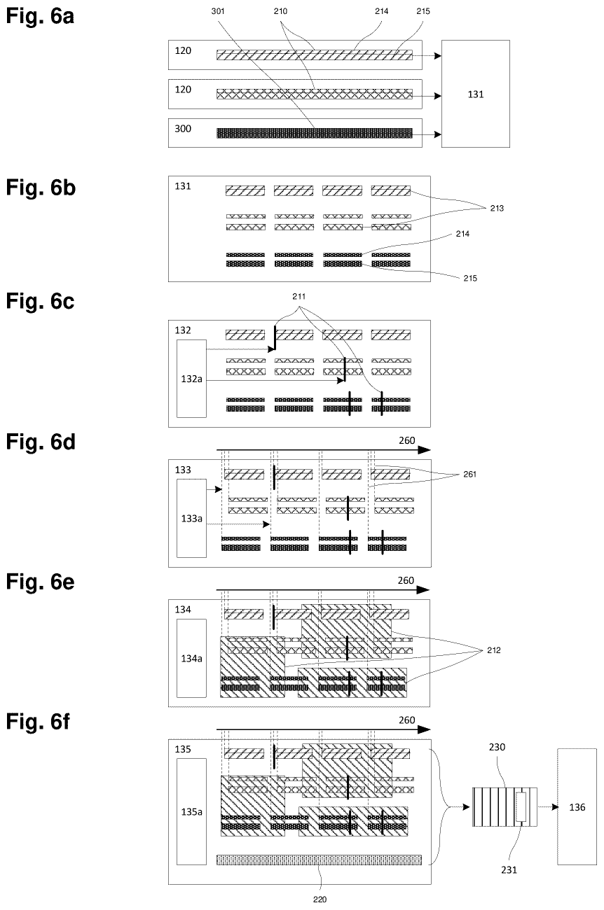

FIGS. 6a-6f illustrate subsequent states in relation to the different method steps in the method illustrated in FIG. 5;

FIG. 7 illustrates, conceptually, a common protocol;

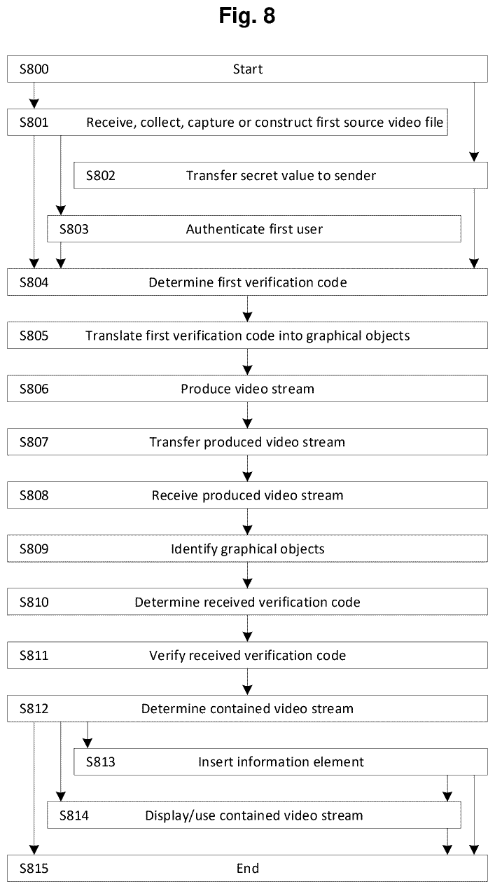

FIG. 8 illustrates a second method;

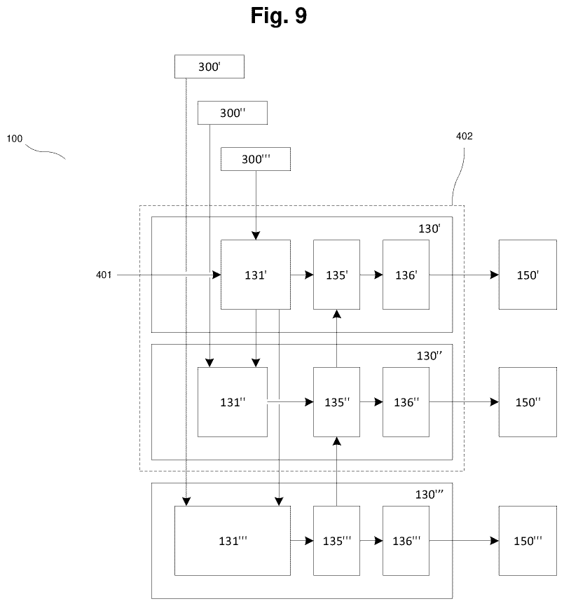

FIG. 9 illustrates a fourth exemplifying system;

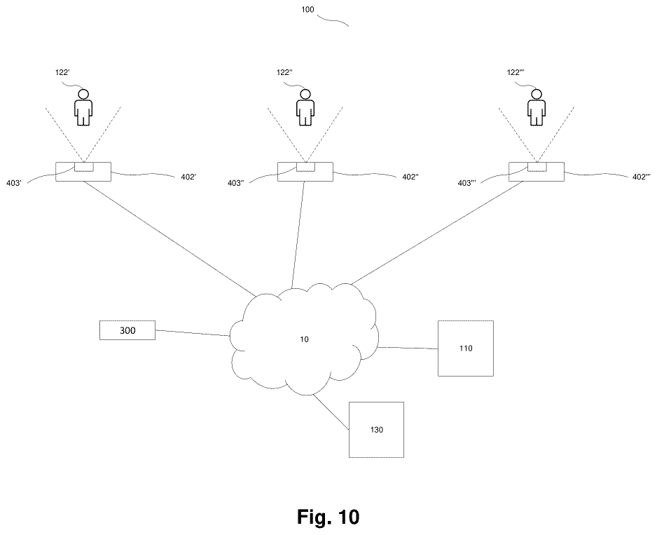

FIG. 10 illustrates a fifth exemplifying system;

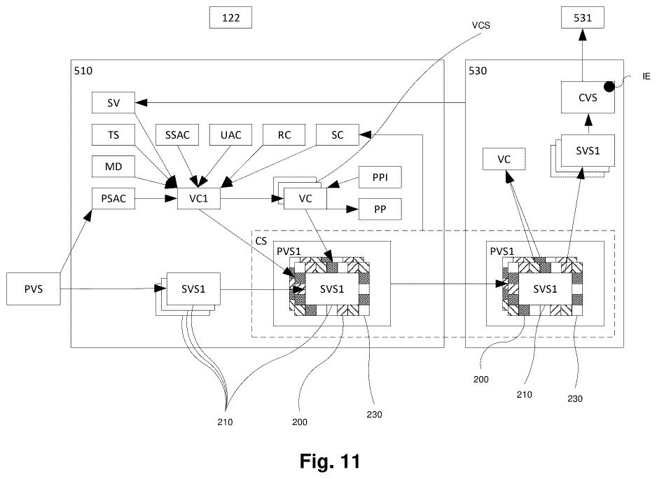

FIG. 11 illustrates a sixth exemplifying system including information flows;

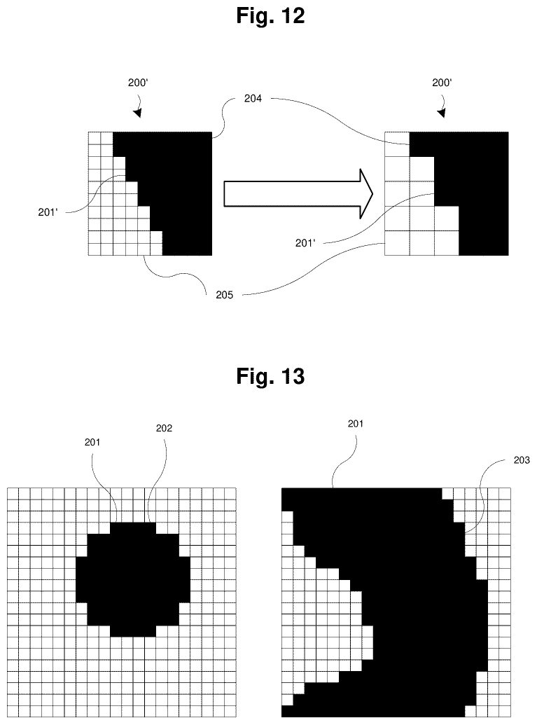

FIG. 12 illustrates two pixmaps of a video stream frame;

FIG. 13 illustrates two different pixmaps of a video stream frame;

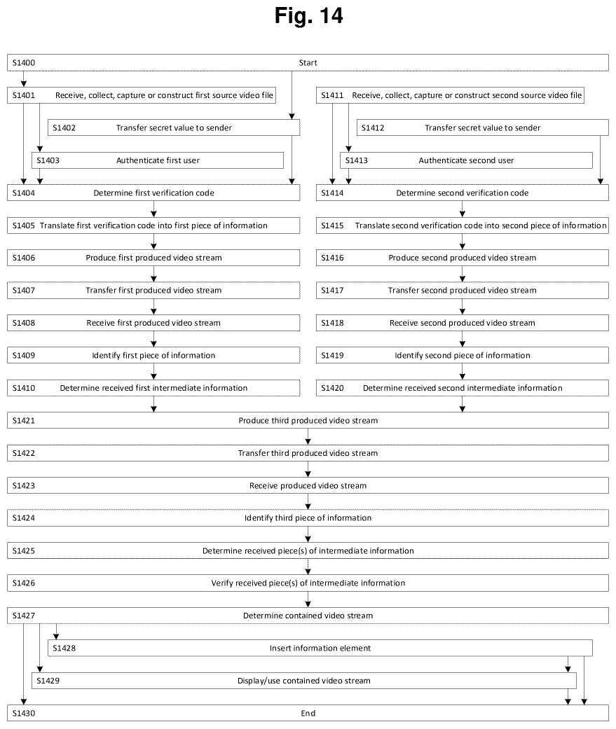

FIG. 14 illustrates a third method;

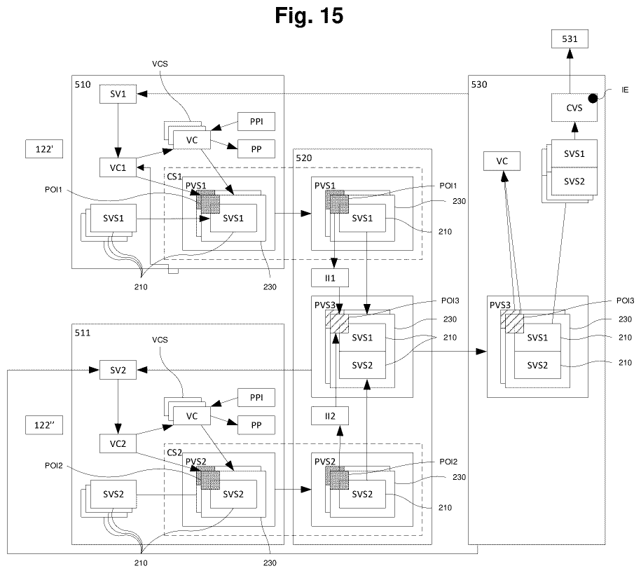

FIG. 15 illustrates a seventh exemplifying system including information flows;

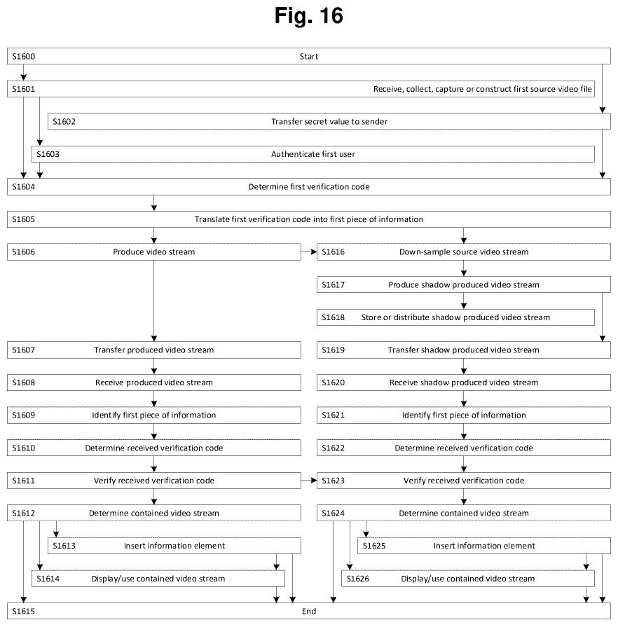

FIG. 16 illustrates a fourth method;

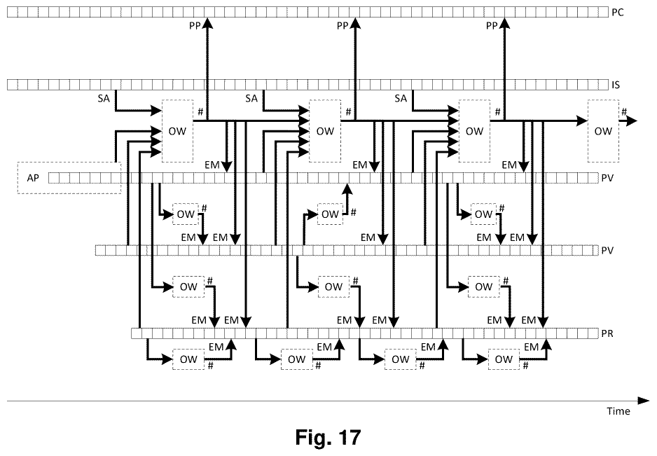

FIG. 17 illustrates interrelationships among a set of video streams, an information source and a publication channel along a time axis;

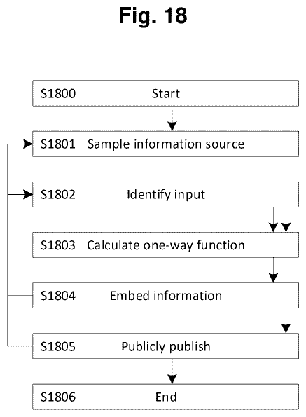

FIG. 18 illustrates a fifth method;

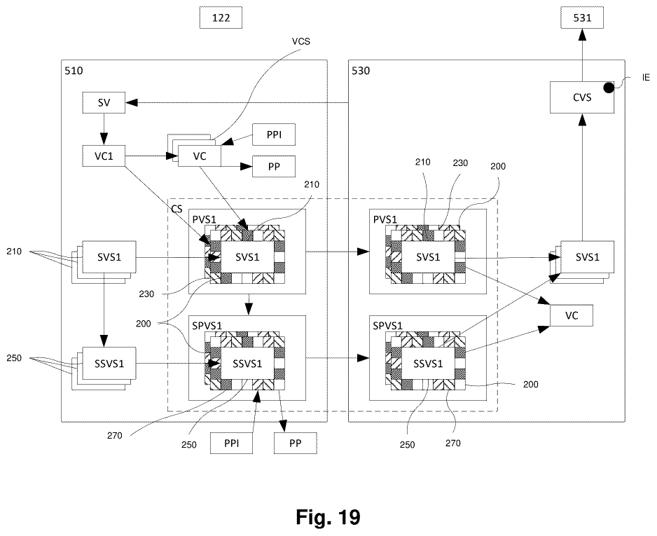

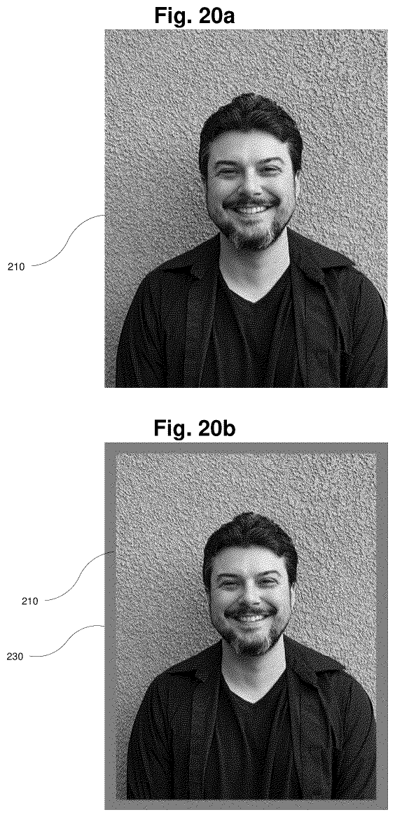

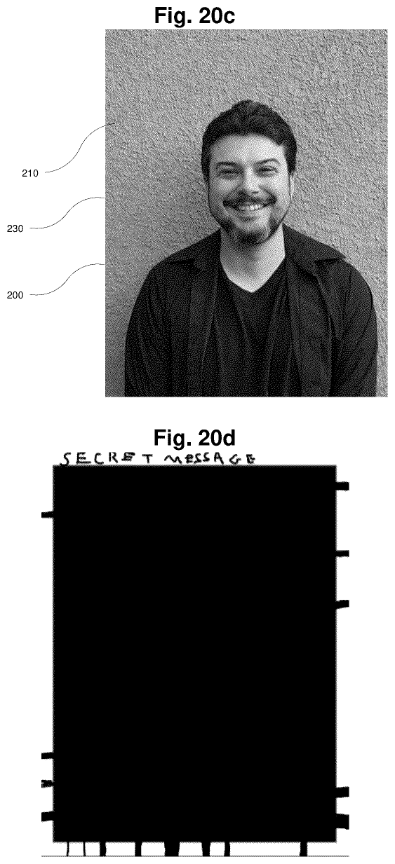

FIG. 19 illustrates an eight exemplifying system including information flows;

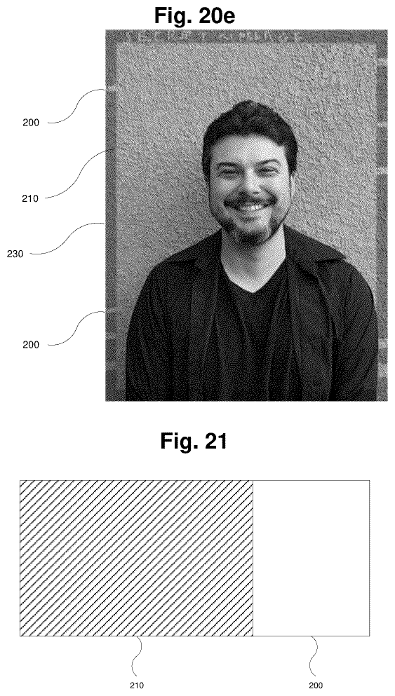

FIGS. 20a-20e show a series of image frames with and without surrounding graphical objects;

FIG. 21 shows a piece of a frame having pixels adjacent to a graphical object with a visual gradient; and

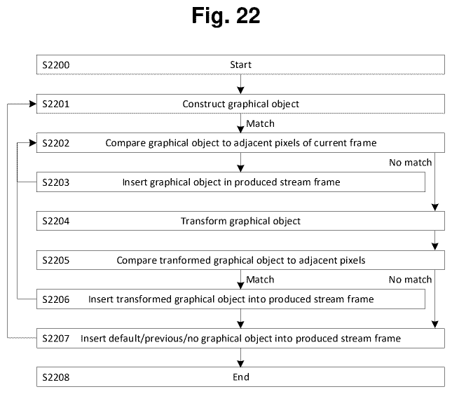

FIG. 22 illustrates a sixth method.

All Figures share reference numerals for the same or corresponding parts.

FIG. 1 illustrates a system 100 according to the present invention, arranged to perform a method according to the invention for transferring a digital video stream, for instance a produced and/or shared digital video stream.

As the term is used herein, “video” and “video stream” includes image material, such as a sequence of image frames. A “video” or “video stream” can also include one or several corresponding audio information tracks.

The system 100 may comprise a video communication service 110, but a video communication service 110 may also be external to the system 100 in some embodiments. As will be discussed, there may be more than one video communication service 110.

The system 100 may comprise one or several participant clients 121, but one, some or all participant clients 121 may also be external to the system 100 in some embodiments.

The system 100 may comprise a central server 130.

As used herein, the term “central server” is a computer-implemented functionality that is arranged to be accessed in a logically centralised manner, such as via a well-defined API (Application Programming Interface). The functionality of such a central server may be implemented purely in computer software, or in a combination of software with virtual and/or physical hardware. It may be implemented on a standalone physical or virtual server computer or be distributed across several interconnected physical and/or virtual server computers.

As will be exemplified below, in some embodiments the central server 130 comprises or is in its entirety a piece of hardware that is locally arranged in relation to one or several of said participating clients 121. As used herein, that two entities are “locally arranged” in relation to each other means that they are arranged within the same premises, such as in the same building, for instance in the same room, and preferably interconnected for local communication using a dedicated cable or local area network connection, as opposed to via the open internet. As will be described below, each participating client 121 can be its own system (or “central server” as defined below) in terms of hardware and/or software.

The physical or virtual hardware that the central server 130 runs on, in other words that computer software defining the functionality of the central server 130 executes on, may comprise a per se conventional CPU, a per se conventional GPU, a per se conventional RAM/ROM memory, a per se conventional computer bus, and a per se conventional external communication functionality such as an internet connection.

Each video communication service 110, to the extent it is used, is also a central server in said sense, that may be a different central server than the central server 130 or a part of the central server 130. In particular, the video communication service 110, or each video communication service 110, may be locally arranged in relation to one, several or all of the participating clients 121.

Correspondingly, each of said participant clients 121 may be a central server in said sense, with the corresponding interpretation, and physical or virtual hardware that each participant client 121 runs on, in other words that computer software defining the functionality of the participant client 121 executes on, may also comprise a per se conventional CPU/GPU, a per se conventional RAM/ROM memory, a per se conventional computer bus, and a per se conventional external communication functionality such as an internet connection.

Each participant client 121 also typically comprises or is in communication with a computer screen, arranged to display video content provided to the participant client 121 as a part of an ongoing video communication; one or several loudspeakers, arranged to emit sound content provided to the participant client 121 as a part of said video communication; one or several video cameras; and one or several microphones, arranged to record sound locally to a human participant 122 to said video communication, the participant 122 using the participant client 121 in question to participate in said video communication.

In other words, a respective human-machine interface of each participant client 121 allows a respective participant 122 to interact with the client 121 in question, in a video communication, with other participants and/or audio/video streams provided by various sources.

In general, each of the participating clients 121 comprises a respective input means 123, that may comprise said video camera(s); said microphone(s); a keyboard; a computer mouse or trackpad; and/or an API to receive a digital video stream, a digital audio stream and/or other digital data. The input means 123 is specifically arranged to receive a video stream and/or an audio stream from a central server, such as the video communication service 110 and/or the central server 130, such a video stream and/or audio stream being provided as a part of a video communication and preferably being produced based on corresponding digital data input streams provided to said central server from at least two sources of such digital data input streams, for instance participant clients 121 and/or external sources (see below).

Further generally, each of the participating clients 121 comprises a respective output means 124, that may comprise said computer screen; said loudspeaker(s); and an API to emit a digital video and/or audio stream, such stream being representative of a captured video and/or audio locally to the participant 122 using the participant client 121 in question.

In practice, each participant client 121 may be a mobile device, such as a mobile phone, arranged with a screen, a loudspeaker, a microphone and an internet connection, the mobile device executing computer software locally or accessing remotely executed computer software to perform the functionality of the participant client 121 in question. Correspondingly, the participant client 121 may also be a thick or thin laptop or stationary computer, executing a locally installed application, using a remotely accessed functionality via a web browser, and so forth, as the case may be. Each participant client 121 can also comprise any peripherally connected equipment, such as any external cameras, microphones and/or loudspeakers.

There may be more than one, such as at least three or even at least four, participant clients 121 used in one and the same video communication of the present type.

In some cases, there is no video communication service 110, but the digital video stream is instead transferred directly between participant clients 121, possibly via one or several central servers 130 acting as intermediaries relaying the transferred digital video stream in original or modified form. For instance, such an intermediary central server 130 can use the transferred digital video stream as an input video stream to an automatic production function producing an output produced digital video stream comprising part of, or the entire, transferred digital video stream.

A video communication may be provided at least partly by the video communication service 110 and/or at least partly by the central server 130, as will be described and exemplified herein.

As the term is used herein, a “video communication” is an interactive, digital communication session involving at least two, preferably at least three or even at least four, video streams, and preferably also matching audio streams that are used to produce one or several mixed or joint digital video/audio streams that in turn is or are consumed by one or several consumers (such as participant clients of the discussed type), that may or may not also be contributing to the video communication via video and/or audio. Such a video communication can be real-time, with or without a certain latency or delay. At least one, preferably at least two, or even at least four, participants 122 to such a video communication can be involved in the video communication in an interactive manner, both providing and consuming video/audio information to/from other participant clients 121, 140 and/or to/from the central server 130 and/or the video communication service 110.

At least one of the participant clients 121, or all of the participant clients 121, may comprise a local synchronisation software function 125. The video communication service 110 may comprise or have access to a common time reference.

Each of the at least one central server 130 may comprise a respective API 137, for digitally communicating with entities external to the central server 130 in question. Such communication may involve both input and output.

The system 100, such as said central server 130, may furthermore be arranged to digitally communicate with, and in particular to receive digital information, such as audio and/or video stream data, from an external information source 300, such as an externally provided video stream. That the information source 300 is “external” means that it is not provided from or as a part of the central server 130. Preferably, the digital data provided by the external information source 300 is independent of the central server 130, and the central server 130 cannot affect the information contents thereof. For instance, the external information source 300 may be live captured video and/or audio, such as of a public sporting event or an ongoing news event or reporting. The external information source 300 may also be captured by a web camera or similar, but not by any one of the participating clients 121. Such captured video may hence show the same locality as any one of the participant clients 121, but not be captured as a part of the activity of the participant client 121 per se. One possible difference between an externally provided information source 300 and an internally provided information source 120 is that internally provided information sources may be provided as, and in their capacity as, participants to a video communication of the above-defined type, whereas an externally provided information source 300 is not, but is instead provided as a part of a context that is external to said video conference. In other embodiments, one or several externally provided information sources 300 are in the form of a respective digital camera or a microphone, arranged to capture a respective digital image/video and/or audio stream in the same locality in which one or several of the participating clients 121 and/or the corresponding users 122 are present, and in a way which is controlled by the central server 130. Hence, the central server 130 may control an on/off state of such digital image/video/audio capturing device 300, and/or other capturing state such as a currently applied physical or virtual panning or zooming. The external information source 300 may also or alternatively provide non-video data, such as one or several still images, sound information, static digital information such as text and/or numbers, and so forth.

There may also be several external information sources 300, that provide digital information of said type, such as audio and/or video streams, to the central server 130 in parallel.

As shown in FIG. 1, each of the participating clients 121 may constitute the source of a respective information (video and/or audio) stream 120, provided to the video communication service 110 by the participant client 121 in question as described.

The system 100, such as the central server 130, may be further arranged to digitally communicate with, and in particular to emit digital information (such as a digital video stream) to, an external consumer 150. For instance, a digital video and/or audio stream produced by the central server 130 may be provided continuously, in real-time or near real-time, to one or several external consumers 150 via said API 137. Again, that the consumer 150 is “external” means that the consumer 150 is not provided as a part of the central server 130, and/or that it is not a party to the said video communication. “Not being party to the video communication” may mean that the consumer 150 only accepts input from the video communication, such as in the form of a provided produced video stream, but that cannot interactively provide such information into the video communication to achieve interactivity.

Unless not stated otherwise, all functionality and communication herein is provided digitally and electronically, effected by computer software executing on suitable computer hardware and communicated over a local or global digital communication network or channel such as the internet.

Hence, in the system 100 configuration illustrated in FIG. 1, a number of participant clients 121 take part in a digital video communication provided by the video communication service 110. Each participant client 121 may hence have an ongoing login, session or similar to the video communication service 110, and may take part in one and the same ongoing video communication provided by the video communication service 110. In other words, the video communication is “shared” among the participant clients 121 and therefore also by corresponding human participants 122.

In FIG. 1, the central server 130 comprises an automatic participant client 140, being an automated client corresponding to participant clients 121 but not associated with a human participant 122. Instead, the automatic participant client 140 is added as a participant client to the video communication service 110 to take part in the same shared video communication as participant clients 121. As such a participant client, the automatic participant client 140 is granted access to continuously produced digital video and/or audio stream(s) provided as a part of the ongoing video communication by the video communication service 110, and can be consumed by the central server 130 via the automatic participant client 140. The automatic participant client 140 can be configured to receive, from the video communication service 110, a common video and/or audio stream that is or may be distributed to one, several or each participant client 121; a respective video and/or audio stream provided to the video communication service 110 from each of one or several of the participant clients 121 and relayed, in raw or modified form, by the video communication service 110 to all or requesting participant clients 121; and/or a common time reference.

The central server 130 may comprise a collecting function 131 arranged to receive video and/or audio streams of said type from the automatic participant client 140, and possibly also from said external information source(s) 300, for processing as described below, and then to provide a produced, such as shared, video stream via the API 137. For instance, this produced video stream may be consumed by the external consumer 150 and/or by the video communication service 110 to in turn be distributed by the video communication service 110 to all or any requesting one of the participant clients 121.

FIG. 2 is similar to FIG. 1, but instead of using the automatic client participant 140 the central server 130 receives video and/or audio stream data from the ongoing video communication via an API 112 of the video communication service 110.

FIG. 3 is also similar to FIG. 1, but shows no video communication service 110. In this case, the participant clients 121 communicate directly with the API 137 of the central server 130, for instance providing video and/or audio stream data to the central server 130 and/or receiving video and/or audio stream data from the central server 130. Then, the produced shared stream may be provided to the external consumer 150 and/or to one or several of the client participants 121.

FIG. 4 illustrates the central server 130 in closer detail. As illustrated, said collecting function 131 may comprise one or, preferably, several, format-specific collecting functions 131a. Each one of said format-specific collecting functions 131a may be arranged to receive a video and/or audio stream having a predetermined format, such as a predetermined binary encoding format and/or a predetermined stream data container, and may be specifically arranged to parse binary video and/or audio data of said format into individual video frames, sequences of video frames and/or time slots.

The central server 130 may further comprise an event detection function 132, arranged to receive video and/or audio stream data, such as binary stream data, from the collecting function 131 and to perform a respective event detection on each individual one of the received data streams. The event detection function 132 may comprise an AI (Artificial Intelligence) component 132a for performing said event detection. The event detection may take place without first time-synchronising the individual collected streams.

The central server 130 further comprises a synchronising function 133, arranged to time-synchronise the data streams provided by the collecting function 131 and that may have been processed by the event detection function 132. The synchronising function 133 may comprise an AI component 133a for performing said time-synchronisation.

The central server 130 may further comprise a pattern detection function 134, arranged to perform a pattern detection based on the combination of at least one, but in many cases at least two, such as at least three or even at least four, such as all, of the received data streams. The pattern detection may be further based on one, or in some cases at least two or more, events detected for each individual one of said data streams by the event detection function 132. Such detected events taking into consideration by said pattern detection function 134 may be distributed across time with respect to each individual collected stream. The pattern detection function 134 may comprise an AI component 134a for performing said pattern detection.

The central server 130 can further comprise a production function 135, arranged to produce a produced digital video stream, such as a shared digital video stream, based on the data stream or streams provided from the collecting function 131, and possibly further based on any detected events and/or patterns. Such a produced video stream may at least comprise a video stream produced to comprise one or several of video streams provided by the collecting function 131, raw, reformatted or transformed, and may also comprise corresponding audio stream data. As will be exemplified below, there may be several produced video streams, where one such produced video stream may be produced in the above-discussed way but further based on a another already produced video stream.

All produced video streams can be produced continuously and/or in near real-time.

The central server 130 may further comprise a publishing function 136, arranged to publish the produced digital video stream in question, such as via API 137 as described above.

It is noted that FIGS. 1, 2 and 3 illustrate three different examples of how the central server 130 can be used to implement the principles described herein, and in particular to provide a method according to the present invention, but that other configurations, with or without using one or several video communication services 110, are also possible.

FIG. 5 illustrates a method for providing a produced digital video stream. FIGS. 6a-6f illustrates different digital video/audio data stream states resulting from the method steps illustrated in FIG. 5.

In a first step S500, the method starts.

In a subsequent collecting step S501, respective primary digital video streams 210, 301 are collected, such as by said collecting function 131, from one or more of said digital video sources 120, 300. Each such primary data stream 210, 301 may comprise an audio part 214 and/or a video part 215. It is understood that “video”, in this context, refers to moving and/or still image contents of such a data stream, the data stream comprising or not comprising audio following the visible contents of the video. Each primary data stream 210, 301 may be encoded according to any video/audio encoding specification (using a respective codec used by the entity providing the primary stream 210, 301 in question), and the encoding formats may be different across different ones of said primary streams 210, 301 concurrently used in one and the same video communication. It is preferred that at least one, such as all, of the primary data streams 210, 301 is provided as a stream of binary data, possibly provided in a per se conventional data container data structure. It is preferred that at least one, such as at least two, or even all of the primary data streams 210, 301 are provided as respective live video recordings. One or several primary data streams 210, 301 can alternatively or additionally be provided as existing digital video resources, or digital video resources being constructed on the fly (but not recorded using a camera) in connection with the collecting. For instance, a primary video stream 210, 301 can be a digital video stream being constructed as a series of images based on (consecutive over time) rendering of 3D data or a per se static document.

It is noted that the primary streams 210, 301 may be unsynchronised in terms of time when they are received by the collecting function 131. This may mean that they are associated with different latencies or delays in relation to each other. For instance, in case two primary video streams 210, 301 are live recordings, this may imply that they are associated, when received by the collecting function 131, with different latencies with respect to the time of recording.

It is also noted that the primary streams 210, 301 may themselves be a respective live camera feed from a web camera; a currently shared screen or presentation; a viewed film clip or similar; or any combination of these arranged in various ways in one and the same screen.

The collecting step S501 is shown in FIGS. 6a and 6b. In FIG. 6b, it is also illustrated how the collecting function 131 can store each primary video stream 210, 301 as bundled audio/video information or as audio stream data separated from associated video stream data. FIG. 6b illustrates how the primary video stream 210, 301 data is stored as individual frames 213 or collections/clusters of frames, “frames” here referring to time-limited parts of image data and/or any associated audio data, such as each frame being an individual still image or a consecutive series of images (such as such a series constituting at the most 1 second of moving images) together forming moving-image video content.

In a subsequent event detection step S502, performed by the event detection function 132, said primary digital video streams 210, 301 can be analysed, such as by said event detection function 132, for instance said AI component 132a, to detect at least one event 211 selected from a first set of events. This is illustrated in FIG. 6c.

It is preferred that this event detection step S502 may be performed for at least one, such as at least two, such as all, primary video streams 210, 301, and that it may be performed individually for each such primary video stream 210, 301. In other words, the event detection step S502 preferably takes place for said individual primary video stream 210, 301 only taking into consideration information contained as a part of that particular primary video stream 210, 301 in question, and particularly without taking into consideration information contained as a part of other primary video streams. Furthermore, the event detection preferably takes place without taking into consideration any common time reference 260 associated with the several primary video streams 210, 301.

On the other hand, the event detection preferably takes into consideration information contained as a part of the individually analysed primary video stream in question across a certain time interval, such as a historic time interval of the primary video stream that is longer than 0 seconds, such as at least 0.1 seconds, such as at least 1 second.

The event detection may take into consideration information contained in audio and/or video data contained as a part of said primary video stream 210, 301.

Said first set of events may contain any number of types of events, such as a change of slides in a slide presentation constituting or being a part of the primary video stream 210, 301 in question; a change in connectivity quality of the source 120, 300 providing the primary video stream 210, 301 in question, resulting in an image quality change, a loss of image data or a regain of image data; and a detected movement physical event in the primary video stream 210, 301 in question, such as the movement of a person or object in the video, a change of lighting in the video, a sudden sharp noise in the audio or a change of audio quality. It is realised that this is not intended to be an exhaustive list, but that these examples are provided in order to understand the applicability of the presently described principles. See the above-referenced Swedish application SE 2151267-8 for additional details.

In a subsequent synchronising step S503, performed by the synchronisation function 133, several provided primary digital video streams 210 may be time-synchronised. This time-synchronisation may be with respect to a common time reference 260. As illustrated in FIG. 6d, the time-synchronisation may involve aligning the primary video streams 210, 301 in relation to each other, for instance using said common time reference 260, so that they can be combined to form a time-synchronised context. The common time reference 260 may be a stream of data, a heartbeat signal or other pulsed data, or a time anchor applicable to each of the individual primary video streams 210, 301. The common time reference can be applied to each of the individual primary video streams 210, 301 in a way so that the informational contents of the primary video stream 210, 301 in question can be unambiguously related to the common time reference with respect to a common time axis. In other words, the common time reference may allow the primary video streams 210, 301 to be aligned, via time shifting, so as to be time-synchronised in the present sense. In other embodiments, the time-synchronisation may be based on known information about a time difference between the primary video streams 210, 301 in question, such as based on measurements.

As illustrated in FIG. 6d, the time-synchronisation may comprise determining, for each primary video streams 210, 301, one or several timestamps 261, such as in relation to the common time reference 260 or for each video stream 210, 301 in relation to another video stream 210, 301 or to other video streams 210, 301.

In a subsequent pattern detection step S504, performed by the pattern detection function 134, the hence time-synchronised primary digital video streams 210, 301 can be analysed to detect at least one pattern 212 selected from a first set of patterns. This is illustrated in FIG. 6e.

In contrast to the event detection step S502, the pattern detection step S504 may be performed based on video and/or audio information contained as a part of at least two of the time-synchronised primary video streams 210, 301 considered jointly.

Said first set of patterns may contain any number of types of patterns, such as several participants talking interchangeably or concurrently; or a presentation slide change occurring concurrently as a different event, such as a different participant talking. This list is not exhaustive, but illustrative. Again see the above-referenced Swedish application SE 2151267-8 for details.

In some embodiments, detected patterns 212 may relate not to information contained in several of said primary video streams 210, 301 but only in one of said primary video streams 210, 301. In such cases, it is preferred that such pattern 212 is detected based on video and/or audio information contained in that single primary video stream 210, 301 spanning across at least two detected events 211, for instance two or more consecutive detected presentation slide changes or connection quality changes. As an example, several consecutive slide changes that follow on each other rapidly over time may be detected as one single slide change pattern, as opposed to one individual slide change pattern for each detected slide change event. Other examples include the movement of a shown entity or person; and the recognition of an uttered vocal phrase by a participant user.

It is realised that the first set of events and said first set of patterns may comprise events/patterns being of predetermined types, defined using respective sets of parameters and parameter intervals. The events/patterns in said sets may also, or additionally, be defined and detected using various AI tools.

In a subsequent production step S505, performed by the production function 135, a digital video stream is produced as an output digital video stream 230 based on consecutively considered frames 213 of the (possibly time-synchronised) one or more primary digital video streams 210, 301, and further possibly based on said detected events 211 and/or said detected patterns 212. The produced digital video stream 230 may or may not be a “shared” video stream in the sense that it is provided to more than one of the participant clients 121. The production can also involve producing different output digital video streams 230 for different participant clients 121 and/or external consumers 150.

The present invention allows for the completely automatic production of video streams, such as of one or several output digital video streams 230.

For instance, such production may involve the selection of what video and/or audio information from what primary video stream 210, 301 to use to what extent in such output video stream 230; a video screen layout of an output video stream 230; a switching pattern between different such uses or layouts across time; and so forth.

This is illustrated in FIG. 6f, that also shows one or several additional pieces of time-related (that may be related to the common time reference 260) digital video information 220, such as an additional digital video information stream, that can be time-synchronised (such as to said common time reference 260) and used in concert with the (possibly time-synchronised) one or more primary video streams 210, 301 in the production of the output video stream 230. For instance, the additional stream 220 may comprise information with respect to any video and/or audio special effects to use, such as dynamically based on detected patterns; a planned time schedule for the video communication; and so forth.

In a subsequent publishing step S506, performed by the publishing function 136, the produced output digital video stream(s) 230 is or are continuously provided to one or several consumers 110, 121, 150 of the produced digital video stream as described above. The produced digital video stream may be provided to one or several participant clients 121, such as via the video communication service 110.

In a subsequent step S507, the method ends. However, first the method may iterate any number of times, as illustrated in FIG. 5, to produce the output video stream 230 as a continuously provided stream. Preferably, the output video stream 230 is produced to be consumed in real-time or near real-time (taking into consideration a total latency added by all steps along the way), and continuously (publishing taking place immediately when more information is available). This way, the one or several output video streams 230 may be consumed in an interactive manner, so that each output video stream 230 may be fed back into the video communication service 110 or into any other context forming a basis for the production of a primary video stream 210 again being fed to the collection function 131 so as to form a closed feedback loop; or so that each output video stream 230 may be consumed into a different (external to system 100 or at least external to the central server 130) context but there forming the basis of a real-time, interactive video communication.

As mentioned above, in some embodiments at least two, such as at least three, such as at least four, or even at least five, of said primary digital video streams 210, 301 are provided as a part of a shared digital video communication, such as provided by said video communication service 110, the video communication involving a respective remotely connected participant client 121 providing the primary digital video stream 210 in question.

In such cases, the collecting step S501 may comprise collecting at least one of said primary digital video streams 210 from the shared digital video communication service 110 itself, such as via an automatic participant client 140 in turn being granted access to video and/or audio stream data from within the video communication service 110 in question; and/or via an API 112 of the video communication service 110.

Moreover, in this and in other cases the collecting step S501 may comprise collecting at least one of said primary digital video streams 210, 301 as a respective external digital video stream 301, collected from an information source 300 being external to the shared digital video communication service 110. It is noted that one or several used such external video sources 300 may also be external to the central server 130.

In some embodiments, the primary video streams 210, 301 are not formatted in the same manner. Such different formatting can be in the form of them being delivered to the collecting function 131 in different types of data containers (such as AVI or MPEG), but in preferred embodiments at least one of the primary video streams 210, 301 is formatted according to a deviating format (as compared to at least one other of said primary video streams 210, 301) in terms of said deviating primary digital video stream 210, 301 having a deviating video encoding; a deviating fixed or variable frame rate; a deviating aspect ratio; a deviating video resolution; and/or a deviating audio sample rate.

It is preferred that the collecting function 131 is preconfigured to read and interpret all encoding formats, container standards, etc. that occur in all collected primary video streams 210, 301. This makes it possible to perform the processing as described herein, not requiring any decoding until relatively late in the process (such as not until after the primary stream in question is put in a respective buffer; not until after the event detection step S502; or even not until after the event detection step S502). However, in the rare case in which one or several of the primary video feeds 210, 301 are encoded using a codec that the collecting function 131 cannot interpret without decoding, the collecting function 131 may be arranged to perform a decoding and analysis of such primary video stream 210, 301, followed by a conversion into a format that can be handled by, for instance, the event detection function. It is noted that, even in this case, it is preferred not to perform any reencoding at this stage.

For instance, primary video streams 220 being fetched from multi-party video events, such as one provided by the video communication service 110, typically have requirements on low latency and are therefore typically associated with variable framerate and variable pixel resolution to enable participants 122 to have an effective communication. In other words, overall video and audio quality will be decreased as necessary for the sake of low latency.

External video feeds 301, on the other hand, will typically have a more stable framerate, higher quality but therefore possibly higher latency.

Hence, the video communication service 110 may, at each moment in time, use a different encoding and/or container than the external video source 300. The analysis and video production process described herein in this case therefore needs to combine these streams 210, 301 of different formats into a new one for the combined experience.

As mentioned above, the collecting function 131 may comprise a set of format-specific collecting functions 131a, each one arranged to process a primary video stream 210, 301 of a particular type of format. For instance, each one of these format-specific collecting functions 131a may be arranged to process primary video streams 210, 301 having been encoded using a different video respective encoding method/codec, such as Windows® Media® or DivX®.

However, in some embodiments the collecting step S501 comprises converting at least two, such as all, of the primary digital video streams 210, 301 into a common protocol 240.

As used in this context, the term “protocol” refers to an information-structuring standard or data structure specifying how to store information contained in a digital video/audio stream. This can comprise information specifying a particular frame rate, pixmap resolution, color depth, audio encoding and/or image encoding to use. In some embodiments, however, the common protocol is not configured to specify how to store the digital video and/or audio information as such on a binary level (i.e, the encoded/compressed data instructive of the sounds and images themselves), but instead forms a structure of predetermined format for storing such data. In other words, the common protocol prescribes storing digital video data in raw, binary form without performing any digital video decoding or digital video encoding in connection to such storing, possibly by not at all amending the existing binary form apart from possibly concatenating and/or splitting apart the binary form byte sequence. Instead, the raw (encoded/compressed) binary data contents of the primary video stream 210, 301 in question is kept, while repacking this raw binary data in the data structure defined by the protocol. In some embodiments, the common protocol defines a video file container format.

FIG. 7 illustrates, as an example, the primary video streams 210, 301 shown in FIG. 6a, restructured by the respective format-specific collecting function 131a and using said common protocol 240.

Hence, the common protocol 240 prescribes storing digital video and/or audio data in data sets 241, preferably divided into discreet, consecutive sets of data along a time line pertaining to the primary video stream 210, 301 in question. Each such data set may include one or several video frames, and also associated audio data.

The common protocol 240 may also prescribe storing metadata 242 associated with specified time points in relation to the stored digital video and/or audio data sets 241.

The metadata 242 may comprise information about the raw binary format of the primary digital video stream 210 in question, such as regarding a digital video encoding method or codec used to produce said raw binary data; a resolution of the video data; a video frame rate; a frame rate variability flag; a video resolution; a video aspect ratio; an audio compression algorithm; or an audio sampling rate. The metadata 242 may also comprise information on a timestamp of the stored data, such as in relation to a time reference of the primary video stream 210, 301 in question as such or to a different video stream as discussed above.

Using said format-specific collecting functions 131a in combination with said common protocol 240 makes it possible to quickly collect the informational contents of the primary video streams 210, 301 without adding latency by decoding/reencoding the received video/audio data.

Hence, the collecting step S501 may comprise using different ones of said format-specific collecting functions 131a for collecting primary digital video streams 210, 301 being encoded using different binary video and/or audio encoding formats, in order to parse the primary video stream 210, 301 in question and store the parsed, raw and binary data in a data structure using the common protocol, together with any relevant metadata. Self-evidently, the determination as to what format-specific collecting function 131a to use for what primary video stream 210, 301 may be performed by the collecting function 131 based on predetermined and/or dynamically detected properties of each primary video stream 210, 301 in question.

Each hence collected primary video stream 210, 301 may be stored in its own separate memory buffer, such as a RAM memory buffer, in the central server 130.

The converting of the primary video streams 210, 301 performed by each format-specific collecting function 131a may hence comprise splitting raw, binary data of each thus converted primary digital video stream 210, 301 into an ordered set of said smaller sets of data 241.

Moreover, the converting may also comprise associating each (or a subset, such as a regularly distributed subset along a respective timeline of the primary stream 210, 301 in question) of said smaller sets 241 with a respective time along a shared timeline, such as in relation to said common time reference 260. This associating may be performed by analysis of the raw binary video and/or audio data in any of the principle ways described below, or in other ways, and may be performed in order to be able to perform the subsequent time-synchronising of the primary video streams 210, 301. Depending on the type of common time reference used, at least part of this association of each of the data sets 241 may also or instead be performed by the synchronisation function 133. In the latter case, the collecting step S501 may instead comprise associating each, or a subset, of the smaller sets 241 with a respective time of a timeline specific for the primary stream 210, 301 in question.

In some embodiments, the collecting step S501 also comprises converting the raw binary video and/or audio data collected from the primary video streams 210, 301 into a uniform quality and/or updating frequency. This may involve down-sampling or up-sampling of said raw, binary digital video and/or audio data of the primary digital video streams 210, 301, as necessary, to a common video frame rate; a common video resolution; or a common audio sampling rate. It is noted that such re-sampling can be performed without performing a full decoding/reencoding, or even without performing any decoding at all, since the format-specific collecting function 131a in question can process the raw binary data directly according to the correct binary encoding target format.

Each of said primary digital video streams 210, 301 may be stored in an individual data storage buffer 250, as individual frames 213 or sequences of frames 213 as described above, and also each associated with a corresponding time stamp in turn associated with said common time reference 260.

In a concrete example, provided to illustrate these principles, the video communication service 110 is Microsoft® Teams®, running a video conference involving concurrent participants 122. The automatic participant client 140 is registered as a meeting participant in the Teems® meeting.

Then, the primary video input signals 210 are available to and obtained by the collecting function 130 via the automatic participant client 140. These are raw signals in H264 format and contain timestamp information for every video frame.

The relevant format-specific collecting function 131a picks up the raw data over IP (LAN network) on a configurable predefined TCP port. Every Teems® meeting participant, as well as associated audio data, are associated with a separate port. The collecting function 131 then uses the timestamps from the audio signal (which is in 50 Hz) and down-samples the video data to a fixed output signal of 25 Hz before storing the video stream 220 in its respective individual buffer 250.

As mentioned, the common protocol 240 may store the data in raw binary form. It can be designed to be very low-level, and to handle the raw bits and bytes of the video/audio data. In preferred embodiments, the data is stored in the common protocol 240 as a simple byte array or corresponding data structure (such as a slice). This means that the data does not need to be put in a conventional video container at all (said common protocol 240 not constituting such conventional container in this context). Also, encoding and decoding video is computationally heavy, which means it causes delays and requires expensive hardware. Moreover, this problem scales with the number of participants.

Using the common protocol 240, it becomes possible to reserve memory in the collecting function 131 for the primary video stream 210 associated with each Teams® meeting participant 122, and also for any external video sources 300, and then to change the amount of memory allocated on the fly during the process. This way, it becomes possible to change the number of input streams and as a result keep each buffer effective. For instance, since information like resolution, framerate and so forth may be variable but stored as metadata in the common protocol 240, this information can be used to quickly resize each buffer as need may be.

In some embodiments, said at least one additional piece of digital video information 220, that may be an overlay or an effect, is also stored in a respective individual buffer 250, as individual frames or sequences of frames each associated with a corresponding time stamp in turn associated with said common time reference 260.

As exemplified above, the event detection step S502 may comprise storing, using said common protocol 240, metadata 242 descriptive of a detected event 211, associated with the primary digital video stream 210, 301 in which the event 211 in question was detected.

The production step S505 may comprise producing the one or several output digital video streams 230 based on a set of predetermined and/or dynamically variable parameters regarding visibility of individual ones of said primary digital video streams 210, 301 in said output digital video stream 230; visual and/or audial video content arrangement; used visual or audio effects; and/or modes of output of the output digital video stream 230. Such parameters may be automatically determined by said production function 135 state machine and/or be set by an operator controlling the production (making it semi-automatic) and/or be predetermined based on certain a priori configuration desires (such as a shortest time between output video stream 230 layout changes or state changes).

In practical examples, the state machine may support a set of predetermined standard layouts that may be applied to the output video stream 230, such as a full-screen presenter view (showing a current speaking participant 122 in full-screen); a slide view (showing a currently shared presentation slide in full-screen); “butterfly view”, showing both a currently speaking participant 122 together with a currently shared presentation slide, in a side-by-side view; a multi-speaker view, showing all or a selected subset of participants 122 side-by-side or in a matrix layout; and so forth. Various available production formats can be defined by a set of state machine state changing rules together with an available set of states (such as said set of standard layouts). For instance, one such production format may be “panel discussion”, another “presentation”, and so forth. By selecting a particular production format via a GUI or other interface to the central server 130, an operator of the system 100 may quickly select one of a set of predefined such production formats, and then allow the central server 130 to, completely automatically, produce the one or several output video streams 230 according to the production format in question, based on available information as described above.

Furthermore, during the production a respective in-memory buffer may be created and maintained for each meeting participant client 121 or external video source 300. These buffers can easily be removed, added, and changed on the fly. The central server 130 can then be arranged to receive information, during the production of the output video stream 230, regarding added/dropped-off participant clients 121 and participants 122 scheduled for delivering speeches; planned or unexpected pauses/resumes of presentations; desired changes to the currently used production format, and so forth. Such information may, for instance, be fed to the central server 130 via an operator GUI or interface, as described above.

As exemplified above, in some embodiments at least one of the primary digital video streams 210, 301 is provided to the digital video communication service 110, and the publishing step S506 may then comprise providing said one or several output digital video streams 230 to that same communication service 110. For instance, the output video stream(s) 230 may be provided to a participant client 121 of the video communication service 110, or be provided, via API 112 as a respective external video stream to the video communication service 110. This way, the output video stream(s) 230 may be made available to several or all of the participants to the video communication event currently being achieved by the video communication service 110.

As also discussed above, in addition or alternatively one or several output video streams 230 may be provided to one or several external consumers 150.

In general, the production step S505 may be performed by the central server 130, providing said output digital video streams 230 to one or several concurrent consumers as a live video stream via the API 137.

FIG. 8 illustrates a method for transferring a first source video stream SVS1.

Moreover, FIGS. 9, 10 and 11 are respective simplified views of the system 100 configured to perform the methods illustrated in FIG. 8.

In FIG. 9, there are three different central servers 130′, 130″, 130′″ shown. These central servers 130′, 130″, 130′″ may be one single, integrated central server of the type discussed above; or be separate such central servers. They may or may not execute on the same physical or virtual hardware. At any rate, they are arranged to communicate with each other.

In some embodiments, the central servers 130′ and 130″ may be arranged to execute on one and the same piece of physical hardware 402 (illustrated by dotted rectangle in FIG. 9), for instance in the form of a discrete hardware appliance such as a per se conventional computer device. In some embodiments, such discrete hardware appliance 402 is a computer device arranged in, or in physical connection to, a meeting room, and specifically arranged to conduct digital video meetings in that room. In other embodiments, the discrete hardware appliance is a personal computer 402″, 402′″, such as a laptop computer, used by an individual human meeting participant 122, 122″, 122′″ to such digital video meeting, the participant 122, 122″, 122′″ being present in the room in question or remotely.

Each of the central servers 130′, 130″, 130′″ comprises a respective collecting function 131′, 131″, 131′″, that may be as generally described above. The collecting function 131′ can be arranged to collect a digital video stream 401 from a digital camera (such as the video camera 123 of the type generally described above). Such a digital camera may be an integrated part of said discrete hardware appliance 402 or a separate camera, connected to the hardware appliance 402 using a suitable wired or wireless digital communication channel. At any rate, the camera can be arranged locally in relation to the hardware appliance 402.

Each of the collecting functions 131″, 131′″ may collect a digital video signal corresponding to the digital video stream 401 directly from said digital camera or from collecting function 131′.

Each of the central servers 130′, 130″, 130′″ may also comprise a respective production function 135′, 135″, 135′″. Each such production function 135′, 135″, 135′″ corresponds to the production function 135 described above, and what has been said above in relation to production function 135 applies equally to production functions 135′, 135″ and 135′″. There may also be more than three production functions, depending on the detailed configuration of the central servers 130′, 130″, 130′″. The various digital communications between the production functions 135′, 135″, 135′″ and other entities may take place via suitable APIs.

Moreover, each of the central servers 130′, 130″, 130′″ may comprise a respective publishing function 136′, 136″, 136′″. Each such publishing function 136′, 136″, 136′″ corresponds to the publishing function 136 described above, and what has been said above in relation to publishing function 136 applies equally to publishing functions 136′, 136″ and 136′″. The publishing functions 136′, 136″, 136′″ may be distinct or co-arranged in one single logical function with several functions, and there may also be more than three publishing functions, depending on the detailed configuration of the central servers 130′, 130″, 130′″. The publishing functions 136′, 136″, 136′″ may in some cases be different functional aspects of one and the same publication function 136.

Whereas the publishing functions 136″ and 136′″ are optional, and may be arranged to output a different (possibly more elaborate, associated with a respective time delay) video stream than a video stream output by publishing function 136′, the publishing function 136′ can be configured to output one or several output digital video streams of the type generally described herein. Further generally, each of the production functions 135″ and 135′″ can be arranged to process the respective incoming video streams so as to produce production control parameters to be used by the production function 135′ to in turn produce said output video stream(s) according to what is described herein.

FIG. 9 also shows three external consumers 150′, 150″, 150′″, each corresponding to external consumer 150 described above. It is realised that there may be less than three; or more than three such external consumers 150′, 150″, 150′″. For instance, two or more of the publishing functions 136′, 136″, 136′″ may output identical or different produced video streams to one and the same external consumer 150′, 150″, 150′″, and each one of the publishing functions 136′, 136″, 136′″ may output identical or different produced video streams to more than one of said external consumers 150′, 150″, 150′″. It is also noted that at least the publishing function 136′ may publish one or several produced video stream(s) back to the collecting function 131′. Furthermore, each of the publishing functions 136′, 136″, 136′″ may be arranged to publish the respective produced video stream(s) in question to a participant client 121 of the general type discussed above.

It is realised that the consumer 150′ may be a participant client 121 that also comprises the central server 130′, for instance by a laptop computer being arranged with the functionality of central server 130′ (and possibly also central server 130″) and providing a corresponding human user 122 with the enhanced, real-time output video stream on a screen of said laptop computer as a part of the video communication service in which the human user 122 participates.

Moreover, FIG. 9 shows three external information sources 300′, 300″, 300′″, each corresponding to external information source 300 described above and providing information to a respective one of said collecting functions 131′, 131″, 131′″. It is realised that there may be less than three; or more than three such external information sources 300′, 300″, 300′″. For instance, one such external information source 300′, 300″, 300′″ may feed into more than one collecting functions 131′, 131″, 131′″; and each collecting function 131′, 131″, 131′″ may be fed from more than one external information source 300′, 300″, 300′−.

FIG. 9 does not, for reasons of simplicity, show the video communication service 110, but it is realised that a video communication service of the above-discussed general type may be used with the central servers 130′, 130″, 130′″, such as providing a shared video communication service to a participant client 121 using the central servers 130′, 130″, 130′″ in the way discussed above. In some embodiments, central server 130′″ constitutes, comprises or is comprised in the video communication service 110.

FIG. 10 illustrates a system 100 setup with three exemplary pieces of hardware or clients 402′, 402″ and 402′″ of the type described above, each of these clients 402′, 402″, 402′″ having a respective camera 403′, 403″, 403′″ configured to capture respective video footage of a respective user 122′, 122″, 122′″ as a part of a video communication service provided by video communication service 110. FIG. 10 also illustrates an external information source 300 and a central server 130. All these entities can be as generally described above, and can be connected over the open internet.

As mentioned above, the method illustrated in FIG. 8 is for transferring a first source video stream SVS1. Generally, the transfer can be from a sender 510 to a receiver 530, and in the illustrative views of FIGS. 9 and 10 the sender can be any one of entities 110, 130, 300, 402′, 402″ or 402′″. Similarly, the receiver can be any other one of the same entities 110, 130, 300, 402′, 402″ or 402′″. See also FIG. 11.

In other words, the first source video stream SVS1 can be transferred from a first client 402′ to a second client 402″ as a part of the video communication service, for instance by the first source video stream SVS1 being a raw or produced video stream showing a user 122′ of the first client 402′; it can be transferred from the external information source 300 to the central server 130, the video communication service 110 or to the first device 402′ as a video stream then used by the central server 130 or the video communication service 110 as an input to a produced video stream thereafter sent to the first client 402′, or sent directly to the first client 402′ with or without an intermediary production; it can be transferred from the external information source 300 to the central server 130 or the video communication service 110 for internal use by the receiving entity; it can be transferred directly from the first client 402′ to the second client 402″ not as part of a video communication service; and so forth. It is realized that these are merely examples; the sender 510 and the receiver 530 can be any two entities wishing to securely transfer a video stream from the sender 510 to the receiver 530. A common denominator for all these cases, however, can be that the first source video stream SVS1 is to be transferred in a way so that the receiver 530 can verifiably trust that the received video stream is authentic in the sense that it was actually sent by the sender 501; that is was not tampered with during transfer in a way altering its cognitive contents; and/or that it was produced and/or sent at a certain specified time, or that it was produced and/or sent in real time.

Various situations in which the presently described methods can be used include real-time video scenarios such as secure conferencing, surveillance, or live event streaming. In such contexts, the presently described methods can be used by the receiver 530 to ensure content integrity and authenticity. In particular, the presently described methods can be used to provide content integrity and authenticity in an ongoing, possibly continuous, manner during the transfer of the first source video stream SVS1, and not only at an initial point in time where authentication takes place or when the transfer starts.

For example, in a secure video conferencing environment, participants need to be confident that the person they are seeing is not being spoofed by an attacker during the call. Similarly, surveillance feeds should be known to have remained uncompromised from the moment of transmission to the moment of viewing, without introducing vulnerabilities at any stage. Without a mechanism that provides continual verification of a video feed's authenticity, malicious actors could manipulate or replace the content without easy detection by the intended recipients. This problem leaves gaps in applications that depend on video feeds for security-critical decisions; for example, responding to threats in a secure facility based on live camera feeds. Furthermore, any latency or interruption in such streams might allow unauthorized individuals to exploit vulnerabilities, necessitating the need for robust, continuous security.

In some embodiments, the first source video stream SVS1 is transferred as a part of a first produced video stream PVS1 as will be described below, and in such cases it is the first produced video stream PVS1 that is received by the receiver 530. The first produced video stream PVS1 can be a streamed video in the sense that it is transferred one piece at a time to the receiver 530 and used by the receiver 530 for immediate consumption of at least the first source video stream SVS1 contained in the first produced video stream PVS1. Such consumption can involve, for example, displaying the continuously received video contents on a display or the use of the continuously received video contents in a further production of a further produced video stream that can in turn be displayed or streamed in the same sense as above regarding the streaming of the first produced video stream PVS1.

To address the above-discussed and potentially other problems, the presently discussed methods comprise the embedding in the first produced video stream PVS1 of dynamic, algorithmically generated information, such as in the form of graphical objects 200 or a first piece of information POI1, provided within or outside of a pixmap of the first source video stream SVS1. The information can act as an authentication layer, such as a multi-factor authentication layer, the layer being transferred together with the first source video stream SVS1 within the first produced video stream PVS1. The information can be generated based on cryptographic data that can dynamically change, for instance in response to an ongoing authorization process, producing a unique sequence of information that acts as a signature of authenticity of the first source video stream SVS1, the sender 510 and/or a user 122 of the sending client 121.

This way, the integrity of the first source video stream SVS1 can be continuously validated, in the sense that any tampering or interruptions can be detected in real-time by the receiver 530. The generated information can be calculated in a way making it practically impossible for malevolent actors to predict or duplicate the information, so that it becomes very difficult to tamper the first source video stream SVS1 by replacing or altering the first source video stream SVS1. The information can be made known to any party that wishes to verify the integrity of the first source video stream SVS1, for instance in a decentralized trust platform implementation. These advantages can be achieved without significantly increasing a required amount of memory or compute usage over time, and while allowing an amount of required compute to vary in response to changing availability of such compute by, for instance, modifying a cadence with which updated verification information is calculated or injected into the first produced video stream PVS1.

Turning back to FIG. 8, in a first step S800 the method starts.

In a subsequent step S801, the first source video stream SVS1 is received, collected, captured or constructed. This can be performed by the sender 510, or the received, collected, captured or constructed first source video stream SVS1 can be provided to the sender 510 by a party doing the receiving, collecting, capturing or constructing. For instance, the first source video stream SVS1 can be continuously captured by a camera 403′ of a client 402′ being the sender 510; collected from a hard drive or memory of the sender 510; or produced by the client 510 based on existing information, such as one or more captured or collected video streams and/or one or more other pieces of information available to the client 510. It is realized that, in the system 100, more than one such source video stream can be concurrently transferred between various pairs of senders and receivers at any one point in time, in which case such transfers can be individually authenticated as described herein by their respective receivers, with or without intermediate parties 520 (see below).

In some embodiments, the transfer of the first source video stream SVS1 is performed in real-time. This means that the transfer is performed without any delay after said receiving, collection, capture or construction, for instance without any intermediate storing or time-consuming intermediate image processing. In the example of a captured video footage of the user 122′ of the sending client 402′ this may mean that the transfer is performed by the sending client 402′ without any time-consuming image processing before reaching the collecting function 131 of the sending client 402′; and/or immediate processing by its production function 135 and its publishing function 136. In some cases, a total delay between a receiving, collection, capturing or construction of any frame of the first source video stream SVS1 and the sending of that frame from the sender 510 can be less than 60 s, such as less than 30 s, such as less than 10 s, such as less than 5 s, such as less than 1 s, such as less than 0.5 s, such as less than 0.1 s, such as less than 0.05 s.

In a subsequent step S804, a first verification code VC1 is determined. The first verification code VC1 can be unique to the first source video stream SVS1 in the sense that the first verification code VC1 can be used by the receiver 530 to verify the authenticity of the first source video stream SVS1 in one or several of the ways described herein.

This uniqueness of the first verification code VC1 can be achieved in various ways.

In some embodiments, the first verification code VC1 is, or is determined based on, a source stream authentication code SSAC, the source stream authentication code SSAC in turn being unique for the first source video stream SVS1. The source stream authentication code SSAC can be generated in connection to a start of the transfer of the first source video stream SVS1, and can also be re-generated as a new code that is unique to the first source video stream SVS1 upon any disruption of the transfer. A party knowing the source stream authentication code SSAC for a particular stream can then use that knowledge to verify the first verification code VC1.

As used herein, the term “determined based on” throughout means “unambiguously determined based on”, such as via an unambiguous and deterministic, for instance predetermined, calculation.

The first source video stream SVS1 can be cryptographically tied to an external context, such as an external timeline, by for instance comprising an output of a one-way function in turn being calculated based on a publicly published piece of information in the way generally discussed below, or by being “weaved” in the way also discussed below. Then, the source stream authentication code SSAC can be an output of a one-way function the input of which is a part, such as a first frame or any frame containing said output of the one-way function, of the first source video stream SVS1.

The cryptographic tying of the first source video stream SVS1 to the external context and/or to the external timeline can be with respect to a point in time when the first source video stream SVS1 was received, collected, captured or constructed, for instance by incorporating the output of the one-way function being calculated based on the publicly published piece of information into a frame of the first source video stream SVS1 and then publicly publishing the output of a one-way function an input of which is said frame or a derivative thereof.

The first verification code VC1 can additionally, or alternatively, be or be determined based on a user authentication code UAC, where the user authentication code UAC can be unique for a user 122 being associated with or depicted in the first source video stream SVS1. The user authentication code UAC can be a code useful for authenticating a user 122 of the sender 510 (such as user 122′ of the sending client 402′ in the example discussed above) and/or the sender 510 itself (such as the sending client 402′).

For instance, in a step S803 a first participant user 122 can be authenticated, and the user authentication code UAC can automatically result from this authentication. There are many different ways to perform such an authentication. The authentication can comprise at least one or several of the following:
The user 122 logs in to the system 100.
The user 122 logs in to a system which is external to the system 100, for instance to a system operated by an online service vendor such as a social network or search engine operator.
The user 122 uses an existing login with a first external party to login with respect to the system 100 or to a system provided by a second external party, such as using a login token provided by the first external party.
The user 122 uses a username/password combination to be authenticated with respect to the system 100 or to a system provided by an external party.
The user receives a one-time password and uses this to be authenticated with respect to the system 100 or to a system provided by an external party.
The user 122 is biometrically measured with respect to a fingerprint, a palm, an iris, a 2D or 3D face profile, a voice profile, or similar, to be authenticated with respect to the system 100 or to a system provided by an external party.

Generally, the authentication can include at least one, at least two or even all three of the general authentication factor types “something you have”, “something you know” and “something you are”.

Something the user 122 “has” can be a mobile device, such as a smartphone or a laptop that may or may not be the client device 121 used by the user 122 to access the video communication service 110. Hence, the mobile device can be used to receive a one-time password to be entered into a graphical user interface or via a microphone, or the mobile device can be hardware-tied to a piece of information used in the authentication, such as via a secure circuit of the mobile device. A smartcard, a USB drive or other communication-enabled separate device can also be used as something that the user 122 has. The verification that the user 122 “has” the device can be by the device receiving a piece of information, such as a PIN, and the user 122 entering the information into the system 100 or into the external system. In other embodiments, the device the user 122 “has” can be arranged to communicate directly, such as electronically, digitally, using a wire and/or wirelessly, or even using an audio channel at outside-of-human-hearing-frequencies, with the client 121. Such direct communication can be active only in connection to the authentication, but can also be active also thereafter in a continuity surveillance of the user's 122 authentication status.

Something the user 122 “knows” can be a PIN, a password or passphrase. It can also be a response to a question that may be difficult to answer for other persons than the user 122.

Something the user 122 “is” can be a biometric measure of the user 122, such as a fingerprint, a facial recognition pattern, an iris scan pattern, a DNA signature, or the like.

It is realized that there are many different known ways to authenticate the user 122. Herein, the terms a “way to authenticate”, a “manner of authentication”, a “type of authentication”, and similar, are used as synonyms.

The authentication can generally be in relation to the system 100 or to a different system provided by an external party. In some embodiments, it is not important in relation to what party the user 122 is authenticated; instead an interesting aspect may in such cases instead be the reliability of the authentication in itself in terms of the authentication being a reliable proof of the actual identity of the user 122, and the fact that the authentication can be retroactively verified.

Such an authentication in relation to the system 100 or any externally provided system can produce an authentication token. This token itself can have any suitable format, such as a hash value or a cryptographic signature. Then, such a token can be configured so that it can be used to retroactively validate the authentication, so that a party having access to the authentication token can securely validate, using available tools, that the user 122 was indeed authenticated or indeed has an active and valid authentication. In a concrete example, a Webauthn device is used for the authentication, such as the Yubikey®. It is a compact personal key that operates over a standard protocol, using asymmetric cryptographical techniques, producing unique digital tokens that are immediately validated by an authentication server, but also may be preserved for later verification. In another concrete example, a third-party authentication part, such as Google®, performs the authentication and in response provides an authentication token, such as an access token according to the Oauth standard.

As used herein, “authenticated”, “authentication”, or the like, means that some party (such as an operator of the system 100) has verified the identity of somebody, such as the identity of the user 122.

In general, the authentication of the user 122 can result in the user authentication code UAC, which can for instance be or be determined based on the above-discussed authentication token.

The client (piece of hardware or central server) 121 being the sender 510 can be authenticated using a suitable challenge-response protocol based on a secret piece of information, such as a private key of a PKI key pair, known by the client 121; using a signature of some piece of information by the client 121 using such a private key; or similarly, resulting in an authentication token that can have similar properties as described above. Hence, an authentication of the client 121 can be performed completely automatically, without any human intervention. As a matter of fact, the authentication of the user 122 can also be performed fully automatically in some cases, for instance by the client 121 or any other hardware owned by the user 122 being automatically authenticated in relation to an authenticating party.

Hence, the authentication can be in relation to an identity of the user 122 and/or to the device 121; and/or can be in relation to a point in time when such authentication was performed.

In some cases, the first source video stream SVS1 is a produced video stream in the sense discussed above. Then, the first verification code VC1 can in addition or alternatively be, or be determined based on, a primary stream authentication code PSAC. Namely, the first source video stream SVS1 can be produced based completely or partially on a primary video stream PVS, such as the primary video stream PVS being partly or completely visible, in its original, formatted or processed form, in the first source video stream SVS1. In such cases, the primary video stream PVS can be associated with a primary stream authentication code PSAC. Such primary stream authentication code PSAC can be determined in a way corresponding to any one or several of the mechanisms discussed above in relation to the authentication of the client 121 providing the video stream in question, a user 122 of the client 121 or the video stream itself. However, the primary stream authentication code PSAC can be unique for the primary video stream PVS as opposed to the first source video stream SVS1.

As mentioned above, the first verification code VC1 can be, or be determined based on, a user authentication code UAC being unique for a user 122 being associated with or depicted in the first source video stream SVS1. In addition or alternatively, the same or a different user authentication code UAC can be determined to be unique for a user receiving the transfer of the first source video SVS1, such as a receiver of the first produced video stream PVS1, such as a user 122 of a piece of hardware being the receiver 530.

In addition or alternatively, the first verification code VC1 can be, or be determined based on, a session code SC, the session code SC in turn being unique for a communication session CS within the context of which the transfer of the first produced video stream PVS1 takes place. Such a session code SC can be an identifier of a communication session CS on a relatively low level, such as of a socket connection; and/or an identifier of a communication session CS on a relatively high level, such as an identifier of a currently ongoing communication session CS orchestrated by the video communication service 110.

In addition or alternatively, the first verification code VC1 can be, or be determined based on, a random code RC. The random code can be a pseudo-random code that can be determined in any suitable manner, such as in the form of a sequence of pseudo-random numbers calculated based on some seed number. In some cases, the random code RC is calculated based on a piece of hardware-generated randomness.

Additionally or alternatively, the first verification code VC1 can be, or be determined based on, a timestamp TS. The timestamp TS can be a clock timestamp, such as the current time according to some suitable clock metric such as the Unix timestamp (representing the number of seconds since Jan. 1, 1970). The timestamp TS can alternatively be a value calculated based on an output from a one-way function calculated using as input a piece of publicly published information and/or an output of a one-way function calculated using the timestamp as input and thereafter being publicly published (see below), for instance in case such one-way function output can be used to tie the output in question to a particular time interval when it was produced, based on sampling and/or publication dates of information to which the output relates.

In addition or alternatively, the first verification code VC1 can be, or be determined based on, metadata MD regarding the transfer. For instance, such metadata MD can comprise information about one or several of the sender 510; the receiver 530; the first source video stream SVS1; said session; said context; items or persons visible in the first source video stream SVS1; events or patterns taking place in the first source video stream SVS1; transcripts of words being spoken or heard, or descriptions of sounds being audible in, the first source video stream SVS1; and/or general information about what is viewed in in the first source video stream SVS1, such as a background used or lighting conditions. The metadata can, for instance, be plaintext and/or parameter information such as a name, a description, and so forth.

In addition or alternatively, the first verification code VC1 can be, or be determined based on, a secret value SV. The secret value SV can be any or all of the above-discussed pieces of information that can be used as the first verification code VC1 or based upon which the first verification code VC1 can be calculated; or the secret value SV can be a separate value. That the secret value SV is “secret” means that it is known, or made known, to the receiver 530 and to the sender 510, but that it is not known or made known to any third party that may be malevolent.

Namely, In a step S802 the secret value SV, being known to the receiver 530, can be transferred to the sender 510. The transfer may be performed by the receiver 530 or any other entity that is trusted by the receiver 530, such as the video communication service 110 or any intermediate party mediating the transfer of the first source video stream SVS1. Such trusted party can also transfer the secret value SV to the receiver 530.

In some embodiments, the first verification code VC1 is determined based on only the secret value SV and possibly also based on additional information where the additional information is known to the receiver 530. Such additional information can then be any one or several of the types of information PSAC, SSAC, UAC, SC, RC, TS and/or MD as discussed above. The receiver 530 will then be able to verify the received first produced video stream PVS1 in any of the ways described below using only information already known to the receiver 530.

In practical embodiments, the user 122 of the sender 510 can be assigned a user authentication code UAC in the form of a long-form MFA (Multi Factor Authentication) token, that can be or be used to calculate the first verification code VC1. This token can then be used to authenticate their identity whenever they join a video session. In the example of a video communication service involving several different users 122 acting as senders 510 in the present sense, each such user 122 (or corresponding device 121) can be associated with such a long-form MFA token.

The token can be determined based on user-specific information such as a user identifier, user account setup details, an authentication token of the above-discussed type, and so forth. The token can be calculated using a cryptographic algorithm comprising, for instance, elements like SHA (Secure Hash Algorithm) (such as SHA-256), PKI (Public Key Infrastructure), OTP (One-Time Password), or integration with existing MFA tools such as Google® Authenticator or Microsoft® Authenticator. For instance, the calculation may be based on a private key of a PKI key pair, the private key being known to party doing the calculation; and/or a one-time password generated using a hash function and provided to this party.

A communication session CS within the context of which the transfer of the first source video stream SVS1 takes place can also be created using token information, such as a combination of respective authentication tokens from each participant user 122 involved in a video communication service run by service 110. This token information can then form the session code SC.

The video communication service 110 can for instance create the communication session as a secure communication environment where only participants/clients 121, 122 that have been authenticated in a predetermined manner are allowed access for participation.

In a first example, the video communication service 110 is a centralized controller, that handles all security-related operations in relation to the session and its participants 121/122. This can then include verifying participants 121/122, generating tokens, and monitoring the integrity of the session over time. This may involve the video communication service 110 being the receiver 530 and/or the video communication service 110 being an intermediate party 520 of the below-described type, relaying the first source video stream SVS1 to the receiver 530. The video communication service 110 can also be a facilitator providing contexts and related information for communications between various senders 510, 511, intermediate parties 520 and receivers 530, without having such a role itself.

In a second example, the video communication service 110 in a capacity as intermediate party 520 and/or receiver 530, can be decentralized, such as managed by two or more of the participant clients 121. Then, each such managing participant client 121 can contribute to the communication session CS setup by interacting with the decentralized video communication service 110. Such participant clients 121 can then use their own cryptographic credentials to generate shared keys or contribute to the generation of the session code SC. A blockchain can be utilized to achieve such decentralization in a transparent manner. By using a blockchain, each participant client's 121 contribution to the session setup (such as cryptographic keys or shared secrets) can be recorded in a secure, immutable ledger of the blockchain, creating decentralized and verifiable audit trail that can support virtually immediate tamper detection. When the session is created, a smart contract can be initiated, by the video communication service 110, on the blockchain. This smart contract can then record meeting details, such as a meeting identifier, public PKI keys of participant clients 121 involved and/or other public data useful for verification of the herein-discussed types of information used to calculated the first verification code VC1. Such a smart contract can be configured to function as an automated arbiter, ensuring that a set of predetermined security requirements is met before the session can be created. In practice, the session can be created or initiated by a participant user 122 or client 121, or the video communication service 110, submitting an initiation transaction to the blockchain, the initiation transaction being configured to deploy a smart contract of said type. This contract can include fields for storing the meeting, identifying the cryptographic keys contributed by each participant user 122 or client 121, and any other data. Each participant user 122 or client 121 can then submit to the blockchain their cryptographic credentials (such as public keys) to the smart contract. These credentials are securely stored within the contract, making each participant user 122 or client 121 a verified party in the session. Once all participant users 122 and/or clients 121 have successfully submitted their respective credentials, the smart contract can be configured to automatically check that all necessary conditions are met, such as verifying the presence of valid cryptographic keys from all participant users 122 or clients 121. Upon successful verification, the smart contract can then be configured to set the session status to “active,” allowing the session to proceed.

In a third example, the video communication service 110 (being an intermediate party 520 and/or a receiver 530) is integrated in, or is configured to integrate with, and existing third-party meeting service, such as Zoom® or Microsoft® Teams®, adding an additional layer of MFA security on top of such existing infrastructure. This way, the system 100 can provide enhanced security without having to rebuild basic meeting functionalities. The additional MFA layer can, for instance, be added as a plugin or extension to a standard video feed of the third-party meeting service.

In a fourth example, a combination of the above first, second and/or third examples is used. For example, a centralized session controller can be used in combination with blockchain technology to ensure secure management of authentication while also providing transparency and immutability. Additionally or alternatively, participants 122 can contribute to the generation of cryptographic elements in a decentralized fashion, such as using a different smart contract on the blockchain, adding further robustness. Generally, the video communication service 110 can be centralized function and/or decentralized (such as using a blockchain), at the same time as the session information can in itself be stored in a centralized and/or decentralized manner (again possibly using a blockchain).

Configured in the role as an intermediate party 520 and/or receiver 530, the video communication service 110 can hence be configured to authenticate one or several of the participant users 122 or clients 121 to the video communication; to initiate the communication session CS and to monitor the integrity of one or several source video streams being transferred within the communication session CS.

In case the video communication service 110 performs continuous integrity monitoring of the session, including of the transfer of the first source video stream SVS1, this can comprise reauthentication of the sender 510 (such as of the user 122 and/or of the client 121). Such reauthentication can be triggered after a certain predetermined time; upon the detection of an anomality in the first source video stream SVS1, a disruption or disturbance in the transfer of the first source video stream SVS1 and/or with respect to activity by one or several participants 122 in relation to, or in, the video communication.

Reauthentication can take place in a corresponding manner as any originally performed authentication, such as using a prompt to the sender 510 to reauthenticate and/or by discontinuing the streaming of the first source video stream SVS1 until reauthentication has been performed and verified. In a centralized approach, this can be performed by the centrally configured video communication service 110; whereas in a decentralized approach this can be performed by the participant users 122 or clients 121 interacting using smart contracts on the blockchain. For instance, reauthentication can take place by the sender 510 submitting updated authentication information to the blockchain and other participant user 122 clients 121 automatically verifying this information using a smart contract designed to produce a result once verified information has been provided to the smart contract (in a way corresponding to the original authentication of the sender 510).

Hence, in a decentralized setup participant clients 121 can be configured to verify each other's credentials from the outset and/or in case any type of predetermined disruptions, disturbances or anomalies are detected. Using a blockchain or any other type of distributed ledger, the (re) authentication process can be made transparent, allowing clients/participant users 121/122 to collectively confirm identity and maintain communication session CS integrity.

In practical examples, the first verification code VC1 can be generated by combining the one or several pieces of information SV, TS, MD, PSAC, SSAC, UAC, RC and/or SC discussed above to create a robust and verifiable identifier for each session. For instance, the source stream authentication code SSAC, metadata MD regarding communication session CS configuration and a timestamp TS can be concatenated to create an initial session data value:

$$Session\_Data = SSAC ‖ metadata ‖ timestamp$$

Thereafter, a session code SC in the form of a session hash can be calculated as a hash of the session data value:

$$Session\_Hash = SHA - 256 ( Session\_Data )$$

This way, the generated first verification code VC1 will be unique to each communication session CS, ensuring that no two communication sessions CS have the same verification code VC, providing strong resistance to replay attacks and other forms of tampering.

The session hash in this example adds an additional layer of temporal uniqueness, making unauthorized reproduction of the authentication sequence more difficult. It can be used in the subsequent steps to generate the first verification code VC1, ensuring that the latter is unique and unpredictable. Since the session hash can be calculated based on shared information, it can also be configured to be individually verifiable by both an intermediate party 520, the receiver 530 and any other interested party.

Then, the first verification code VC1 can be generated based on (such as a hash of a concatenation of) the session hash and any additional information, such as one or several of the above-discussed authentication tokens and/or an additional timestamp of any of the types discussed herein.

In some examples, a Deterministic Random Number Generator (DRNG) can also be used to produce a time stamp TS that then constitutes or is used to determine the first verification code VC1. Such a DRNG can be used to generate the first verification code VC1 as a sequence of random numbers.

Many programming languages comprise existing such DRNG algorithms that can be used. However, for increased security a cryptographic random generator (such as CryptoRandom) can be used. Another option for increased security is to use a hardware-based random number generator. Devices like Hardware Security Modules (HSM) can produce hardware-based seeds for a DRNG, which can then significantly enhance security by leveraging physical processes to generate randomness. A hash function or other one-way function can also be used to produce random-like values for initializing the DRNG. Concretely, a secure hashing algorithm (e.g., SHA-256) is applied iteratively, using previous outputs as inputs to generate a sequence of pseudo-random numbers. This ensures a deterministic yet secure sequence that is highly resistant to prediction or tampering. These approaches can of course be combined.

As described above, the first verification code VC1 can be determined in many different ways so as to depend on various types of information making the first verification code VC1 useful for verifying the authenticity of the first source video stream SVS1 in different ways and from different viewpoints.

In a subsequent step S805, the first verification code VC1 can be translated into two or more distinct and different graphical objects 200. The graphical objects 200 can be of many different types and the translation process can build on many different principles. However, the translation can in general be performed such that the graphical objects 200 are useful to unambiguously determine the first verification code VC1 based on visual identification of each of the graphical objects 200. In other words, in case a sufficient number of one, two or more of the graphical objects 200 are known, the first verification code VC1 can be determined in an unambiguous manner based on the graphical objects 200 in question using a predetermined algorithm or processing pattern.

The graphical objects 200 can comprise one, two, three or more graphical objects 200 corresponding to the first verification code VC1, such as one, two, three or more graphical objects 200 for a single frame of the first source video stream SVS1. Generally, a particular sequence of two or more of the graphical objects 200 can code for the first verification code VC1.

Further generally, the translation of the first verification code VC1 can be performed in such a way so that each of the resulting graphical objects 200 is configured with one or several respective distinct graphical features 201, as viewed in a pixmap of pixels. The one or several distinct graphical features 201 can be defined in a more coarse-grained manner, on pixel information level, than the first source video stream SVS1. This means that each of the distinct graphical features 201 that is important for unambiguously determine the first verification code VC1 based on an identity of the graphical object 200 in question is defined using a set of pixels that is at least partly redundant—even if some of the pixels are removed; the pixmap is compressed in terms of pixel resolution; and so forth, to some extent, it will be possible to unambiguously extract the graphical object 200 identity having the distinct graphical features 201 so as to be able to unambiguously infer the first verification code VC1 based thereon. Hence, even under such pixel information deterioration, the information concerning the distinct graphical features 201 and hence the identity of the graphical objects 200 will remain. The corresponding is in general not the case for the first source video stream SVS1, where a pixel deterioration will normally remove image-based information (such as details in the shown images) from the first source video stream VC1.

Examples can include a distinct a distinct graphical feature in the form of a straight edge 201′ between a dark region 204 and a bright region 205, the edge 201′ having a certain length and angle of extension, and being located in a particular location within the graphical object 200′ in question, where the edge 201′ is defined across a pixmap area of perhaps a total of 100 pixels. Even if that pixel area is compressed to be defined using a total of only 25 pixels, that edge 201′ will still be visible and its existence; its general location, extension and angle can be gleaned from the lower-resolution version of the pixmap. This is illustrated in FIG. 12, where the left-hand pixmap is the original pixmap and the right-hand pixmap is the pixmap after a compression in the form of a pixel resolution decrease (represented by the big horizontal arrow).

In general, the one or several distinct graphical features 201 can be selected to incorporate sufficient graphical coarseness so that each of the graphical objects 200 can be visually and uniquely identified also after a down-sampling, such as a predetermined down-sampling, of the first produced video stream PVS1 containing the first source video stream SVS1. Such down-sampling can be in terms of one or more of a reduced pixmap resolution; a reduced color depth; an increased compression; a changed encoding resulting in a smaller bitrate; and similar.

In some embodiments, one, two or more, such as each, of the distinct graphical features 201 are defined in terms of a defined color range, or a defined color, applied across a connected set 202 of at least 8×8 pixels. Such defined color or color range can be defined in absolute or relative terms, in other words as a well-defined color such as an RGB color code or relative to another color. For instance, the color or color range can be selected to have a high contrast in relation to a prevailing or average color of a frame of the first source video stream SVS1 in connection to which the distinct graphical feature 201 is provided in the first produced video stream PVS1. A “color range” can mean a range of colors, such as grayscales, from which range each pixel color within the connected set 202 is selected, but where all the pixels do not have the same uniform color.

In some embodiments, one, two or more, such as each, of the distinct graphical features 201 are additionally or alternatively defined in terms of a high-contrast basic shape element 203 having a smallest geometrical size measurement, such as in any direction or in all directions, of at least 8 pixels. By “high-contrast” is meant that the distinct graphical feature 201 in question uses a pixel color (or color range, corresponding to the above) having a high contrast in relation to surrounding pixels in the first produced video stream PVS1.

FIG. 13 shows an example of these to cases. The definition of one, two or more, such as each, of the distinct graphical features 201 can be exclusively using such coarse-grained features 202, 203, at least with respect to information-carrying parts of the distinct graphical feature 201 in question. This provides resilience to information loss under image quality deteriorations such as pixmap resolution decreases and compression increases. In general terms, one, two or more, such as each, of the graphical objects 200 can be informationally defined using one or several such distinct graphical features 201 being coarse-grained.

In order to provide resilience to information loss under image quality deteriorations such as color depth decreases, such as via compression or palette transformations, respective colors or color ranges used in different ones of the graphical objects 200 can be uniquely describable using a color depth of 8 bits or less. More generally, one, two or more, such as each, of the graphical objects 200 and/or one, two or more, such as each, of the distinct graphical features 201 can be defined using a color depth of 8 bits or less. In case the first produced video stream PVS1 is defined using a larger color depth, such as 16 or 24 bits, colors of individual graphical objects 200 and/or distinct graphical features 201 can be selected as colors being sufficiently far apart in a selected color space resulting in that a reduction of color depth will result in that the colors will remain different even under such reduction of color depth. For instance, the used colors can be selected to be black and white or other complementary or otherwise contrasting colors.

Hence, instead of using full-color graphical objects 200, grayscale or a 256-color web-safe palette can be used. This reduces bandwidth requirements while still maintaining a recognizable visual signature. The grayscale approach can be particularly useful in environments where color differentiation may not be ideal or where a simpler color scheme is required.

Another option is to display numbers, characters or other symbols, instead of colors. Each graphical object 200 can be assigned a number or other symbol derived from the first verification code VC1. This approach may be useful in situations where visual clarity or accessibility concerns make colors less practical.

Yet another alternative is that one or several graphical objects 200 comprise a respective static or dynamic barcode or QR code. Such code can then change in sync with the first produced video stream PVS1, embedding the first verification code VC1 within the code. This allows external devices, such as smartphones, to quickly scan and verify the authenticity of the first produced video stream PVS1. It is realized that such barcode or QR code can then be defined in a coarse-grained manner as described above, and can hence be sufficiently large as measured in pixels to survive an image quality degradation during transfer as described herein.

Instead of using colors or symbols, the graphical objects 200 can be or comprise a unique pattern generated based on the first verification code VC1. Patterns such as stripes, dots, or waves can be used, where the specific arrangement is determined by the first verification code VC1. This way, the graphical objects 200 visible in the first produced video stream PVS1 can be configured to appear less obtrusive. Again, such patterns can be sufficiently coarse-grained.

As will be discussed below, one, two or more, such as all, of the graphical objects 200 can be arranged outside of the first source video stream SVS1 in a pixmap of the first produced video stream PVS1 containing one or more frames of the first source video stream SVS1. However, in some embodiments other methods can be used to visually authenticate the first produced video stream PVS1 in ways that are less noticeable or more seamlessly integrated with the first source video stream SVS1.

In a first example of this, an invisible overlay is provided within the first source video stream SVS1 itself. This overlay could be constructed to not be noticeable to the human eye under normal viewing conditions of the first source video stream SVS1, but so that it becomes visible when the first produced video stream PVS1 (or the first source video stream SVS1) is processed in a predetermined way, such as by converting it to a negative image or increasing brightness or contrast thereof. It is noted that such methods of introducing watermark data into video streams, and viewing such watermark data, is conventional as such. The watermark overlay can contain the first verification code VC1 in plain text or as a static or dynamically changing barcode or QR code. Again, the overlay can be sufficiently coarse-grained as described above, in terms of pixel distribution and color usage, to survive an image quality degradation.

In a second example, a clearly visible but small (in relation to a pixmap of the first source video stream SVS1) QR code can be introduced as an overlay on top of the first source video stream SVS1 in the first produced video stream PVS1, for example in a corner of the pixmap of the first source video stream SVS1. Again, the QR code can be sufficiently coarse-grained.

It is noted that the graphical objects 200 described herein are a special case of the first and further pieces of information POI1, POI2, POI3 described below, and that everything said here regarding the graphical objects 200 are equally applicable to said pieces of information POI1, POI2, POI3.

In a subsequent step S806, the first produced video stream PVS1 is produced. This production can be generally be performed in the various ways discussed above and herein, and can be based on the first source video stream SVS1 in the sense that the first produced video stream PVS1 is produced to comprise one or several frames 210 of the first source video stream SVS1. As one of several different possible examples, a frame rate of the first produced video stream PVS1 can be the same or an even multiple of the first source video stream SVS1 and the first produced video stream PVS1 can then be produced to incorporate, in each frame, a corresponding frame of the first source video stream SVS1. In general, the first produced video stream PVS1 can be produced to contain the first source video stream SVS1 in a way so that the first source video stream SVS1 can be viewed, or can be substantially viewed, as a part of the first produced video stream PVS1. As the term is used here, “substantially” can mean that the cognitive or informational contents of the first source video stream SVS1 are discernible from the first produced video stream PVS1. In some embodiments, each frame of the first source video stream SVS1 is transferred, in a cropped form or in its entirety, as a part of the first produced video stream PVS1.

The first produce video stream PVS1 can also be produced to comprise the graphical objects 200.

This can be achieved in various ways. In some embodiments, the graphical objects 200 do not overlap with pixmap frames 210 of the first source video stream SVS1, so that none, or substantially none, of the graphical objects 200 overlap the first source video stream SVS1 to obscure part or the whole of the corresponding frame of the first source video stream SVS1.

The first source video stream SVS1, or at least several frames of the first source video stream SVS1, can be included in the first produced video stream PVS1 in its entirety and without any cropping of the frames 210 of the first source video stream SVS1. In case the first source video stream SVS1 has a different frame rate than the first produced video stream PVS1 this can include skipping individual frames of the first source video stream SVS1 or introducing certain frames several times in the first produced video stream PVS1. It can also be the case that only certain parts, along a timeline or in terms of pixmap areas, of the first source video stream SVS1, is to be transferred and are therefore incorporated into the first produced video stream PVS1.

In general, at least one, two, or more, such as each, of the frames 230 of the first produced video stream PVS1 contains a larger number of pixels than a corresponding frame 210 of the first source video stream SVS1 being incorporated into the first produced video stream PVS1. This is typically at least partly due to the fact that the graphical objects 200 are added to the pixmap of respective frames 230 outside of a corresponding pixmap of the respective corresponding frames 210. In the example illustrated in FIG. 11, the graphical objects 200 are arranged as a border of squares of different color nuances (such as grayscales). It is, however, realized that the graphical objects can be arranged in the frames 230 outside of the frames 210 in any manner, such as in a single row, or multiple rows, above and/or below the frame 210; a single row, or multiple rows, to the left and/or to the right of the frame 210; a single or several distinct graphical features arranged at a distance from the frame 210, where the location of such graphical features can be fixed or moving across different frames 230; and so on.

In general, the first produced video stream PVS1 is produced so that it contains the incorporated pieces of the first source video stream SVS1 in an unaltered manner, hence without any modifications in terms of pixel information, pixmap resolution, compression, color depth, frame rate, and so on.

In a simple example, the first produced video stream PVS1 hence shows, in each frame 230, a corresponding frame 210 of the first source video stream SVS1 together with the graphical object(s) 200 for that frame 230/210.

In some embodiments, two or more of the graphical objects 200 are incorporated into one single frame 230 of the first produced video stream PVS1. Such two or more of the graphical objects 200 can then be configured to together code for the first verification code VC1, or part of the first verification code VC1. In FIG. 11, twenty distinct graphical objects 200, each in the form of a different squares having various encoding grayscales (in FIG. 11 illustrated using different fill patterns) are arranged as a frame around a periphery of the frame 230 in question. Alternatively or in addition, two or more of the graphical objects 200, together coding for the first verification code VC1, or part of the first verification code VC1, can be incorporated into different frames 230 of the first produced video stream PVS1.

In other words, a set of the graphical objects 200, configured to in combination code for the first verification code VC1, can be arranged in one single or multiple different of the frames 230 in the first produced video stream PVS1, as long as the receiver 530 knows how to determine which ones of the graphical objects that code for the first verification code VC1 and in what way to interpret this coding to end up with the first verification code VC1.

As mentioned, the graphical objects 200 encode for the first verification code VC1. However, in some embodiments, a sequence of verification codes SVC are calculated, such as based on the same information SV, TS, MD, PSAC, SSAC, UAC, RC and/or SC as discussed above to produce the first verification code VC1 or, more simply, based on the first verification code VC1. In some embodiments, the sequence of verification codes SVC is calculated as a chain of verification codes VC where each verification code VC in the chain (sequence) of verification codes SVC is calculated based on one or several previous verification codes VC in the chain of verification codes SVC. For instance, these calculations can be performed using one or several one-way functions, such as a hash function.

The sequence of verification codes SVC can be an ordered sequence wherein each verification code VC is calculated based on at least one of a previous verification code VC in the ordered sequence of verification codes SVC and the first verification code VC1. The first verification code VC1 can for instance be a first verification code VC in the ordered sequence of verification codes SVC, or the first verification code VC in the ordered sequence of verification codes SVC can be calculated based on the first verification code VC1.

At least one, two or more, such as each, of one or several verification codes VC in the sequence of verification codes SVC can in addition or alternatively be calculated based on publicly published information PPI in a way corresponding to what is described below.

In some embodiments, a value can be calculated based on a particular one, or several, or all, of the verification codes VC in the sequence of verification codes SVC. This value can subsequently be publicly published PP.

Each verification code VC in the sequence of verification codes SVC can individually be calculated as a pseudo-random number, such as based on a previous verification code VC.

Hence, a sequence of graphical objects 200 can be calculated and be incorporated into one or several frames 230 of the first produced video stream PVS1 based on such a sequence of verification codes SVC being continuously or intermittently calculated over time as the transfer of the first produced video stream PVS1 is ongoing. By interpreting these graphical objects 200, the receiver 530 can determine a latest or current verification code VC in the sequence of verification codes SVS and use this latest or current verification code VC to verify the most recently received frame of the first produced video stream PVS1 according to a verification protocol known to the receiver 530. For instance, in case the sequence of verification codes SVS is calculated as a chain of verification codes VC, the receiver can use knowledge about the functions used to calculate this chain to calculate an expected value of each verification code VC in the chain and then verify that the expected values are the same as the ones coded for by the graphical objects 200.

In a subsequent step S807, the first produced video stream PVS1 is transferred from the sender 510 to the receiver 530. It is realized that, since the first source video stream SVS1 is incorporated into the first produced video stream PVS1, the transfer of the first produced video streams PVS1 implies the simultaneous transfer of the first source video stream SVS1 from the sender 510 to the receiver 530.

The transfer can take place in any way, such as over the public internet or internally within the system 100, with or without using a suitable encryption. Generally, the transfer is performed digitally and electronically.

In some embodiments, the transfer itself comprises a down-sampling of the first produced video stream PVS1. This can be the result of processing of the first produced video stream PVS1 by intermediate nodes between the sender 510 and the receiver 530, as a result of limited bandwidth or for any other reason. “Down-sampling” can mean a reduction of pixmap resolution, a reduction of color depth, an increase in compression rate, a change of compression type or encoding type, a reduction of frame rate, and similar. In general, the down-sampling can be applied and/or be the same with respect to part of or the entire first produced video stream PVS1. Further generally, the down-sampling can result in a lower bitrate for the transfer and/or a quality deterioration of image and/or audio data in the first produced video stream PVS1.

In some cases, the sender 510, 511 and/or the intermediate party 520 and/or the receiver 530 is not aware of the precise type of down-sampling that occurs during transfer. Instead, the graphical objects 200 can be designed to survive deterioration due to such down-sampling of predetermined maximum magnitudes.

It is noted that the receiver 530 will be able to interpret the information carried by the graphical objects 200 even after such down-sampling, due to the deterioration-resistant design of these graphical objects 200.

In a subsequent step S808, the receiver 530 can receive the first produced video stream PVS1. At this point, the first produced video stream PVS1 typically contains, as a part of a respective pixmap of one or several frames 230 of the first produced video stream PVS1, a respective contained video frame 210 of the first source video stream SVS1.

Then, in a subsequent step S809, one, two or more, such as each, of the graphical objects 200 can be identified in the first produced video stream PVS1. The identification can be performed by the receiver 530. As described above, the graphical objects 200 are useful to unambiguously determine a received verification code VCR. The identification can take place using any suitable algorithm, such as per se conventional image processing algorithms, such as edge detection or optical character recognition algorithms. In some cases, the receiver 530 can have a priori knowledge of a visual format used to introduce the graphical objects 520, so that the receiver 530 simply reads a predetermined part of the pixmap 230 in question to determine its color, brightness or similar. In some embodiments, detection algorithms used are configured to measure the graphical objects 200 using relative image information as opposed to absolute pixel image information.

Hence, in a subsequent step S810, the received verification code VCR can be determined based on the identified graphical objects 200. This can be performed by the receiver 530 or by a service (such as a system-internal or external central server of the above type) that the receiver 530 delegates this task to.

In a subsequent step S811, the receiver (or a delegated party) can verify that the received verification code VCR is as expected. This verification can be performed using any relevant information available to the receiver, such as SV, TS, MD, PSAC, SSAC, UAC, RC and/or SC. In particular, the verification can be based on the secret value SV.

As discussed above, the verification in step S811 can be ongoing during the receiving of the first produced video stream PVS1 and using the received verification code VCR as the first verification code VC1 or continuously calculated verification codes VC of the sequence of verification codes SVC.

The transfer of video streams as discussed herein can in general be a “streaming” in the sense that individual frames, or clusters of frames, are transferred in real-time or near real-time. The verification in step S811 can then be ongoing, always verifying a latest received frame or cluster of frames of the first produce video stream PVS1.

In a step S812, a contained video stream CVS in the first produced video stream PVS1 (i.e., a stream represented by the frames 210 of the possibly down-sampled first source video stream SVS1) can be determined by the receiver 530 (or a delegated party). This determination is then based on the one or several contained video frames 210.

It is noted that, due to the various mechanisms described above, the frames 210 of the first source video stream SVS1 contained in the first produced video stream PVS1 received by the receiver 530 can be identical as, or altered in relation to, the first source video stream SVS1, or even to the frames 210 contained in the first produced video stream PVS1 as it was when it left the sender 510. However, the cogitative and informational contents can be the same. Therefore, from a cognitive and informational point of view, the contained video stream CVS can in some embodiments correspond to, or even be identical to, the first source video stream SVS1.

In case the verification of the received verification code VCR in step S811 failed, a visual information element IE can be inserted into the contained video stream CVS, the information element IE indicating to a participant user 122 viewing the contained video stream CVS that the integrity of the contained video stream cannot be verified. For instance, the information element IE can in this case be a red circle or other clear symbol of failure. To the contrary, in case the verification in step S811 succeeded, an information element IE can be inserted into the contained video stream CVS, the information element IE indicating success. In this case, the information element can be a green circle or similar.

In a subsequent step S814, the contained video stream CVS can be displayed on a screen display 531, such as a screen display of the receiver 530, and/or otherwise used. In general, display by the receiver 520 is not necessary. Instead, the receiver 530 can use the contained video stream CVS, for instance by streaming it to a different recipient entity, or use it as an input to a production step wherein the contained video stream CVS is used, for instance within the context of a video communication service.

The “production” in this case can be as generally described above and herein. For instance, the receiver 530 may be, or be comprised in, a central server 130 or video communication service 110 of the general types discussed herein, receiving primary (source) video streams in the way generally illustrated in FIGS. 8 and 11 as part of a respective produced video stream, and producing an output video stream based on these primary video streams (the respective constructed contained video streams CVS). That produced video stream may then be delivered, such as in real-time, to one or several recipient clients 121 or external party 150 as generally described above. This way, the producing party can verify that the respective integrity of each of the incoming primary video streams is independently verifiable, and this information can for instance be indicated in the produced output video stream in a suitable manner, such as using the information element IE or in the form of metadata.

Hence, a produced output video stream can be automatically produced based on said transferred primary video streams and any additional data, such as external data or metadata (for instance the metadata MD). The automatic producing can be based on automatic production decisions of the type explained and exemplified above, for instance based on the automatic detection of events and/or patterns and/or based on predetermined and/or dynamic production parameters. Concretely, the automatic production can be performed based at least on one of a defined production parameter; an automatic image processing of the first and/or second primary/source video streams; and an automatic audio processing of the first and/or second primary/source video streams.

Then, the produced output video stream is provided to a recipient user 530, that in turn may be the first user, the second user, a different user being party to the same video communication service 110 and/or an external user 150.

Any or all of the source video streams, the corresponding contained video streams CVS, any information SV, TS, MD, PSAC, SSAC, UAC, RC and/or SC used to determine the corresponding verification code VF, and/or and any produced output video stream can be stored for future reference, in that case preferably in a persistent and permanent manner, such as on a hard drive, a flash drive, a non-volatile memory storage, or the like. The storing can be in a way that allows full retroactive replication of each of the video streams, in other words not using any lossy compression algorithm or similar. Any or all of this information can also be “weaved” in the sense described herein (see below).

In some embodiments, the graphical objects 200 do not form part of the contained video stream CVS and/or are not displayed on the screen display 531.

In some embodiments, the determining of the contained video stream CVS is performed using a cropping operation of the first produced video stream PVS1. More specifically, any pixmap area of each individual frame 230 (or of all several or frames at once, depending on cropping technique) that is outside of the corresponding frame 210 can be cropped away. At least, any area of the frame 230 that contains one or more of the graphical objects 200 can be cropped away from the frame 230.

In a subsequent step S815, the method ends.

It is understood that the producing in step S806 can take place continuously, one frame or set of frames at a time, in real-time. This way, the method illustrated in FIG. 8 can be iterative and ongoing over time. The corresponding is true regarding FIGS. 14 and 16 and their corresponding production steps S1406, S1416, S1421, S1606 and S1617.

Like FIG. 8, FIG. 14 also illustrates a method for transferring a video stream from the sender 510 to the receiver 530. The sender 510 and the receiver 530 can be as discussed above.

FIG. 15 corresponds to FIG. 11, but illustrates the method of FIG. 14. Since many of the method steps in the method illustrated in FIG. 14 can be similar to the corresponding method steps of the method illustrated in FIG. 8, some of the details in FIG. 11 are not shown in FIG. 15, making FIG. 15 clearer. It is, however, realized that all the relevant detail shown in FIG. 11 is correspondingly applicable to FIG. 15.

In a first step S1400, the method starts.

In a subsequent step S1401, the sender 510 can receive, collect, capture or construct a first source video stream SVS1, in a way that can correspond to what has been described above in connection with step S801.

In a step S1402, the sender 510 can receive a first secret value SV1 from the receiver 530. This step can be similar to step S802 described above, and the first secret value SV1 can also be as described above.

In a step S1403, the first participant user 122 can be authenticated, in a way that can correspond to what has been discussed above in connection to step S803.

In a subsequent step S1404, that can correspond to step S804 described above, the sender 510 can determine a first verification code VC1, the first verification code VC1 being or being determined based on the first secret value SV1 and otherwise in general being according to what has been discussed above. Hence, the first verification code VC1 can be determined based on one or more of SV1, TS, MD, PSAC, SSAC, UAC, RC and SC. SC is here a session code for a communication session CS1 within which the communication between the sender 510 and the intermediate party 520 takes place, corresponding to the communication session CS discussed above.

In a subsequent step S1405, that can be similar to step S805 above, the first verification code VC1 can be translated into one or several graphical objects, using the methodology described above.

In a subsequent step S1406, the sender 510 can produce the first produced video stream PVS1 in the way generally discussed above, based on one or several frames 210 of the first source video stream SVS1. Hence, the cognitive and informational contents of the first source video stream SVS1 can be present as a part of the first produced video stream PVS1, such as in unmodified, modified or otherwise processed form as described above.

The first produced video stream PVS1 can contain a first piece of information POI1. The first piece of information POI1 codes for the first verification code VC1 in a way so that the first verification code VC1 can be unambiguously determined based on the first produced video stream PVS1. Hence, the first piece of information POI1 can be the graphical objects 200 described above. The first piece of information POI1 can alternatively be other types of information that are integratable, insertable or embeddable into the first produced video stream PVS1. For instance, the first piece of information POI1 can be in the form of a filter applied to the entire, or parts of the, first produced video stream PVS1 constituting a watermark not visible to the human eye but configured to be extracted from the first produced video stream PVS1 in an unambiguous and deterministic manner. Such filter can, again, be designed to be sufficiently coarse-grained in terms of pixel information and filter properties, to survive a down-sampling of the first produced video stream PVS1 in the general sense described above.

In general, the first piece of information POI1 can comprise pixel information the introduction of which into the first produced video stream PVS1 modifies the pixmap of the first produced video stream PVS1. In addition thereto, or alternatively, the first piece of information POI1 can comprise audio information the introduction of which into the first produced video stream PVS1 modifies audio data, such as an audio track, of the first produced video stream PVS1. Whereas such pixel information can be introduced to be unambiguously detectable and interpretable from the pixmap of the first produced video stream PVS1 using suitable digital image processing algorithms, such audio information can be introduced to be unambiguously detectable and interpretable from the audio data of the first produced video stream PVS1 using suitable digital audio processing algorithms, such as filter-based algorithms. Such audio processing algorithms are known per se. The corresponding can of course be said in relation also to the second and third pieces of information POI2, POI3 (below).

In case the first piece of information POI1 comprises audio information, this audio information can be added to the first produced video stream PVS1 in a coarse-grained manner, in a similar way as described above in relation to added pixel information, so that the audio-encoded information survives a transfer of the first produced video stream PVS1 when such transfer results in a deterioration of audio quality. For instance, the first piece of information POI1 can comprise a high-amplitude waveform having a predetermined and well-defined narrow frequency so that the intermediate party 520 can filter out the waveform.

More concretely, the first piece of information POI1, the second piece of information POI2 and/or the third piece of information POI3 can each individually comprise or constitute one or several of the graphical objects 200 described above. Such graphical objects 200 can be overlapping or non-overlapping with a corresponding pixmap of the produced video stream PVS1, PVS2, PVS3 in question.

In addition or alternatively, the first piece of information POI1, the second piece of information POI2 and/or the third piece of information POI3 can each individually comprise or constitute a visual coding pattern having a predetermined structure, such as a QR code or a barcode, the visual coding pattern being useful to unambiguously determine the first verification code VC1 or the first piece of intermediate information II1 based on visual identification of the visual coding pattern. Correspondingly for the second and third pieces of information POI2, POI3. The visual coding pattern can be overlapping or non-overlapping with a corresponding pixmap of the produced video stream PVS1, PVS2, PVS3 in question. The coding pattern can, again, be sufficiently coarse-grained.

In addition or alternatively, the first piece of information POI1, the second piece of information POI2 and/or the third piece of information POI3 can each individually comprise or constitute one or several alphanumeric characters, the one or several alphanumeric characters being useful to unambiguously determine the first verification code VC1 or the first piece of intermediate information II1 based on visual identification of each of the one or several alphanumeric characters. Correspondingly for the second and third pieces of information POI2, POI3. The alphanumerical characters can be overlapping or non-overlapping with a corresponding pixmap of the produced video stream PVS1, PVS2, PVS3 in question. The characters can, again, be sufficiently coarse-grained.

In addition or alternatively, the first piece of information POI1, the second piece of information POI2 and/or the third piece of information POI3 can each individually comprise or constitute a watermark structure, being configured to be indiscernible to the human eye in the produced video stream, but to be discernible after an image transformation, such as an inversion or a change of brightness or contrast, performed on the produced video stream in question. The watermark structure can, again, be sufficiently coarse-grained.

In addition or alternatively, the first piece of information POI1, the second piece of information POI2 and/or the third piece of information POI3 can each individually comprise or constitute information being provided in metadata in, or associated with, the produced video stream PVS1, PVS2, PVS3 in question. Such metadata is then configured not to get lost during the transfer even in case of encoding changes or similar of the first produced video stream PVS1.

In a subsequent step S1407, the first produced video stream PVS1 is transferred. Step S1407 can correspond to step S807, but in the method illustrated in FIG. 14 the transfer is to an intermediate party 520.

The intermediate party 520 can be any part acting as an intermediary for communication between the sender 510 and the receiver 530. For instance, the intermediate party 520 can be a relay node in a communication system, or a party otherwise configured to relay the first source video stream SVS1 from the sender 510 to the receiver 530. In particular, the intermediate party 520 can be the central server 130 or video communication service 110 described herein, providing a video communication service in which the sender 510 and the receiver 530 both take part. Hence, instead of sending the first source video stream SVS1 directly to the receiver 530, the sender 510 can send the first source video stream SVS1 to the receiver 530 via the intermediate party 520. In all such cases, the receiver 530 may want to verify the integrity of the received video stream. Using the method illustrated in FIG. 14, this verification can take place by the receiver 530 in much the same manner as the verification described in relation to FIG. 8, but after intermediate data processing performed by the intermediate party 520, possibly including down-sampling of the transferred video stream, as will be described in the following.

Hence, in a subsequent step S1408, that can correspond to step S808 but where the intermediate party 520 plays the same role in FIG. 14 as the receiver 530 does in FIG. 8, the intermediate party 520 can receive the first produced video stream PVS1.

In a subsequent step S1409, that again can correspond to step S809 but with the intermediate party 520 playing the role of the receiver 530 in FIG. 8, the intermediate party 520 can determine, based on the first produced video stream PVS1, the first piece of information POI1 provided as a part of the first produced video stream PVS1. Again, the first piece of information POI1 can be the graphical objects 200, and the determination can be performed from the first produced video stream PVS1 in the corresponding manner as described above regarding the automatic determination of the graphical objects 200 from the first produced video stream PVS1 in step S809.

In a subsequent step S1410, a first piece of intermediate information II1 correlating to the first verification code VC1 can be determined, based on the first piece of information POI1 identified in step S1409 and in a manner that can correspond to step S810.

The first piece of intermediate information II1 can be the first verification code VC1, but it can also be a subset of the first verification code VC1 sufficient to perform the verification by the receiver 530 described below. For instance, the first verification code VC1 can contain redundant or unnecessary information not needed to perform the verification.

In a subsequent step S1421, instead of verifying the first piece of intermediate information II1 (as would be the case if step S811 would be performed as in a method of the type illustrated in FIG. 8), the intermediate party 250 can instead produce a third produced video stream PVS3 based on the frames 230 of the first produced video stream PVS1 as well as on a third piece of information POI3.

As a matter of fact, the first secret value SV1 and the first verification code VC1 can be unknown to the intermediate party 520, and the intermediate party 520 can refrain from verifying the correctness of the first piece of intermediate information II1.

The third piece of information POI3 is configured to code for the first piece of intermediate information II1 in a way so that the first piece of intermediate information II1, and therefore the first verification code VC1 or any latest verification code VC in the sequence of verification codes SVC, can be unambiguously determined based on the third produced video stream PVS3. The third piece of information POI3 can be incorporated, inserted or embedded into the third produced video stream PVS3 in a way that can correspond to the incorporation, insertion or embedding of the first piece of information POI1 into the first produced video stream PVS1 described above (and/or the insertion of the graphical objects 200 into the first produced video stream PVS1). The third piece of information POI3 can hence, for instance, be in the form of graphical objects 200 of the above-described type (that can then be the same or different graphical objects 200 as graphical objects 200 present in the first produced video stream PVS1); a filter of the above-described type; or similar. The third piece of information POI3 can be the same or different from the first piece of information POI1. One way in which the intermediate party 520 can produce and insert the third piece of information POI3 into the third produced video stream PVS3 is to simply copy and paste the first piece of information POI1 from the first produced video stream PVS1.

In general, the third produced video stream PVS3 can be produced in a way corresponding to what has been described in relation to the production of the first produced video stream PVS1.

In particular, the intermediate party 520 can produce the third produced video stream PVS3 based on the first produced video stream PVS1 so that one, two or more, such as all, of the frames 210 of the first source video stream SVS1 is or are partly or wholly contained in the first produced video stream PVS1 in a way visible in the third produced video stream PVS3. In general, for at least one, some or all of individual frames 210 of the first source video stream SVS1, at least part of the frame 210, or the entire frame 210, is visible in the third produced video stream PVS3. It is realized that the transfer to the intermediate party 520 of the first produced video stream PVS1 can entail a change of quality (down-sampling) of the first produced video stream PVS1, as has been described above, and can as a result also correspondingly affect a quality of any contained frames 210 of the first source video stream SVS1. In other words, the frames or part of frames of the first source video stream SVS1 introduced into the third produced video stream PVS3 are then these quality-changed parts of the first source video stream SVS1. However, since the first piece of information POI1 was designed by the sender 510 so that the information carried by the first piece of information POI1 survives any occurring quality deteriorations due to the transfer, the first piece of intermediate information II1 can still be successfully determined and used to produce the third piece of information POI3.

In some embodiments, enough frame material from the first source video stream SVS1 is inserted into the third produced video stream PVS3 so that any informational and cognitive contents of the first source video stream SVS1 are still present in the third produced video stream PVS3. In a way corresponding to the presence of such informational and cognitive contents in the first produced video stream PVS1, this can be in spite of certain frames of the first source video stream SVS1 being removed due to a decrease in frame rate during transfer; a reduction in pixmap resolution or color depth; and so forth.

As discussed, the intermediate party 520 can be a provider of a video communication service, or an active part of, or in, such video communication service. In such cases, as well as in other cases, the intermediate party 520 can be configured to produce the third produced video stream PVS3 based on the first source video stream SVS1 (fetched from the first produced video stream PVS1) as one primary video stream, as well as additional content AC, the additional information potentially being one or more additional primary/source video streams and/or any other type of information. This production can then be as generally described above. The additional content AC can be used so that is partly or wholly visible in the third produced video stream PVS3.

In case the additional content AC is or comprises an additional primary/source video stream, this primary/source video stream can be provided to the intermediate party 520 as a part of a second produced video stream PVS2 that in itself can be similar to the first produced video stream PVS1 in the sense that it carries frames of a second source video stream SVS2 as well as a second piece of information PIO2 coding for a second verification code VC2 in a way so that the second verification code VC2 can be unambiguously determined based on the second produced video stream PVS2, by reading the second piece of information PIO2. The second verification code VC2 and the second piece of information PIO2 can correspond to the first verification code VC1 and the first piece of information POI1, respectively, and the second piece of information POI1 can be introduced into the second produced video stream PVS2 by a different sender 511 than the sender 510. It is understood that the second verification code VC2 can be used to produce and process a respective sequence of verification codes VCS in a way corresponding to what has been described above. Then, the intermediate party 520 can use such sequence VCS to verify the integrity of the second produced video stream PVS2.

This is illustrated in FIG. 15, where it also can be seen that a second secret value SV2 can be provided to the different sender 511, such as from the receiver 530. FIG. 15 also shows a second communication session CS2 within which a communication between the different sender 511 and the intermediate party 520 takes place. The second communication session CS2 can be similar to the first communication session CS1.

FIG. 15 also shows the exemplary case in which the first participant user 122′ controls the sender 511 and the second participant user 122″ controls the different sender 511. It is realized that the first and different senders 510, 511 can each individually be a client 121 of the general type described above; a central server; and so on, as has been discussed above in relation to the nature of the sender 510.

As seen in FIG. 14, steps S1411, S1412, S1413, S1414, S1415, S1416, S1417, S1418, S1419 and S1420 individually correspond to the corresponding individual steps S1401-S1410 but for the different sender 511, the second source video streams SVS2, the second verification code SV2 and the second produced video stream PVS2.

Hence, in case the third produced video stream PVS3 is produced based on not only the first produced video stream PVS1 but also on the second produced video stream PVS2, steps S1411-S1420 can be performed in parallel to steps S1401-1410, such as in an ongoing manner to produce respective produced streamed video streams PVS1, PVS2. The incoming first and second produced video streams PVS1, PVS2 can be (continuously) collected by the intermediate party 520, such as using a collecting function 131 of the intermediate party 520 of the type described above. Then, the production of the third produced video stream PVS3 can take place as generally described above, including aspects like time-synchronizing the first and second produced video streams PVS1, PVS2, the detection of events and/or patterns, taking various automatic production decisions, and so forth. The production of the third produced video stream PVS3 can also take place continuously, in real-time or near real-time.

A second piece of intermediate information II2 can be determined, in step S1420, based on the second piece of information POI2. The third piece of information POI3 can then be determined based on both the first piece of intermediate information II1 and on the second piece of intermediate information II2 so that both these latter pieces of information can be determined in an unambiguous manner based on the third piece of information POI3. In practical cases, the first and second pieces of intermediate information II1, II2 can be added graphically side by side in the third produced video stream PVS3, or a visual encoding can be used to produce the third piece of information POI3 in a way so that it is unambiguously discernible for the receiver 530 what each of the first and second pieces of intermediate information II1, II2 are given the third piece of information POI3.

In a subsequent step S1422, the third produced video stream PVS3, that may then comprise frames from the first source video stream SVS1 and possibly also frames from the second source video stream SVS2, can be transferred to the receiver 530.

In a subsequent step S1423, that can correspond to step S808, the receiver 530 can receive the third produced video stream PVS3. At this point, the third produced video stream PVS3 will contain as a part of a respective pixmap of one or several frames 230 of the third produced video stream PVS3 a respective contained video frame 210 of the first source video stream SVS1 and possibly also, for the same or different of the frames 230, a respective contained video frame 210 of the second source video stream.

In a subsequent step S1424, that can correspond to step S809, the receiver 530 can identify the third piece of information POI3 from the third produced video stream PVS3. This can be performed as generally described above, such as in the particular example when the third piece of information POI3 is one or more graphical objects 200.

In a subsequent step S1425, that can correspond to step S810, the received first piece of intermediate information II1 can be determined, by the receiver 530, based on the third produced video stream PVS3, normally based on the identified third piece of information POI3. In case the third piece of information POI3 is determined based also on the second piece of intermediate information II2, the second piece of intermediate information II2 can also be determined based on the third piece of information POI3.

It is specifically noted that the third produced video stream PVS3 can contain two or more distinct pieces of information, each coding for one or several distinct pieces of intermediate information accruing from different respective source video streams. In such cases, the different distinct pieces of information can be processed separately by the receiver 530, such as in parallel, in sequence or immediately upon receiving of a frame of the third produced video stream PVS3 containing such a piece of information.

In FIG. 15, reference “VC” corresponds to “VC” in FIG. 11 and denotes the one or more pieces of intermediate information received as a part of the third piece of information POI3.

In a subsequent step S1426, that can correspond to step S811, the receiver 530 can verify the first piece of intermediate information II1 using the first secret value SV1 previously made known to the sender 510. It is understood that a separate verification can be made of any piece of intermediate information, such as the second piece of intermediate information accruing from the different sender 511, received by the receiver 530.

It is realized that, at this point, the first piece of intermediate information II1 is or can be transformed into the first verification code VC1, or any verification code VC carried by the first produced video stream PVS1 to the intermediate party 520. Therefore, it is possible to verify that the first piece of intermediate information II1 is as expected based on knowledge about any relevant information including one or more of SV, TS, MD, PSAC, SSAC, UAC, RC and/or SC used to produce such verification code VC. In particular, the verification can be based on the first secret value SV1.

Correspondingly, any second piece of intermediate information II2 and any additional piece of intermediate information extracted from the third produced video stream PVS3 can be verified in the corresponding manner, using relevant information used by a respective sender 511 to determine a corresponding verification code.

In a step S1427, that can correspond to step S812, a contained video stream CVS in the third produced video stream PVS3 can be determined by the receiver 530. In the example shown in FIG. 15, the contained video stream CVS can contain partial or entire frames from both the first source video stream SVS1 and the second source video stream SVS2 since the intermediate party 520 produced the third produced video stream PVS3 based on both these primary video streams. In other cases, the contained video stream CVS can be based only on the first source video stream SVS1. The determination of the contained video stream CVS is based on the one or several contained video frames 210.

As has been described above in connection to step S812, the frames 210 of the first source video stream SVS1 (and possibly also the frames 210 of the second source video stream SVS2) contained in the third produced video stream PVS3 received by the receiver 530 can be identical as, or altered in relation to, the corresponding source video stream, or even to the frames 210 contained in the first/second produced video stream PVS1, PVS2 as it was when it left the respective sender 510, 511. However, the cogitative and informational contents can be the same even after a transfer causing quality deterioration. Therefore, from a cognitive and informational point of view, the contained video stream CVS will correspond to, or even be identical to, the first source video stream SVS1 (and possibly also the second source video stream SVS2).

It is realized that the contained video stream CVS can essentially be the third produced video stream PVS3 produced by the intermediate party 520 based on the first and second source video streams SVS1, SVS2, possibly apart from the third piece of information POI3 that in itself can be purged from the third produced video stream PVS3 and not be a part of the contained video stream CVS.

In a subsequent step S1428, that can correspond to step S813, performed in case the verification of either of the received pieces of intermediate information in step S1426 failed, a visual information element IE can be inserted into the contained video stream CVS, the information element IE indicating to a participant user 122 viewing the contained video stream CVS that the integrity of the contained video stream cannot be verified. To the contrary, in case the verification in step S1426 succeeded, an information element IE can be inserted into the contained video stream CVS, the information element IE indicating success.

In a subsequent step S1429, that can correspond to step S814, the contained video stream CVS can be displayed on a screen display 531, such as a screen display of the receiver 530, and/or otherwise used. Alternatively or additionally, the receiver 530 can use the contained video stream CVS, for instance by streaming it to a different recipient entity, or use it as an input to a production step wherein the contained video stream is used, for instance within the context of a video communication service. As was discussed above in connection with step S814, the “production” can in this case be as generally described above and herein.

Everything that has been disclosed in relation to the method illustrated in FIGS. 8 and 11 are correspondingly applicable to the method illustrated in FIGS. 14 and 15.

Using the method illustrated in FIGS. 14 and 15, a receiver 530 of a video stream that was produced by an intermediate party 520 based on one or several source video streams SVS1, SVS2 can verify the integrity of the source video stream(s) SVS1, SVS2 contained in the received video stream, the integrity being verifiable all the way from the respective sender 510, 511 of the source video stream SVS1, SVS2 in question and without the receiver 530 having to trust the intermediate party 520. As has been discussed above, the streaming of the video streams can take place in real-time or near real-time and does not have to follow any particular video encoding format or similar.

In a subsequent step S1430, the method ends.

Now with reference to FIGS. 17 and 18, the term “one-way function” is per se well-known in the art, meaning a function the input value of which is, in practice, impossible to determine based only upon the corresponding function output value, and which is substantially one-to-one in the sense that in the practical applications described herein, two different input values will in practice always result in two different output values. Examples include many hash functions which are conventional as such, such as SHA hash functions, such as SHA-1, SHA-2 and SHA-3, as well as MD5.

In various embodiments, such one-way functions are collision-free. Furthermore, they can be cryptographic hash functions in the sense described at https://en.wikipedia.org/wiki/Cryptographic_hash_function.

Each one-way function described herein can be the same or different one-way functions (that is, the same or different one-way functions can be used in different contexts and situations).

As the term is used herein, that an output of a one-way function is calculated using a certain piece of information, such as a video stream, “as direct or derivative input”, means that the result (output) of the one-way function is caused to unambiguously depend on the certain piece of information in a direct or indirect manner. Sometimes the phrase “calculating a function” is used, and sometimes “calculating an output of a function”, but it is understood that these mean the same thing.

For instance, some or all pixel values of one or several frames of a video stream can be used directly as input to a one-way function, or (more realistically) a hash value of such data can be used as input to the one-way function. However, in more complex embodiments, the certain piece of information can be used as input to another one-way function (that in turn can be the same or a different one-way function), the output of which can form the input to a one-way function to produce the end result. This way, “chains” of one-way functions can be formed, the chains in some cases being very long. One property of such a calculation chain is then that, in order to correctly calculate a final output of a downstream-most one-way function, the following information is required:
The data fed into an upstream-most one-way function;
all the one-way functions used in the chain; and
any additional input information being inserted into one or several of the one-way functions along the chain.

In other words, a “derivative” input can be derived along a chain of functions, such as one-way functions, the chain comprising two or more functions being calculated serially and possibly over time. Such chains of one-way functions can both be branched and joined.

Of course, a “derivative” input can also be derived using a non-one-way function, such as a conventional integral, summing or difference function, or the like.

Correspondingly, an output of a one-way function can be “direct or derivative” in the sense that the output may be the output value of the one-way function itself or a value being determined in a repeatable and unambiguous manner based on such direct output value, for instance via a chain of additional one-way functions and/or other calculations.

That a piece of information such as an output of a one-way function is “embedded” into a produced video stream can have a similar or corresponding meaning as discussed above with respect to the graphical objects 200 and/or the pieces of information PO1, POI2, PO3. In particular, such “embedding” can mean that the produced video stream is modified as compared to a produced video stream without the piece of information embedded. The modification can take place as a result of the production and/or post production and can be a digital modification. For instance, the embedded piece of information can be digitally added in the form of a QR or bar code, or a sequence of alphanumeric characters in a visibly readable manner in the video part, coding for the piece of information. The addition can be in the form of a readily readable overlay, a watermark, or in any other suitable manner. The information shown can be the piece of information itself or some other piece of information that can be used to unambiguously find the piece of information representing a direct or derivative output of the first one-way function in question, such as via association, calculation or similar. The embedding can also be audible, so that an audio part of the video stream is modified to retroactively be able to extract the embedded piece of information from the produced video stream. Examples include an audio watermark or a computer-generated voice or signal representing the embedded piece of information. The embedding can be visible/audible or hidden. The embedding can also be in metadata of, or associated with, the produced video stream.

That a piece of information is “stored” means that it is stored on some suitable storage medium, such as in a database, for future access. The storing can be as a part of, together with or separate from a produced video stream into which the piece of information is embedded. The storing is preferably persistent and permanent, such as on a conventional hard drive, a flash drive, a non-volatile memory storage, or the like. The storing can be in a way that allows full retroactive replication of each piece of information, in other words not using any lossy compression algorithm or similar.

That a piece of information is “publicly published” means that it is published in such a way so that it is readily available to a wide enough audience, and with sufficient persistence over time, so that a third party is more likely than not to be able to verify the time of publication (such as to a granularity of at the most one day or even at the most one hour) and the contents of the piece of information or document exactly as they were at the date and time of publication, even if some time, such as several years, has passed after the publication. For instance, the piece of information can be published as a public social media post or on a publicly inspectable blockchain. The public publishing can be in a format so that the piece of information itself, as well as a publication timestamp thereof, is accessible online. In general, the public publishing takes place on and using a publicly available publication channel.

In some embodiments, metadata is provided, such as received, identified, created, deduced or similar, in relation to one or several of the source, primary and/or produced video streams described herein. Such metadata can be of the general type described above. Such metadata can be associated with any one of the source, primary and/or produced video streams described herein, and in particular with any of the source video streams SVS1, SVS2, SVS3 and/or any of the produced video streams PVS1, PVS2, PVS3. Such metadata can have different forms, and may be provided at any point, such as in connection to a certain event; intermittently; continuously; and/or upon request from some part of the system 100.

The sender 510 can perform a “weaving” of a source video stream, such as the first source video stream SVS1, the weaving being of the type described below, including embedding into a second video frame of the source video stream the direct or derivative output of a one-way function in turn using as direct or indirect input a first video frame of the source video stream, and then iterating by using the second videos frame, including the embedding, as direct or derivative input to another one-way function, the direct or derivative output of which is embedded into a third frame of the source video stream, and so forth, where any such one-way function can use as direct or derivative input a sampled piece of information from a publicly available information source and/or a direct or derivative output of any such one-way function can be publicly published. The first, second and third frames can be time-ordered in the source video stream in question.

In some embodiments, the invention comprises sampling of a publicly available information source. As used herein, a “publicly available information source” is an information source that is sufficiently widely and persistently available so that a third person is likely to be able to retroactively verify an information state of the information source at a particular point in time. For instance, such information sources include stock market prices, weather data, tv/radio news broadcasts, sports events, public social media feeds, and so forth. As used herein, “sampling” such a publicly available information source means to read a current informational state of some aspect of the information source, such as a combination of several current stock market prices and storing information representative of the informational state. The sampled aspect is one that could not reasonably be guessed ahead of time, and is therefore at least so detailed that such guesses would be futile in practice. The sampling can be performed using public APIs. The sampled information should preferably or at least likely be available via such public APIs for at least a number of years. The sampled information can be used as-is, and/or be compressed, hashed or otherwise processed using one or several one-way functions, where it is preferred that the direct or resulting derivative piece of information is configured so that it could not have been known before the time of the sampling.

In particular, an output of a source one-way function can be calculated using as direct or derivative input the sampled information.

As used herein, a “source” one-way function is generally a one-way function calculated using as direct or derivative input information sampled from an information source.

In some embodiments, an output of a joint one-way function is calculated, the joint one-way function using as input the direct or derivative output of said source one-way function, in turn being calculated using as direct or derivative input said information sampled from the publicly available information source.

As used herein, a “joint” one-way function is a one-way function using two different inputs to calculate an output.

Such a joint one-way function can also use as input the respective direct or derivative output of the above-described first and/or second one-way function, in turn being calculated based on the corresponding primary video stream and in particular (directly or derivatively) the corresponding authentication video part.

A direct or derivative output of the joint one-way function can then be publicly published, with the meaning as defined above.

The calculation of the joint one-way function can be iterative, in the sense that it is calculated repeatedly using as direct or derivative input, in each iteration, respective updated calculated values of its input values. The output of the joint one-way function can be publicly published for every iteration or only for some iterations.

In some embodiments, the joint one-way function can use as input a direct or derivative output of a previous-iteration calculation of the joint one-way function.

FIG. 17 shows an example illustrating these principles, wherein “IS” means publicly available information source; “SA” means sampling; “EM” means embedding; “OW” means one-way function having (one or several) inputs to the left and an output to the right thereof; “#” means the result of a one-way function, such as a hash-value or similar; “PV” means a primary video stream or a source video stream; “AP” means an authentication part of a primary/source video stream; “PR” means a produced video stream; “PC” means a publicly available publication channel; and “PP” means a public publication. In FIG. 17, the horizontal axis is the time.

An “authentication part” AP of a video stream is a part of the video stream showing the act of authentication of a user or a machine, such as showing a user holding up his or her printed piece of ID or performing a login using a graphical user interface. An output from a one-way function using a hash of such an authentication part can for instance be used as the user authentication code UAC.

It is realized that FIG. 17 is simplified in order to illustrate the principles described herein. All features shown in FIG. 17 may not be necessary, and additional features as described herein can be added. For instance, each one-way function OW shown can be a concatenation or chain of any number of one-way functions. One-way functions OW being shown as having multiple inputs can be divided into two or more separate one-way functions, each using one or several of such inputs and possibly feeding into a common downstream one-way function OW.

As is illustrated for the primary/source video streams PV and for the produced video stream PR, a state of any primary/source or produced video stream can be used as direct or derivative input to a one-way function OW the direct or derivative output of which is embedded at a later point in the same video stream; and/or a state of any primary/source video stream(s) can be used as direct or derivative input to a one-way function the direct or derivative output of which is embedded into a produced video stream being produced based on the primary/source video stream(s) in question. A part of a video stream into which a direct or derivative output of a one-way function OW is embedded can be used as direct or derivative input to a subsequent one-way function OW the output value of which is affected by the embedded information.

When a part of a video stream is used as direct or derivative input to a one-way function OW, any part of the video stream can be extracted for direct or derivative input to the one-way function OW, such as a whole or part of a single frame; multiple frames; and/or audio of the video stream. The extracted part can, for instance, be hashed. Such hashing can take all the information into consideration, or only part of it (such as only using a defined set of pixels in each frame or similar). It is preferred that the information extracted and used as direct or indirect input to the one-way function is configured to depend on the state of the video stream at the point of extraction along a timeline of the video stream, the state being an instantaneous state or having a certain length in time.

In general, any information embedded into a video stream PV, PR can be caused to affect a state of the video stream PV, PR in question used as direct or derivative input to a later one-way function OW calculation, so that it is not possible to perform the later one-way function OW calculation without having access to the video stream PV, PR as affected by the embedding. This can be achieved by, for instance, using a part (such as one or several frames) of the video stream PV, PR having the embedding as direct or derivative input to a one-way function OW the results of which is then embedded at a later point into the same video stream PV, PR; and so forth.

As is also illustrated in FIG. 17, the direct or derivative output of a one-way function OW using as direct or derivative input a part of a primary/source video stream PV can be embedded into another primary/source video stream PV, and two different primary/source video streams PV can be cross-linked in both directions this way.

Any of the one-way function OW calculations described herein can be iteratively repeated. Among other things, this results (via the above-mentioned joint one-way function) in that a video stream PV, PR having an embedding that depends on these calculations could not have existed (with the embedding) before the latest sampling of the publicly available information source used as input to the calculation; and information used as input to the calculation could not have come into existence after the earliest public publication of the output to the calculation. This locks in each piece of information subject to the one-way function calculations between an earliest and a latest point in time, as compared to an absolute timeline, making it possible to retroactively determine, with high certainty, a point in time when the information was used as direct or derivative input to the joint one-way function and as a result both a relative order of any frames of a video stream processed this way as well as the point in time when such a video stream was created.

More concretely, for a video stream, such as any primary/source PV or produced PR video stream, the state of which is used as direct or derivative input to the joint one-way function and into which a direct or derivative output of the joint one-way function is embedded in a way so that a subsequent state is used as direct or derivative input to a next-iteration calculation of the joint one-way function, this means two things:
It is possible to, with a high degree of confidence, retroactively determine a relative order of states (such as frames or sets of frames) in the video stream; and
It is possible to, with a high degree of confidence, retroactively determine a point in time at which the video stream was captured or produced.

Such determinations require knowledge of all information used as input to the one-way function in question, as well as knowledge of what one-way functions were used in each step. In certain embodiments, the invention encompasses storing all such required information in a persistent manner, for future use, such as in the form of metadata of the general type discussed herein. In general, however, the output of the one-way function can be available via embeddings in video streams the veracity of which is to be verified, and may therefore not need to be separately stored.

For any primary/source or produced video stream, a current state of the video stream can be used as direct or indirect input to the joint one-way function that is calculated at least once every minute, such as at least at once every ten seconds, such as at least once every second, such as at least every 100 video frames, such as at least every 10 video frames, such as every frame. An up-to-date state of a publicly available information source can be sampled at least once every hour, such as at least once every ten minutes, such as at least once every minute, such as at least once every ten seconds and used as direct or derivative input to the joint one-way function. An updated direct or derivative output of the joint one-way function can be publicly published at least once every hour, such as at least once every ten minutes, such as at least once every minute, such as at least once every ten seconds. A time between the sampling of a publicly available information source and a public publication of a direct or derivative output of the joint one-way function using as direct or derivative input the sampling in question can be at the most one hour, such as at the most ten minutes, such as at the most one minute, such as at the most ten seconds.

Hence, for each primary/source or produced video stream, information pertaining to different parts or frames of the video stream in question can be iteratively used as direct or indirect input to the joint one-way function. A maximum time between the occurrence of such part or frame and the usage thereof as direct or derivative input to the joint one-way function can be at the most ten minutes, such as at the most one minute, such as at the most ten seconds, such as at the most one second.

As understood from the above, the joint one-way function OW works as a mechanism of “weaving” information together along a timeline, internally within a video stream PV, PR (by the video stream feeding into itself at a later point along its timeline); across video streams PV, PR (by one video stream feeding into the other); and/or together with the publicly available information source IS and/or the public publication channel PC (by the publicly available information source IS feeding into the video stream or the video stream feeding into the public publication channel PC), to form an interconnected “weave” or “web” of information that is mathematically tied to the timeline. Verification of this “weave” or “web” involves retroactively inspecting the corresponding information as required, which may encompass all ingoing and outgoing information of used one-way functions OW, and in some embodiments in particular the publicly available information source IS and/or the public publication channel PC.

Such “weaving” of the primary/source PV and/or produced PR video streams can be devised so as to interconnect one, several or all of the video streams discussed herein to each other, in the sense that any set of at least one, such as several or even all relevant output values of the joint one-way function OW cannot be calculated without having access to at least one, or even several, parts of each of the primary/source PV and/or produced PR video streams.

The joint one-way function OW can use as direct or derivative input, apart from the above-described examples, also other information that is also to be “weaved in” in the corresponding way and hence become retroactively verifiable in terms of information integrity and time.

Hence, the joint one-way function OW can be calculated using as direct or derivative input one or several of SV, TS, MD, PSAC, SSAC, UAC, RC and SC; one or several of objects 200, VC1, VC2, VC, II1, II2, POI1, POI2 and POI3; and a set of metadata directly or indirectly (but unambiguously) describing a complete set of production steps used to produce any one of the produced video streams descried herein.

In FIG. 18, the general methodology of this “weaving” is illustrated.

In a first step S1800, the method starts.

In a subsequent step S1801, one or several publicly available information sources IS are sampled.

In a subsequent step S1802, one or several inputs are identified, in terms of parts of one or several primary/source PV and/or produced PR video streams. Here, the term “input” refers to a direct or derivative input to a joint one-way function OW.

In a subsequent step S1803, the output of the joint one-way function OW is calculated using the sampled information as well as the identified information as direct or derivative inputs. It is realized that different joint one-way functions OW can be used in different iterations.

In a subsequent step S1804, the direct or derivative output is embedded into one or several primary/source PV and/or produced PR video streams.

In a subsequent step S1805, the direct or derivative output is publicly published using the public publication channel PC. This part of the method can iterate as indicated in FIG. 18.

In a subsequent step S1806, the method ends.

As mentioned above, using the various described “weaving” solutions, it is possible to retroactively verify information relevant to any primary/source video streams PV, any produced video streams PR and historic or ongoing user authentication. However, as also mentioned, such verification requires direct or derivative access to any information used as input to the relevant one-way functions OW. In case such information is not available, it is not possible to verify the accuracy of the corresponding output of the one-way function OW in question.

FIGS. 16 and 19 illustrate another method for transferring a video stream from the sender 510 to the receiver 520.

In a first step S1600, the method starts.

In a series of steps S1601, S1602, S1603, S1604, S1605, S1606 and S1607, that can correspond to steps S801-S807 or S1401-S1407, the first source video stream SVS1 is used, together with the first verification code VC1, to produce and transfer the first produced video stream PVS1 which is then transferred to the receiver 530. The producing of the first produced video stream PVS1 can be performed using one or more automatic primary production steps, such automatic production steps generally being of the different types described above and herein.

Thereafter, in a series of steps S1608, S1609, S1610, S1611, S1612, S1613 and S1614, that can correspond to steps S808-S814, steps S1408-S1410 or steps S1423-S1429, the received first produced video stream PVS1 can be processed to identify the first piece of information POI1 (or the graphical objects 200), use this information to determine the received intermediate information or verification code and to then verify this information SV, TS, MD, PSAC, SSAC, UAC, RC and/or SC known to the receiver 530.

However, in a step S1616, the first source video stream SVS1 can be down-sampled, for instance by the sender 510. This down-sampling of the first source video stream SVS1 results in a first shadow source video stream SSVS1.

Then, in a subsequent step S1617, a first shadow produced video stream SPVS1 can be produced, based on frames 250 of the first shadow source video stream SSVS1 as well as the first piece of information POI1 in a way so that the verification code VC1 can be unambiguously determined based on the first shadow produced video stream SPVS1.

The producing of the first shadow produced video stream SPVS1 can be performed using one or more automatic shadow production steps corresponding to the one or more automatic primary production steps, but where the automatic primary production steps are performed in relation to the first source video stream SVS1 for the production of the first produced video stream PVS1 but performed in relation to the first shadow source video stream SVS1 for the production of the first shadow produced video stream SPVS1.

In some embodiments, at least some, such as all, of the production steps taken to produce the shadow produced video stream SPVS1 are identical to the production steps taken to produce the first produced video stream PVS1. It is noted here that the term “production step” can refer to automatic commands executed using the input information to produce the output video stream and in some embodiments not, for example, to the individual values of individual pixels in the output video stream. Hence, an example of such command is “show the first source video stream SVS1 in a side-by-side layout together with graph X” or “do a virtual panning across the first source video stream SVS1”.

In some embodiments, a set of production steps that are identical between the production of the shadow produced video stream SPVS1 and the production of the first produced video stream PVS1 are production steps altering the informational and/or cognitive contents of the respective produced video stream, and possibly not production steps only affecting a quality of the respective produced video stream per se. In particular, the production steps that are identical can be production steps that are unambiguously applied in the corresponding manner irrespectively of a difference in time-averaged bitrate, image quality and/or audio quality of the input (primary/source) video stream used to perform the production of the output produced stream.

In all such cases, at least one production step can differ between the production of the shadow produced video stream SPVS1 and the production of the first produced video stream PVS1, namely a production step resulting in that the shadow produced video stream SPVS1 has a lower time-averaged bitrate than the first produced video stream PVS1. This can then be achieved using said down-sampling.

In general, the two parallel productions (of the first produced video stream PVS1 and the first shadow produced video stream SPVS1) can be performed so that the two produced video streams PVS1 and SPVS1 are identical with respect to cognitive and informational contents apart from the time-averaged bitrate of the first shadow produced video stream SPVS1 being lower than the first produced video stream PVS1. Hence, when viewed on a display screen a human user will perceive these two produced video streams PVS1 and SPVS1 as identical but the first shadow produced video stream SPVS1 having lower quality.

Another way of expressing this is that the automatic producing of the first shadow produced video stream SPVS1 is based on the corresponding automatic production decisions as used to produce the first produced video stream PVS1 and the automatic production decisions are applied in an identical manner with the only difference being that the production takes place using the down-sampled material. The first shadow produced video stream SPVS1 can hence be produced to completely correspond to the first produced video stream PVS1, or at least completely correspond to a subset of the first produced video stream PVS1, but being qualitatively inferior in terms of for instance image quality.

In some embodiments, the full set of same or corresponding automatic production decisions can be used for both automatic productions, and in some embodiments no other production decisions in addition to this set of production decisions are used to produce the first shadow produced video stream SPVS1.

In alternative embodiments, the first produced video stream PVS1 can first be produced and then the produced video stream can be down-sampled to achieve the first shadow produced video stream SPVS1. The corresponding can apply also to the second and third produced video streams PVS2, PVS3.

In a subsequent step S1618, the first shadow produced video stream SPVS1 is stored or distributed, such as by the sender 510.

The storing of the first shadow produced video stream SPVS1 can be in a persistent and permanent manner, such as on a conventional hard drive, a flash drive, a non-volatile memory storage, or the like. The storing can be performed in a way that allows full retroactive replication of each of the shadow video streams, in other words not using any lossy compression or cropping algorithm or similar. In addition to the shadow video streams, information identifying all the automatic production decisions used to produce the produced shadow video stream can also be stored in the corresponding manner. In particular, the information stored should be sufficient for the retroactive replication of the production of the produced shadow video stream based on the shadow primary video streams. This way, the informational contents (imagery and/or audio) can be verified retroactively with respect to its contents.

It is realized that the second source video stream SVS2 and the second produced video stream PVS2 described above can also be used to produce a second shadow produced video stream in the corresponding manner as described above for the first shadow produced video stream SPVS1. Everything that is said herein regarding the first shadow produced video stream PVS1 is correspondingly applicable also to such a second shadow produced video stream.

In the following, the first and second source video streams SVS1, SVS2 are denoted “original-quality” source video streams, and the first and second produced video streams PVS1, PVS2 are denoted “original-quality” produced video stream, to distinguish them from the corresponding “shadow” video streams. It is understood that everything that has been said above in relation to the various video streams above can still apply and be used in the context of the method illustrated in FIG. 18 both to the original-quality video streams and independently to the shadow video streams. In general, the provision and use of the corresponding shadow video streams can be performed in parallel with the other method steps.

In general, the methods described in connection with FIGS. 8, 11, 14 and 15 can be freely combined with the methods described in FIGS. 16, 18 and 19, and in particular the method illustrated in FIG. 18 can be used as an add-on to any embodiment according to what has been discussed above in connection to FIGS. 8, 11 and 14. Any original-quality source video stream can be used to produce, via down-sampling, a corresponding shadow source video stream and any original-quality produced video stream can be used to produce, by applying the same production steps and/or by down-sampling, a corresponding shadow produced video stream.

One purpose of a shadow video stream of the type discussed herein can be to visually and/or audibly be able to verify the informational and cognitive contents thereof in order to determine if they match a corresponding informational and cognitive content of a corresponding original-quality video stream. Such information and cognitive contents that a person may want to verify can comprise one or several of an identity of a person being shown in the shadow video stream; the language contents of a discussion being viewed in the shadow video stream; the identity of an object being viewed in the shadow video stream, and so forth. To reach this goal, it is normally not necessary to provide the shadow video stream to a verifying party in a quality commensurate with standard requirements for modern video content. In other words, it is normally possible to compress the original-quality video streams quite much without losing the possibility to retroactively achieve such verification.

At any rate, it is preferred that the down-sampling of the original-quality video stream is performed without removing more information therefrom than so that it is possible to visually identify, also in the resulting shadow video stream, the presence and identity of a user participant 122 being clearly visible and identifiable in the corresponding original-quality video stream.

Also, the first shadow produced video stream SPVS1 should not be so compressed so that the graphical objects 200 or the piece of information POI1 (as the case may be) are no longer readable in an unambiguous manner from the first shadow produced video stream SPVS1. In other words, the compression should not be so heavy so that it is no longer possible to read the verification code VC or the first piece of intermediate information II1 from the first shadow produced video stream SPVS1. The corresponding applies for the second and third produced video streams PVS2, PVS3.

In some embodiments, the down-sampling of each shadow video stream in relation to its original-quality counterpart is a down-sampling arranged to reduce a byte size at least 10 times, or even at least 100 times. In this and in other cases, the down-sampling of the shadow video stream can comprise one or several of the following compression methods:
Decreasing, uniformly or selectively across an image plane, and/or along a timeline, of the shadow video stream in question, a pixel resolution of the shadow video stream as compared to the original-quality corresponding video stream, for instance to a pixel resolution in any or each pixmap dimension, and in at least one or several video frames, being at the most half, or even at the most one-fifth, of the corresponding original-quality pixel resolution;
decreasing, uniformly or selectively across an image plane, and/or along a timeline, of the shadow video stream in question, a pixel depth of the shadow video stream as compared to the original-quality corresponding video stream, for instance to a pixel depth that is, for at least one or several image frames, at the most half, or even at the most one-fifth, of the corresponding original-quality pixel depth, and/or for instance converting at least one or several image frames of an original-quality color video stream to a grayscale or even black/white video stream;
decreasing, uniformly or variably across a timeline of the shadow video stream in question, a frame rate of the shadow video stream as compared to the original-quality corresponding video stream, for instance to a frame rate that, for at least parts of the shadow video stream, is at the most half, or even at the most one-fifth, of the corresponding original-quality frame rate; and
incorporating into at least parts of the shadow video stream in question a cropping of the shadow video stream as compared to the original-quality corresponding video stream, such as by cropping away a background, for instance where one or several users 122 and/or detected object of interest constitute the foreground in the original-quality video stream in question.

In some embodiments, the down-sampling of the original-quality video stream is dynamic, meaning that it can vary along a timeline of the video stream and/or across an image plane of the video stream. For instance, the down-sampling can take into consideration one or several defined parameter values of the automatic production decisions so that the down-sampling is applied differently over time, across an image plane of one or several original-quality video streams and/or across different original-quality video streams, as viewed along a timeline of the original-quality video stream in question.

For instance, the automatic production of the original-quality third produced video stream PVS3 can be based (as described above) on the automatic detection of a currently speaking user 122; a location in the first or second source video streams SVS1, SVS2 of one or several users 122; the occurrence of one or several events and/or patterns; and so forth. Then, the down-sampling can be applied when producing the third shadow produced video stream corresponding to the third produced video stream PVS3 so that relatively less information is compressed away from an image-frame area containing one or several speaking or non-speaking users 122 as compared to other image-frame areas, and/or the down-sampling can be applied so that relatively less information is compressed away from temporal and/or image-frame parts of the original-quality source video stream SVS1, SVS2 containing higher concentrations of detected events and/or patterns. It is realized that these are only examples, and that many different dynamic compression techniques can be applied. Of course, the compression can alternatively or in addition be dynamically applied irrespective of the automatic production decisions, such as using conventional variable video compression techniques.

The production of the produced shadow video stream can be performed by any suitable production function 135 of the above-described type, such as the same or different production function 135 that produces the original-quality produced video stream.

In principle, the performance of steps S1616 and S1617 with respect to a certain frame in the first source video stream SVS1 or in the first produced video stream PVS1 can take place at a later point in time than step S1606 with respect to the same frame, such as long afterwards, for instance several days afterwards. However, in order to minimize the possibility of integrity breach or even fraud, in some embodiments step S1617, in other words the production of the corresponding first produced shadow video stream SPVS1 (and correspondingly for producing the other possible shadow video streams discussed herein), takes place with a time delay of at the most one minute, such as at the most ten seconds, in relation to the production of the original-quality produced video stream. This can in particular be true in the preferred case in which the shadow video streams are “weaved in” in the general manner described above.

In general, all the shadow video streams can be “weaved” together in a way corresponding to what has been described above in connection with the “weaving” of the original-quality video streams, using joint one-way functions OW, sampling of publicly available information sources IS to be used as input information, publicly publishing output information using publicly available publication channels PC and embedding EM output information into shadow video streams. Such “weaving” of the shadow video streams can be devised so as to interconnect one, several or all of the primary/source and/or produced shadow video streams to each other; to interconnect one, several or all of the primary/source and/or produced original-quality video streams to each other; and/or to interconnect one, several or all of the primary/source and/or produced shadow video streams to one or several of the primary/source and/or produced original-quality video streams, with the corresponding meaning of the word “interconnect” as above with respect to “weaving together” different video streams.

In particular, embedding into a later frame of a shadow video stream a piece of information being the direct or derivative output of a one-way function calculated using a previous frame of the shadow video stream as direct or derivative input verifiably preserves a relative order between the previous and later frames. Incorporating into a frame of a shadow video stream a direct or derivative output of a one-way function calculated using a direct or derivative sampled public information source as input verifiably puts the shadow video stream after a sampling time along a timeline. Publicly publishing a direct or derivative output of a one-way function calculated using as direct or derivative input a frame of a shadow video frame verifiably puts the shadow stream before the time of public publication.

In some embodiments, a cryptographic fingerprint of a primary/source video stream, in the form of a direct or derivative output of a one-way function calculated using as direct or derivative input a frame of the primary/source video stream is embedded into a shadow video stream, such as into a shadow video stream corresponding to the primary/source video stream. The opposite can also be true (embedding a digital fingerprint of the shadow video stream into the primary/source video stream). This verifiably locks in the primary/source video stream in relation to the shadow video stream along a timeline.

Concretely, a first shadow one-way function can be calculated to correspond to the above-described first one-way function. Hence, the first shadow one-way function can be calculated using as direct or derivative input the first shadow source video stream SSVS1. Correspondingly, a second shadow one-way function can be calculated using as direct or derivative input the second shadow source video stream to correspond to the second one-way function described above. The first shadow one-way function can be calculated using as direct or derivative input a first shadow authentication video part AP of the first shadow source video stream SSVS1, corresponding to the first primary authentication video part AP and showing, for instance, the step of authenticating a participant user 122, but in corresponding down-sampled video. Then, for each of a respective piece of information representing a direct or derivative output of the first shadow one-way function and the second shadow one-way function, at least one of embedding into the third shadow produced video stream a visual and/or audible representation of the piece of information; storing the piece of information; and publicly publishing the piece of information can be performed.

Going one step further, the same or a different (but similar) publicly available information source IS as discussed above can be sampled, and a second source one-way function, corresponding to or actually being the above-described source one-way function (that in turn can be denoted the “first” source one-way function) can be calculated using this sampling as input. Then, a second joint one-way function OW can be calculated, corresponding to or actually being the joint one-way function OW described above (that in turn can be denoted the “first” joint one-way function), using as input a direct or derivative output of the second source one-way function; a direct or derivative output of the first shadow one-way function; and a direct or derivative output of the second shadow one-way function. Finally, a direct or derivative output of the second joint one-way function OW can be publicly published in the manner described above, using a public publication channel PC. In case the first and second joint one-way functions OW are the same, only one public publishing is of course required for that particular iteration.

In order to be able to retroactively verify that an original-quality video stream was indeed used to give rise to the corresponding shadow video stream, the method can comprise one or several of the following:
Embedding into one or several of the original-quality source or produced video streams a direct or derivative output of the first or second shadow one-way function having been calculated based on the shadow video stream corresponding to the original-quality video stream in question. The embedding then takes place after the down-sampling of the original-quality video stream in question, and can also comprise unambiguous information regarding how the embedding into the original-quality video stream was performed in a way so that it can be reversed in order to perform said verification (that uses the original-quality video stream before the embedding).
Embedding into one or several produced original-quality video streams a direct or derivative output of one or several of the first and second shadow one-way functions having been calculated based on an original-quality source video stream used to produce the produced original-quality video stream in question.
Embedding into one or several of the shadow source or produced video streams a direct or derivative output of the corresponding first or second one-way functions (having been calculated based on the original-quality video stream corresponding to the shadow video stream in question).

To sum up, each shadow video streams can be used, together with information regarding how the automatic production was performed, to verify the informational and cognitive contents of an available original-quality produced video stream, such as that a user shown in an authentication part AP of the shadow video stream was actually authenticated; or to unambiguously identify graphical objects 200 or a piece of information POI1, POI2, POI3. Since this is the case, a corresponding shadow produced video stream can be transferred to the intermediate party 520 or to the receiver 530, and can then be used to verify its contents by inspection of the graphical objects 200 or the piece of information POI1, POI2, POI3 in the same way as described above, but using the shadow produced video stream instead of the original-quality produced video stream. In particular, using the various techniques to “weave” the various video streams, the verification is made stronger, for instance since it is then possible to verify that the shadow produced video stream was indeed produced very recently in a real-time scenario. This is possible even in case the potentially large original-quality primary video streams are lost, whether by accident or on purpose.

In FIG. 17, embeddings EM are shown as being in relation to a particular point in time of the video stream in question into which the embedding EM is performed. It is noted that such an embedding EM can be performed so as to affect the video stream into which the embedding EM is performed also going forward, at least so that a subsequent part of the same video stream which is used as direct or derivative input to a subsequent one-way function OW will depend on the embedding EM to achieve a cryptographic “chaining” effect of the above-described type. Each embedding can also be more or less short-lived, and can leave the video stream in question unaffected after a certain time period or number of frames. At any rate, a next time a part of a video stream is used as direct or derivative input to a one-way function OW, the embedding EM and/or the extraction of such part of the video stream can be configured so that the embedded EM information affects the subsequent calculation of the one-way function OW. This can be true individually for each such pair of the embedding EM and the subsequent one-way function OW calculation.

None of these extractions, embeddings EM, samplings SA and publications PP illustrated in FIG. 17 need to be synchronized in any particular manner, as long as they are performed so that they depend on each other in the general ways described herein to achieve the discussed “weaving” effect.

It is also noted that all the extractions, embeddings EM, samplings SA and publications PP can take place in real-time, so that the extraction of information from a video stream uses the video stream in its current state (such as using a currently most recent, such as most recently captured, video frame) to extract the information; so that the embedding EM takes place with respect to a currently considered most recent (such as most recently captured) video frame or part; so that the sampling SA is a sampling of a most recently accrued state of the public information source; and/or so that the public publication PP takes place immediately.

With reference to FIGS. 16, 17 and 19, an output can be calculated of a first one-way function OW using as direct or derivative input frame data of the first shadow produced video stream SPVS1, and the output can be publicly published PP. The value of the first one-way function OW can also be calculated using as direct or derivative input the first piece of information POI1 or the graphical objects 200.

Also, in some embodiments a publicly available information source PPI is sampled, and an output of a second one-way function OW is calculated using the sampling as input. Then, the output of the second one-way function OW can be incorporated into one or several frames 270 of the first shadow produced video stream SPVS1.

The output of the first one-way function OW can be calculated based on the output of the second one-way function OW and/or a subsequently calculated output of the first one-way function OW can be calculated based on the output of the second one-way function OW, the subsequently calculated output of the first one-way function OW being calculated based on a subsequent frame 270 of the first shadow produced video stream SPVS1.

In some embodiments, the output of the second one-way function OW is calculated based on the output of the first one-way function OW and/or a subsequently calculated output of the second one-way function OW is calculated based on the output of the first one-way function OW, the subsequently calculated output of the second one-way function OW being calculated based on a subsequent sampling of said publicly available information source PPI.

In other words, the first shadow produced video stream SPVS1 can be “weaved” in the way generally described above, so that it is possible to later verify a narrow time interval during which various parts of the first shadow produced video stream SPVS1 where actually produced. This can, for instance, be used by the receiver 530 to verify that the received first shadow produced video stream SPVS1 is freshly produced (for instance, not older than a predetermined time limit) during a real-time streaming of the first shadow produced video stream SPVS1.

The corresponding can apply to shadow produced video stream counterparts to the second produced video stream PVS2 and the third produced video stream PVS3, depending on the specific embodiment.

As mentioned above, the sender 510 can receive the secret value SV known to the receiver 530, in step S1602.

The method can then comprise steps S1608, S1609, S1610, S1611, S1612, S1613 and S1614, that can correspond to steps S808, S809, S810, S811, S812, S813 and S814, wherein the sender 510 can determine the first verification code VC1 in turn being or being determined based on the secret value SV; the receiver 530 can determine, based on the first produced video stream PVS1, the first verification code VC1 or the verification codes VC; and the receiver 530 can verifying the first verification code VC1, or verification codes VC, using the secret value SV. These steps can be performed as has been described in connection with FIG. 8.

However, in case the receiver 530 determines, in step S1611, that the verification is a failure, the first verification code VC1, or verification codes VC, can instead be determined based on the first shadow produced video stream SPVS1.

Namely, in a series of steps S1619, S1620, S1621 and S1622, corresponding to steps S1607, S1608, S1609 and S1610 but using the first shadow produced video stream SPVS1 instead of the first produced video stream PVS1, the first shadow produced video stream SPVS1 can be transferred from the sender 510 to the receiver 530 and receiver by the receiver 530; the first piece of information POI1 or the graphical objects 200 can be identified in the first shadow produced video stream SPVS1; and the first verification code VC1 or verification codes VC can be determined therefrom.

Thereafter, in a step S1623, the first verification code VC1, or verification codes VC, determined based on the first shadow produced video stream SPVS1 can be verified using the secret value SV in the corresponding manner as the verification of the first verification code VC1 or verification codes VC.

Since the graphical objects 200 or first piece of information POI1 are constructed so as to survive quality deteriorations occurring during the transfer in step S1619, it will be possible for the receiver 530 to determine the first verification code VC1, or verification codes VC, based on the first shadow produced video stream SPVS1.

Hence, if the receiver 530 determines that it is not possible to verify the integrity of the first source video stream SVS1 based on the received first produced video stream PVS1, the receiver 530 can instead try to verify the first source video stream based on the first shadow produced video stream SPVS1. This provides an additional layer of security in case of any security problems, transfer problems and so forth.

Namely, since the first shadow produced video stream SPVS1 normally requires less bandwidth to transfer, a fallback to verifying the integrity of the first source video stream SVS1 can be useful in case problems are experienced with, for example, low bandwidth or other transfer problems.

In addition, due to the lower bandwidth requirements to transfer the first shadow produced video stream SPVS1, and its smaller bit size, it is easier to verify the “weaving” that potentially has been applied with respect to the first shadow produced video stream SPVS1 than with respect to the relatively data-heavier first produced video stream PVS1. This is since it may be necessary to gain access to, and use, an unaltered version of the first shadow produced video stream SPVS1 to perform the verification calculations of one-way functions necessary to perform such verifications. This adds an extra layer of security to the use of the first shadow produced video stream SPVS1 even if it has a lower image quality, for example, than the first produced video stream PVS1.

Hence, the verification in step S1623 can comprise verifying a respective output of the above-discussed first and/or second one-way functions OW, and in particular using the contents of the received first shadow produced video stream SPVS1 to verify these outputs. Concretely, this can imply verifying that an embedding in a particular frame 270 of the first shadow produced video stream SPVS1 agrees with the output of the second one-way function OW provided with the inputs of the second one-way function allegedly used to produce that output; and correspondingly that the output of the first one-way function OW actually agrees with a frame of the first shadow produced video stream SPVS1 allegedly used to calculate that output. In case any of these verifications fail, the verification in step S1623 can be configured to fail as a whole. The corresponding can apply in case it is determined, from “weaving” information, that a time of creation of the frame 270 is not sufficiently recent.

In subsequent steps S1624, 1625 and 1626, that can correspond to step S1612-S1614, the contained video stream CVS can be constructed based on extracted frames 270 or 230 from the first shadow produced video stream SPVS1 or from the first produced video stream PVS1. For example, in case the verification in step S1611 fails but the follow-up verification in step S1623 succeeds, the frames 230 from the first produced video stream PVS1 can still be used to construct the contained video stream CVS; whereas in the event of a disruption of the streaming of the first produced video stream PVS1 while the streaming of the first shadow produced video stream SPVS1 is ongoing and the verification in step S1623 succeeds, the frames 270 from the first shadow produced video stream SPVS1 can be used to construct the contained video stream CVS instead of frames 230.

The information element IE can be configured to vary in reaction to the results of verification steps S1611 and S1623. For instance, in case the verification in step S1611 succeeds, the information element IE can be configured to signal that the integrity of the first source video stream SVS1 is verified (for instance, green color). In case the verification in step S1611 fails or the first produced video stream PVS1 cannot be received due to transfer problems or similar, but the verification in step S1623 succeeds, the information element IE can be configured to signal that the integrity of the first source video stream SVS1 is at risk (for instance, yellow color). In case the verification both in step S1611 and in step S1623 fails, the information element IE can be configured to signal that the integrity of the first source video stream SVS1 is not verified (for instance, red color).

In a subsequent step S1615, the method ends.

As mentioned above, it may be the case that the transfer of the first produced video stream PVS1 is interrupted for some reason. In such case, and also in other cases, the method can comprise using the first shadow produced video stream SPVS1 instead of the first produced video stream PVS1 for extracting frames 270 and constructing the contained video stream CVS. In such cases, the extracted frames 270 can be transformed to improve their usefulness in the contained video stream CVS.

In general, step S1617 can comprise producing, such as in the form of metadata of the various types discussed herein, at least one piece of context-relevant information about the first source video stream SVS1, such context-relevant information not being derivable from any shadow source video stream SSVS1 corresponding to the source video stream SVS1 to which it pertains, and in particular not being derivable from the first shadow source video stream SSVS1.

Then, the method can comprise the receiver 530, or any party delegated this task, to use this stored context-relevant information to transform at least part of the first shadow source video stream SSVS1 received from the sender 510, thereby achieving a first transformed source video stream.

In this context, the terms “transform”, “enhance” and “up-sample” can be used interchangeably, and correspondingly “transformed”, “enhanced” and “up-sampled”.

The stored context-relevant information can comprises metadata descriptive of one or several events (as defined above) or patterns (as defined above) detectable in the first source video stream SVS1.

The stored context-relevant information can comprise metadata descriptive of one or several things, persons or phenomena being visually shown and/or audibly heard in the first source video stream SVS1, such as an identity of a participant user 122 being visible or talking in the first source video stream SVS1 or a facial expression of such a participant user 122.

In other words, step S1624 can comprise the frames 270 of the transferred first shadow source video stream SSVS1 being automatically transformed (enhanced/up-sampled) to achieve a transformed (enhanced/up-sampled) video stream.

In various embodiments, the transforming (enhancing/up-sampling) can include one or several of the following:
Increase an audio bitrate, a pixel resolution, a pixel depth and/or a frame rate;
introduce a de-cropping, an image element and/or an audio element, such as a background, such as based on previously stored metadata; and
partly or completely animating a participant user 122 showed in the transformed video stream, the transforming possibly being based on previously stored metadata.

All these transformations result in the addition of information to the first shadow source video stream SSVS1, such added information not being deducible from the first shadow source video stream SSVS1 itself, making it necessary to do at least one of gleaning such added information from some available information source (such as the stored context-relevant information) and making informed guesses with respect to the contents of such added information. In general, a properly trained neural network can be used to fulfil these tasks, using statistical analyses of the first source shadow video stream SSVS1 to predict a naturally-looking filling out of the blanks that were lost during the down-sampling resulting in the first shadow source video stream SSVS1. For instance, so-called generative AI tools, such as a large language model, can be used to achieve this is an automatic way. In simpler cases, interpolation techniques can be used to insert additional pixels and/or frames in a video stream. This process can also be similar to the up-sampling of a video stream signal that is used by modern tv monitors, for example. The corresponding can be performed with respect to audio contents, adding frequencies so as to achieve a natural-sounding audio.

Furthermore, the transformation can use various types of available information.

For instance, audio information of the first shadow source video stream SSVS1 can be interpreted so as to better understand what is going on visually in the frames 270, such as to understand that a depicted participant user 122 is currently talking or moving about. Correspondingly, imagery of the first shadow source video stream SSVS1 can be used to artificially improve audio, for instance such that image processing can result in an understanding of the origin of a particular sound, such as a visible object toppling over and falling on the floor.

The available information can comprise image and/or audio material related to participant users 122 and/or objects that are visible in the first shadow source video stream SSVS1. For instance, a still image of the face of a participant user 122 can be used to improve the pixel resolution of that participant user's 122 face in the transformed video stream. Such information can be of different types, and for instance include information regarding the body size, normal posture, typical movement pattern and voice properties of the participant user 122.

The above-discussed metadata can also be used as available information in the present context. In connection to the down-sampling of the original-quality first source video stream SVS1 in step S1617, information regarding what the first source video stream SVS1 shows, what is happening in the first source video stream SVS1 and so forth can be automatically and selectively extracted, using available digital audio and/or video processing techniques and/or defined parameter values, and stored as metadata in step S1617. Such metadata can comprise, for instance, the identity and/or personal properties of participant users 122 visible in the original-quality first source video stream SVS1; textual or parametric descriptions of a scene visible in the original-quality first source video stream SVS1, in particular parts that are cropped away or heavily compressed as a result of the down-sampling; specifications regarding events; colour information pertaining to parts of the original-quality first source video stream SVS1 the pixel depth has been reduced or where colour information is otherwise lost; and/or patterns occurring in the original-quality first source video stream SVS1, such as that two participant users 122 shake hands, that a particular participant user 122 smiles or frowns, or that a particular participant user 122 looks at a particular other participant user 122. Using such information, the transformation can then be used to produce a best-guess artificial improvement of the first shadow source video stream SSVS1 so as to achieve the transformed first source video stream as a seemingly higher-quality video stream. In all these examples, available information can be combined in various ways with generative techniques such as interpolation and generative AI. For instance, textual information regarding the scene can be fed into a large language model facing the task of graphically improving the first shadow source video stream SSVS1.

In some embodiments, each or some shadow video streams described herein, or metadata associated with each of some shadow video streams, can be created to comprise some image and/or audio information of better quality (pixel resolution, pixel depth, sample rate, etc.). For instance, intermittent frames, such as one out of every ten frames or similar, can be in higher quality, such as in full image quality, as compared to the rest of the frames. Then, the transformation can comprise using the higher-quality parts to artificially render an improved-quality version of shadow video stream frames having inferior quality. This can be performed using, for instance, a properly trained neural network.

It is noted that the possibility of verifying the original-quality first source video stream SVS1 using the first shadow source video stream SSVS1 is not affected by the transformation, since the non-transformed first shadow source video stream SSVS1 is still kept stored for future reference. It is also noted that any transformed shadow primary/source or produced video stream can be used as a primary/source video stream in any of the ways described herein.

In general, available information in the form of stored metadata can be determined or calculated based on the original-quality first source video stream SVS1. The metadata can furthermore comprise externally provided information, for instance personal information regarding one or several participant users 122 being visible in the original-quality first source video stream SVS1.

In some embodiments, the down-sampling used to produce the corresponding shadow source/produced video stream is irreversible, requiring said transformation to add artificially deduced information to arrive at the transformed primary video stream. The transformation itself can also be an irreversible process.

The method illustrated in FIG. 16 is similar to the method illustrated in FIG. 8 in that the first produced video stream PVS1 is sent from the sender 510 to the receiver 530. It is, however, possible that the principles relating to the shadow video streams and their processing is applied also to the method illustrated in FIG. 14. Then, the first shadow produced video stream SPVS1 can be processed in a straight-through process by the intermediate party 520 in a way that can fully correspond to its processing of the first produced video stream PVS1, performed in a parallel track. Hence, a respective first and second shadow produced video stream can be received by the intermediate party 520 from the respective senders 510, 511; each containing respective frames of a corresponding first and second shadow source video stream as well as the respective first and second pieces of information POI1, POI2. Then, a shadow produced video stream can be produced by the intermediate party 520 to be a shadow correspondent to the third produced video stream PVS3, containing frames corresponding to the first and second shadow source video streams as well as the third piece of information POI3. Thereafter, the receiver 530 can process and use the received shadow produced video stream in a way corresponding to what has been described in relation to the first shadow produced video stream SPVS1 in the method illustrated in FIG. 16.

As mentioned, the present invention also relates to the system 100 itself. As has been described above, one or several central servers 130/110 in combination with one or several clients 121 are arranged to perform the above-described methods so as to produce the produced video stream.

Furthermore, the present invention also relates to a computer program product for producing the produced video stream. Such computer program product comprises instructions arranged to, when executed in the system 100, perform the steps of the methods described herein. The execution can take place on said one or several central servers 130/110 and/or on one or several clients 121 as described herein.

In any and all of the embodiments described above, the construction of the graphical objects 200 can be performed taking into consideration a coloration, texture or pattern of one or several pixels of the corresponding frame 210 of the first source video stream SVS1, such one or several pixels being adjacent or contiguous in relation to the graphical object 200 in the first produced video stream PVS1. For instance, one or more of the graphical objects 200 can be constructed to match such adjacent or contiguous pixels in the sense that each such graphical object 200 is designed to visually match, blend with or constitute a continuation of a texture, pattern, shape, color or similar of such adjacent or contiguous pixels. In the following, this will simply be denoted “matching”, and the adjacent or contiguous pixels of the frame 210 in relation to any particular graphical object 200 will simply be denoted its “adjacent pixels” in the frame 230 containing the frame 210 and the graphical object 200 in question. What is described in this context is equally applicable to any of the source and produced video streams described herein.

This way, the first produced video stream PVS1 can be viewed by, for instance, the receiver 530 without looking aesthetically displeasing. Viewing the first produced video stream PVS1 rather than the contained video stream CVS can be an option, in particular in case the first produced video stream PVS1 is not considerably less aesthetically pleasing than the contained video stream CVS.

Such construction of graphical objects 200 can be achieved in a way so that each graphical object 200 matches its adjacent pixels while also carrying the coarse-grainedly encoded information (the first verification code VC1) as described above. For instance, if the frame 210 at an upper region thereof shows a wall of a house with a particular color, a series of graphical objects 200 located directly above the frame 210 can be designed with the same color as said wall, giving the appearance that the wall continues upwards from the top of frame 210, across a part of the frame 230 outside of frame 210. Then, each of the graphical objects 200 can, for instance, be transformed into either a darker or lighter shade while keeping the hue of the wall color, forming a series of graphical objects 200 of two types—relatively dark ones and relatively light ones—that both are visually similar to the wall shown in the adjacent pixels but visually distinguishable from each other. Then, dark ones of the graphical objects 200 can represent the value “1” whereas light ones can represent the value “0”. Since the graphical object 100 itself can encompass a set of pixels, as described above, the binary encoded information can survive compression steps and similar during transmission of the first produced video stream PVS1 in the way generally described above. In other examples, characters, symbols or shapes can be added on top of color-matched graphical objects 200; or different graphical objects 200 can be shifted towards particular values of two or more different object-global visual properties, such as hues, tints and/or shades.

Generally, the graphical objects 200 can be arranged in direct connection to their respective set of adjacent pixels in the pixmap of the frame 230 of the first produced video stream PVS1, such as without any pixel space between the graphical object 200 and the set of adjacent pixels.

In some embodiments, a respective gradient is added to one, two or more of the graphical objects 200. Such gradient can be designed to shift a visual property, such as tint, shade or hue, of the graphical object 200 from being very close to one or more adjacent pixels in a region immediately next to the adjacent pixels in question to being less close to the one or more adjacent pixels in a region at a distance from the adjacent pixels. This gradient can then be from the very close match towards a visual property used to (instead of being closely matched of the adjacent pixels) indicate the information carried by the graphical object 200 in question.

The process of constructing each graphical object 200 can contain a first step, in which the general visual properties of the graphical object 200 are determined so as to match its adjacent pixels. Then, the graphical object 200 can be transformed, such as by changing its hue, tint or shade; by introducing a gradient; by adding a symbol, character or shape; and so forth, to introduce the information-carrying element or aspect of the graphical object 200.

In some embodiments, the construction of the graphical object 200 can be performed using a generative AI model, for instance one using the so-called “transformers” architecture in turn using self-attention mechanisms to produce image material. Using such a generative AI model, each graphical object 200 can be constructed as, comprising or based upon a generated image so as to match a visual appearance, in terms of colors, textures, patterns, shapes and so forth of a motif shown in the frame 210 in a way so that it visually appears that the graphical object 200 in the frame 230 constitutes a projected extension of, or visual entity otherwise matching, the frame 210. Then, the generative AI model can be configured to produce each graphical object 200 also having some information-carrying property, such as being “dark” or “bright”; or the resulting generated pixmap can be transformed as described above, such as using a gradient, to introduce the information-carrying aspects or element.

FIGS. 20a-20e illustrate this in a simple example.

In FIG. 20a, a frame 210 of the first source video stream SVS1 is shown, with a man in front of a textured plaster wall.

FIG. 20b shows the frame 210 as a part of a corresponding frame 230 of the first produced video stream PVS1, with gray fields illustrating where graphical objects 200 should be introduced into the frame 230.

FIG. 20c shows the frame 230 including graphical objects 200 designed to match the adjacent pixels. In this case, a generative AI model was used to construct the graphical objects 200 to have a corresponding, projected/extended texture matching that of the adjacent pixels.

FIG. 20d shows a mask used to transform the graphical objects 200 so that they carry the information.

FIG. 20e shows the final view of the frame 230, where the mask has been used to transform the tint of the pixels of the graphical objects 200 into relatively darker graphical objects 200 and relatively brighter graphical objects 200.

FIG. 21 shows a simple example of a graphical object 200 having a gradient as described above, from a matching striped pattern towards a bright information-carrying shade.

The construction of such graphical objects 200 can take some time, and a graphical object 200 being constructed to match adjacent pixels in a certain frame 210 may no longer match the corresponding adjacent pixels in a certain later frame 210 in the first source video stream SVS1. In other words, once the graphical object 200 is constructed, it may no longer be useful as a matched graphical object 200 since the frame 210 to which it was constructed to match may already have been transferred and a new current frame 210, with different visual properties, will then have taken its place.

To solve this problem, in some embodiments the finally constructed graphical object 200 can be matched against the adjacent pixels of a frame 210 being a current frame 210 for transfer at the point in time when the graphical object 200 is finalized.

Then, in case the graphical object 200 is found to not match the adjacent pixels sufficiently, according to some suitable predetermined criterion, either a new graphical object 200 can be constructed anew, to match the adjacent pixels of that current frame 210, or the already constructed graphical object 200 can be transformed to more closely match the adjacent pixels of the current frame 210 but without changing the information carried by the graphical object 200.

In the case in which a new graphical object 200 is constructed this can take some time, and the current corresponding frame 230 may then be produced without the graphical object 200, or using a previously constructed or default graphical object 200. Alternatively, a graphical object 200 not carrying any information but only being, for instance, a field of a color matching an average color of the adjacent pixels or similar, can be used.

In the case in which the graphical object 200 is transformed, the transformation can be selected to be performed quickly, without having to pause the transfer of the first produced video stream PVS1 in order to be able to incorporate the transformed graphical object 200 into the current frame 230. Examples of suitable transforms can include brightness or hue alterations applied homogenously to the entire graphical object 200 to more closely match a brightness or hue of the adjacent pixels of the current frame 210. It is noted that this transformation should not alter the information carried by the graphical object 200 (the first verification code VC1), so any brightness alterations etc. must be within an interval allowing the graphical object 200 to still code for the same coarse-grained information. In case it is not possible to transform the graphical object 200 to sufficiently match the adjacent pixels, it may be deemed impossible to perform the transformation and a new graphical object 200 can then instead be constructed.

In some embodiments, a constructed graphical object 200 can be used without being altered for more than one frame 230. For instance, for each current frame 210 a comparison can be made between the constructed graphical object 200 and its adjacent pixels in the current frame 210, and if the graphical object 200 is deemed to sufficiently closely match the adjacent pixels, such as according to the above-mentioned predetermined criterion, the graphical object 200 can be used for that current frame 210. In some cases, as described above, the same constructed graphical object 200 can be transformed on the margin to more closely match the adjacent pixels of a current frame 210 but without changing the basic constitution of the graphical object 200.

In case the graphical object 200 is determined not to match the adjacent pixels sufficiently well, due for instance to a scene change or panning in the first source video stream SVS1, a new graphical object 200 can then be constructed. It is noted that this construction can then take some time to perform, so that the current frame 210 when the new graphical object 200 if finalized may no longer match that graphical object 200. In this case, the method can proceed as above.

FIG. 22 illustrates a method of this type.

In a first step 2200, the method starts.

In a subsequent step 2201, a graphical object 200 can be constructed to match its adjacent pixels. This step can also comprise transforming the graphical object 200 as described above to change the information carried by the graphical object 200. The graphical object 200 can be constructed to carry information being unique to the graphical objects 200 of that particular current frame 230 of the first produced video stream PVS1 and/or for a series of such frames 230, as has been discussed above.

In a subsequent step 2202, the graphical object 200 can be compared to its adjacent pixels in a current frame 210 at the time when the graphical object 200 is finalized. This comparison can be simple, such as comparing object-global or average properties such as hue or tint.

In a subsequent step 2203, performed in case the graphical object 200 is found to match the adjacent pixels, it can be inserted into the current frame 230 for transfer. Then, the method can loop back to step 2202, using the next current frame 210. In some cases, one and the same graphical object 200 can be used for several consecutive frames 230 until a match is no longer considered to be sufficient; and/or until a certain time or number of frames 230 have passed, such as at the most 5 seconds or 100 frames.

In an alternative subsequent step 2204, performed in case the graphical object 200 is found not to match the adjacent pixels, the graphical object 200 can be transformed using a quick transformation, the transformation not changing the information carried by the graphical object 200.

In a subsequent step 2205, the transformed graphical object 200, carrying the same information as the non-transformed graphical object 200, can again be compared to its adjacent pixels to see if it matches. This step 2205 can be skipped in case the transformation involves predictable results in terms of the results of the comparison.

In a subsequent step 2206, performed in case the transformed graphical object 200 is found to match, the transformed graphical object 200 can be inserted into the current frame 230 for transfer. Then, the method can loop back to step 2202, for the next current frame 210.

In an alternative subsequent step 2207, performed in case the transformed graphical object 200 is not found to match, it can be decided not to insert the transformed graphical object 200 into the current frame 230. Instead, a new graphical object 200 can be determined, by looping back to step 2201. A default graphical object 200, a simple matching graphical object 200, a previous graphical object 200, or no graphical object 200 at all, can be inserted into the current frame 230 for transfer.

In a subsequent step 2208, the method ends. Before that, the method can loop back to step 2202 for the next current frame 210.

The comparisons in steps S2202 and S2205 can be performed on a per-graphical object 200 basis or for all graphical objects 200 relating to a particular frame 210. In other words, individual graphical objects 200 can be updated/replaced independently of other graphical objects 200, or several (or all) of the graphical objects 200 pertaining to a particular frame 210 can be replaced or not replaced as a group depending on the sufficiency of the matching.

In such embodiments, a new set of graphical objects 200 can be introduced into the first produced video stream 230 at irregular intervals. In order to be able to perform the verification of the information carried by the graphical objects 200, the information carried by the graphical objects 200 can be calculated based on one or several pieces of information carried by previous graphical objects 200 in the first produced video stream PVS1 so that the receiver can verify that no graphical objects 200 were lost in the transmission.

Above, preferred embodiments have been described. However, it is apparent to the skilled person that many modifications can be made to the disclosed embodiments without departing from the basic idea of the invention.

For instance, many additional functions can be provided as a part of the system 100 described herein, and that are not described herein. In general, the presently described solutions provide a framework on top of which detailed functionality and features can be built, to cater for a wide variety of different concrete application wherein streams of video data is used for communication.

In one particular example, more than one intermediary party 520 can be used, so that each such intermediate party receives respective one or several produced video streams; processes the information as described above; and provides a new produced video stream to a downstream intermediate party 520. Each such intermediate party 520 can then propagate both frames 210 of one or several source video streams and pieces of information for verifying the integrity of the frames 210. Each such intermediate party 520 can also produce productions based on the frames 210, as generally described herein. This way, very complex production chains can be implemented, involving many different video sources and participants, while still being able to verify the integrity of all received information without having to trust any of the intermediate parties 520.

In general, all which has been said in relation to the presently described methods, systems and computer program products is applicable across these methods, systems and computer program products even if not explicitly mentioned.

The description has been based on “video” being 2D video, comprising 2D image frames. It is, however, realized that the same or corresponding principles can be used for 3D video, comprising 3D image frames.

Generally, metadata regarding one or several primary video streams and/or one or several produced video streams can be identified, stored and/or “weaved” into one or several of said streams, as generally described above. Such metadata can comprise many different types of information pertaining to the video stream(s) as such, a context in which the video stream(s) accrued, properties of users participating in the video stream(s), and so forth. In some examples, an identify of a camera or client device capturing a particular primary video stream, such as an IP address, a MAC address, a hardware identity or fingerprint, an updated geolocation information of the camera or client device (such as GPS coordinates) can be stored/used/weaved as metadata with respect to the primary video. Correspondingly, metadata information regarding an identity of a central server or device performing an automatic production of a produced video stream can be stored/used/weaved in the general ways described above.

Hence, the invention is not limited to the described embodiments, but can be varied within the scope of the enclosed claims.

1. A method for transferring a first video stream, comprising:
determining a first verification code;
producing a first produced video stream based on one or several frames of a first source video stream as well as a first piece of information coding for the first verification code in a way so that the first verification code can be unambiguously determined based on the first produced video stream, the producing of the first produced video stream being performed using one or more automatic primary production steps;
transferring the first produced video stream from a sender to a receiver, wherein the method further comprises the steps
down-sampling the first source video stream to achieve a first shadow source video stream;
producing a first shadow produced video stream based on frames of the first shadow source video stream as well as the first piece of information in a way so that the verification code can be unambiguously determined based on the first shadow produced video stream, the producing of the first shadow produced video stream being performed using one or more automatic shadow production steps corresponding to the one or more automatic primary production steps; and
storing or distributing the first produced shadow produced video stream.

2. The method of claim 1, wherein:
the one or more automatic primary production steps are based on at least one of one or more defined parameters; automatic image processing of the first source video stream; and automatic audio processing of the first source video stream.

3. The method of claim 1, further comprising:
calculating an output of a first one-way function using as direct or derivative input frame data of the first shadow produced video stream; and
publicly publishing the output of the first one-way function.

4. The method of claim 3, further comprising:
calculating the output of the first one-way function using as direct or derivative input the first piece of information.

5. The method of claim 1, further comprising:
sampling a publicly available information source and calculating an output of a second one-way function using the sampling as input; and
incorporating into one or several frames of the first shadow produced video stream the output of the second one-way function.

6. The method of claim 5, further comprising:
calculating the output of the first one-way function based on the output of the second one-way function and/or calculating a subsequently calculated output of the first one-way function based on the output of the second one-way function, the subsequently calculated output of the first one-way function being calculated based on a subsequent frame of the first shadow produced video stream.

7. The method of claim 5, further comprising:
calculating the output of the second one-way function based on the output of the first one-way function and/or calculating a subsequently calculated output of the second one-way function based on the output of the first one-way function, the subsequently calculated output of the second one-way function being calculated based on a subsequent sampling of said publicly available information source.

8. The method of claim 1, further comprising:
the sender receiving a secret value known to the receiver;
the sender determining the first verification code being or being determined based on the secret value;
the receiver determining, based on the first produced video stream, the first verification code; and
the receiver verifying the first verification code using the secret value.

9. The method of claim 8, further comprising:
in response to the receiver determining that the verification is a failure,
determining, based on the first shadow produced video stream, the first verification code, and
verifying the first verification code using the secret value.

10. The method of claim 9, further comprising:
verifying a respective output of the first and/or second one-way function.

11. The method of claim 9, wherein:
the verifying of the first verification code and/or the output of the first and/or second one-way function is performed by the receiver.

12. The method of claim 1, wherein:
the first piece of information comprises pixel information and/or audio information.

13. The method of claim 12, wherein:
the first piece of information comprises or constitutes one or several of:
one or several graphical objects being useful to unambiguously determine the first verification code based on visual identification of each of the one or several graphical objects;
a visual coding pattern having a predetermined structure, the visual coding pattern being useful to unambiguously determine the first verification code based on visual identification of the visual coding pattern;
one or several alphanumeric characters, the one or several alphanumeric characters being useful to unambiguously determine the first verification code based on visual identification of each of the one or several alphanumeric characters;
one or several graphical objects located in the first produced video stream without overlay of the first source video stream;
a watermark structure, being configured to be indiscernible to the human eye in the first produced video stream but to be discernible after an image transformation being performed on the first produced video stream.

14. The method of claim 12, wherein:
the first piece of information is present in one or more of frames of the first produced video stream; and/or
different parts of the first piece of information coding for the first verification code are present in two or more different frames of the first produced video stream.

15. (canceled)

16. The method of claim 1, further comprising:
determining the first verification code based on one or several of:
a source stream authentication code, the source stream authentication code being unique for the first source video stream;
a primary stream authentication code, the primary stream authentication code being unique for a primary video stream based on which the first source video stream is produced;
a user authentication code, the user authentication code being unique for a user being associated with or depicted in the first source video stream;
a session code, the session code being unique for a communication session within the context of which the transfer of the first produced video stream takes place;
a random code;
a timestamp; and
metadata, the metadata comprising information about one or several of the sender; the receiver; the first source video stream; said session; and said context.

17. (canceled)

18. The method of claim 1, further comprising:
calculating a sequence of pieces of information to be incorporated into one or several frames of the first produced video stream based on a sequence of verification codes, the sequence of verification codes being an ordered sequence of verification codes, each verification code in the sequence of verification codes being calculated based on at least one of a previous verification code in the ordered sequence of verification codes and the first verification code.

19. The method of claim 18, further comprising:
for each of one or several verification codes in the sequence of verification codes,
calculating the verification code based on publicly published information;
calculating a value of a piece of information based on the verification code, the value subsequently being publicly published; and/or
calculating the verification code as a pseudo-random number.

20. The method of claim 1, wherein:
the first verification code is determined based on only the secret value and any additional information known to the receiver.

21. A system for transferring a first video stream, the system comprising: a sender, the sender being configured to:
determine a first verification code;
produce a first produced video stream based on one or several frames of a first source video stream as well as a first piece of information coding for the first verification code in a way so that the first verification code can be unambiguously determined based on the first produced video stream, the producing of the first produced video stream being performed using one or more automatic primary production steps;
transfer the first produced video stream to a receiver,
wherein the sender is further configured to:
down-sample the first source video stream to achieve a first shadow source video stream;
produce a first shadow produced video stream based on frames of the first shadow source video stream as well as the first piece of information in a way so that the verification code can be unambiguously determined based on the first shadow produced video stream, the producing of the first shadow produced video stream being performed using one or more automatic shadow production steps corresponding to the one or more automatic primary production steps; and
store or distribute the first produced shadow produced video stream.

22. A non-transitory computer program product for transferring a first source video stream, the computer program product being configured to, when executing on one or several computer processors of a sender, cause the sender to:
determine a first verification code;
produce a first produced video stream based on one or several frames of a first source video stream as well as a first piece of information coding for the first verification code in a way so that the first verification code can be unambiguously determined based on the first produced video stream, the producing of the first produced video stream being performed using one or more automatic primary production steps;
transfer the first produced video stream to a receiver,
wherein the computer program product is configured to, when executing on one or several computer processors of the sender, further cause the sender to:
down-sample the first source video stream to achieve a first shadow source video stream;
produce a first shadow produced video stream based on frames of the first shadow source video stream as well as the first piece of information in a way so that the verification code can be unambiguously determined based on the first shadow produced video stream, the producing of the first shadow produced video stream being performed using one or more automatic shadow production steps corresponding to the one or more automatic primary production steps; and
store or distribute the first produced shadow produced video stream.
